(19) United States
(12) Patent Application Publication
(10) Pub. No.: US 2025/0004002 A1
(43) Pub. Date: Jan. 2, 2025

(54) SYSTEMS AND RELATED REAGENT CARTRIDGE QUEUING METHODS

(71) Applicant: ILLUMINA, INC., San Diego, CA (US)

(72) Inventors: Richard Lemoine, San Diego, CA (US); Jason Oh, San Diego, CA (US); Jacob Ruden, San Diego, CA (US); Xiangxiong Chen, Palo Alto, CA (US); James Osmus, San Diego, CA (US); Andrew Enslow, Escondido, CA (US); Steven Hendrix, Jamul, CA (US)

(21) Appl. No.: 18/759,367

(22) Filed: Jun. 28, 2024

Related U.S. Application Data
(60) Provisional application No. 63/524,216, filed on Jun. 29, 2023.

(51) Int. Cl. G01N 35/04; B01L 3/00

(52) U.S. Cl. CPC G01N 35/04; B01L 3/523; B01L 2200/16; B01L 2300/041; G01N 2035/0401

(57) ABSTRACT

Systems and related reagent cartridge queuing methods are disclosed. In accordance with an implementation, an apparatus includes a first reagent cartridge, a second reagent cartridge, and a system. The system includes a sipper manifold assembly having a sipper, a queue to carry the first reagent cartridge and the second reagent cartridge, a cartridge moving assembly, and a cartridge receptacle assembly. The cartridge moving assembly includes a gantry, a carriage actuator, and a carriage. The carriage is coupled to the gantry and the carriage actuator is to move the carriage relative to the gantry. The cartridge receptacle assembly has a cartridge receptacle to receive the first reagent cartridge or the second reagent cartridge. The carriage is to move the first reagent cartridge from the queue and position the first reagent cartridge into the cartridge receptacle.

### RELATED APPLICATION

This application claims priority to U.S. Provisional Patent Application No. 63/324,216, filed Jun. 29, 2023, the content of each which is incorporated by reference herein in their entireties and for all purposes.

### BACKGROUND

Instruments such as sequencing instruments may include temperature controlled components. Aspects of the present disclosure relate generally to devices, systems, and methods providing biological or chemical analysis. Various protocols in biological or chemical research involve performing a large number of controlled reactions on local support surfaces or within predefined reaction chambers. The designated reactions may then be observed or detected, and subsequent analysis may help identify or reveal properties of chemicals involved in the reaction. For example, in some multiplex assays, an unknown analyte having an identifiable label (e.g., fluorescent label) may be exposed to thousands of known probes under controlled conditions. Each known probe may be deposited into a corresponding well of a flow cell channel. Observing any chemical reactions that occur between the known probes and the unknown analyte within the wells may help identify or reveal properties of the analyte. Other examples of such protocols include known DNA sequencing processes, such as sequencing-by-synthesis (SBS) or cyclic-array sequencing.

While a variety of devices, systems, and methods have been made and used to perform biological or chemical analysis, it is believed that no one prior to the inventor(s) has made or used the devices and techniques described herein.

### SUMMARY

Advantages of the prior art can be overcome and benefits as described later in this disclosure can be achieved through the provision of systems and related reagent cartridge queuing methods. Various implementations of the apparatus and methods are described below, and the apparatus and methods, including and excluding the additional implementations enumerated below, in any combination (provided these combinations are not inconsistent), may overcome these shortcomings and achieve the benefits described herein.

In accordance with a first implementation, an apparatus, comprising: a first reagent cartridge; a second reagent cartridge; and a system, comprising: a sipper manifold assembly comprising a sipper; a queue to carry the first reagent cartridge and the second reagent cartridge; a cartridge moving assembly comprising a gantry, a carriage actuator, and a carriage, the carriage coupled to the gantry and the carriage actuator to move the carriage relative to the gantry; and a cartridge receptacle assembly comprising a cartridge receptacle to receive the first reagent cartridge or the second reagent cartridge, wherein the carriage is to move the first reagent cartridge from the queue and position the first reagent cartridge into the cartridge receptacle.

In accordance with a second implementation, an apparatus, comprising: a system, comprising: a sipper manifold assembly comprising a sipper; a queue to carry reagent cartridges; a cartridge moving assembly comprising a gantry, a carriage actuator, and a carriage, the carriage coupled to the gantry and the carriage actuator to move the carriage relative to the gantry; and a cartridge receptacle assembly comprising a cartridge receptacle, wherein the carriage is to move the reagent cartridges from the queue to the cartridge receptacle assembly.

In accordance with a third implementation, an apparatus, comprising: a system, comprising: a sipper manifold assembly comprising a sipper; a cartridge conveyor assembly having a stop; a vertical assembly comprising a plurality of cartridge slots to carry reagent cartridges; and a cartridge moving assembly comprising a carriage actuator and a carriage, the carriage actuator to move the carriage relative to the cartridge conveyor assembly and the vertical assembly, wherein the carriage is to move one of the reagent cartridges from the vertical assembly to the cartridge conveyor assembly.

In accordance with a fourth implementation, an apparatus, comprising: a system, comprising: a sipper manifold assembly comprising a sipper; a first vertical assembly comprising a pusher, an actuator, and a plurality of first cartridge slots to carry reagent cartridges; a second vertical assembly comprising a second actuator and a plurality of second cartridge slots; and a conveyor extending between the first vertical assembly and the second vertical assembly, wherein the first actuator is to align one of the first cartridge slots with the conveyor and the second actuator is to align one of the second cartridge slots with the conveyor, and wherein the pusher is to move one of the reagent cartridges from the corresponding first cartridge slot onto the conveyor.

In accordance with a fifth implementation, an apparatus, comprising: a system, comprising: a sipper manifold assembly comprising a sipper; and a cartridge conveyor assembly to move reagent cartridges toward the sipper manifold assembly, wherein the sipper manifold assembly is positioned to access a reagent cartridge positioned on the cartridge conveyor assembly.

In accordance with a sixth implementation, an apparatus, comprising: a system, comprising: a sipper manifold assembly comprising a sipper and a sipper actuator; a first carriage to carry a first reagent cartridge; and a second carriage to carry a second regent cartridge, wherein the sipper actuator is to move the sipper relative to the first carriage and the second carriage.

In accordance with a seventh implementation, a method, comprising: moving a first reagent cartridge from a drawer to a first position on a queue using a cartridge moving assembly comprising a gantry, a carriage actuator, and a carriage; moving a second reagent cartridge from the drawer to a second position on the queue using the cartridge moving assembly; moving the first reagent cartridge from the queue; and positioning the first reagent cartridge in a cartridge receptacle of a cartridge receptacle assembly, the cartridge receptacle accessible by a sipper of a sipper manifold assembly.

In accordance with an eighth implementation, a method, comprising: moving a reagent cartridge from a vertical assembly to a cartridge conveyor assembly using a cartridge moving assembly comprising a carriage actuator and a carriage, the vertical assembly comprising a plurality of cartridge slots to carry reagent cartridges; engaging a stop of the cartridge conveyor assembly with the reagent cartridge; and moving a sipper of a sipper manifold assembly toward the reagent cartridge using a sipper actuator of the sipper manifold assembly.

In accordance with a ninth implementation, a method, comprising: aligning one of first cartridge slots of a first vertical assembly with a conveyor, the first vertical assembly comprising a pusher and a first actuator, and the first cartridge slots carrying reagent cartridges; aligning one of second cartridge slots of a second vertical assembly with the conveyor, the second vertical assembly comprising a second actuator and second cartridge slots; and moving one of the reagent cartridges from the corresponding first cartridge slot onto the conveyor using the pusher.

In accordance with a tenth implementation, a method, comprising: moving reagent cartridges toward a sipper manifold assembly using a cartridge conveyor system; and accessing a first reagent cartridge of the reagent cartridges positioned on the cartridge conveyor system using a sipper manifold assembly.

In accordance with an eleventh implementation, a method, comprising: drawings first reagent from a first reagent cartridge carried by a first carriage using a sipper of a sipper manifold assembly; flowing the first reagent to a first flow cell; moving the sipper manifold assembly above a second carriage carrying a second reagent cartridge using a sipper actuator; drawings second reagent from the second reagent cartridge carried by the second carriage using the sipper of the sipper manifold assembly; and flowing the second reagent to a second flow cell.

In accordance with a twelfth implementation, an apparatus, comprising: a system, comprising: a drawer to receive a reagent cartridge; a cartridge moving assembly comprising a gantry, a carriage actuator, and a carriage comprising a pair of lifting arms and an arm actuator; and a queue. The arm actuator is to actuate the lifting arms to position the lifting arms about the reagent cartridge and the carriage is to move the reagent cartridge from the drawer to the queue.

In accordance with a thirteenth implementation, an apparatus, comprising: a reagent cartridge assembly comprising a reagent cartridge and a flow cell, wherein the reagent cartridge assembly comprises a lid and a body to which the lid is pivotably coupled, wherein the lid covers the flow cell.

In further accordance with the foregoing first, second, third, fourth, fifth, sixth, seventh, eighth, ninth, tenth, eleventh, twelfth, and/or thirteenth implementations, an apparatus and/or method may further comprise or include any one or more of the following:

In accordance with an implementation, wherein the sipper manifold assembly comprises a sipper actuator to move the sipper relative to the cartridge receptacle.

In accordance with another implementation, the cartridge receptacle assembly comprises an opening and a lock movable between an unlocked position and a locked position, the first reagent cartridge positionable through the opening when the lock is in the unlocked position and the first reagent cartridge securable in the cartridge receptacle when the lock is in the locked position.

In accordance with another implementation, the lock comprises a lock actuator and an arm, the lock actuator to move the arm from the unlocked position to the locked position.

In accordance with another implementation, the queue comprises a shelf having a first position and a second position, the first reagent cartridge being positioned at the first position and the second reagent cartridge being positioned at the second position.

In accordance with another implementation, the shelf comprises a first access aperture at the first position and a second access aperture at the second position.

In accordance with another implementation, the carriage actuator is to position the carriage beneath the first reagent cartridge and move the carriage through the first access aperture to lift the first reagent cartridge from the first position.

In accordance with another implementation, further comprising a third reagent cartridge and a drawer carrying the third reagent cartridge.

In accordance with another implementation, the carriage is to move the third cartridge from the drawer onto the queue.

In accordance with another implementation, the drawer comprises an access aperture and the carriage actuator is to position the carriage beneath the third reagent cartridge and move the carriage through the access aperture of the drawer to lift the third reagent cartridge from the drawer.

In accordance with another implementation, the system further comprises a door that is movable to enable access to the drawer.

In accordance with another implementation, further comprising a first reagent cartridge assembly comprising the first reagent cartridge and a first flow cell.

In accordance with another implementation, the system comprises a flow cell interface to receive the first flow cell.

In accordance with another implementation, the first reagent cartridge assembly comprises a lid.

In accordance with another implementation, the first reagent cartridge assembly comprises a body to which the lid is pivotably coupled.

In accordance with another implementation, the lid covers the flow cell.

In accordance with another implementation, the system comprises a pick-and-place assembly to move the first flow cell from the first reagent cartridge assembly to the flow cell interface.

In accordance with another implementation, the pick-and-place assembly comprises an actuator and a gripper, the actuator to move the gripper, and the gripper to move the first flow cell from the first reagent cartridge assembly to the flow cell interface.

In accordance with another implementation, the gantry comprises a two-dimensional gantry.

In accordance with another implementation, the gantry comprises a pair of horizontal guides and a vertical guide movably coupled to the horizontal guides.

In accordance with another implementation, the carriage actuator is to move the carriage along the vertical guide.

In accordance with another implementation, the cartridge receptacle assembly comprises a lock movable between an unlocked position and a locked positon, a corresponding reagent cartridge positionable within the cartridge receptacle when the lock is in the unlocked position and the corresponding reagent cartridge is securable in the cartridge receptacle when the lock is in the locked position.

In accordance with another implementation, the lock comprises a lock actuator, an actuator rod, a link, and an arm, the actuator rod coupled to the lock actuator, the link pivotably coupling the actuator rod and the arm, the arm comprising a distal end coupled to the lock actuator at a pivot.

In accordance with another implementation, the lock actuator is to linearly move the actuator rod and cause the arm to move about the pivot between the locked position and the unlocked position.

In accordance with another implementation, the cartridge receptacle assembly defines a sipper access opening.

In accordance with another implementation, the sipper manifold assembly comprises a sipper actuator to move the sipper through the sipper access opening.

In accordance with another implementation, the sipper actuator comprises a linear actuator.

In accordance with another implementation, the sipper manifold assembly comprises a frame and a vertical guide coupled to the frame, the sipper actuator coupled to the frame and the sipper movably coupled to the vertical guide.

In accordance with another implementation, the sipper actuator to move the sipper along the vertical guide.

In accordance with another implementation, the sipper manifold assembly comprises a rack and pinion actuator to horizontally move the sipper.

In accordance with another implementation, the gantry comprises a horizontal guide and a vertical guide movably coupled to the horizontal guide.

In accordance with another implementation, the horizontal guide comprises a first rail and a first block and the vertical guide comprises a second rail and a second block.

In accordance with another implementation, further comprising a vertical frame coupled to the first block, the second rail coupled to the vertical frame, the carriage actuator coupled to the second block and the vertical frame to move the second block and the carriage.

In accordance with another implementation, further comprising a gantry actuator to horizontally move the carriage.

In accordance with another implementation, further comprising a horizonal frame to which the horizontal guide is coupled. The gantry actuator is to horizontally move the vertical guide.

In accordance with another implementation, the queue comprises a first position and a second position and comprises a first access aperture at the first position and a second access aperture at the second position, the reagent cartridges to be at the corresponding first position or the second position.

In accordance with another implementation, the queue comprises a shelf comprising a first receptacle at the first position and a second receptacle at the second position.

In accordance with another implementation, the carriage actuator is to move the carriage through the first access aperture to lift a corresponding reagent cartridge from the first position.

In accordance with another implementation, the carriage has a pair of protrusions.

In accordance with another implementation, further comprising the reagent cartridges.

In accordance with another implementation, the reagent cartridges each have a base defining downward opening apertures to receive the protrusions.

In accordance with another implementation, the carriage has a pair of lifting arms.

In accordance with another implementation, the carriage actuator is to move the carriage to position the lifting arms to lift the corresponding reagent cartridge.

In accordance with another implementation, further comprising a flow cell interface to receive a flow cell.

In accordance with another implementation, further comprising a pick-and-place assembly to move the flow cell to the flow cell interface.

In accordance with another implementation, the pick-and-place assembly comprises a gantry, corresponding actuators, and a gripper, the actuators to move the gripper.

In accordance with another implementation, the actuators comprises an x-actuator, a y-actuator, and a z-actuator.

In accordance with another implementation, the x-actuator is to move the gripper in the x-direction, the y-actuator is to move the gripper in the y-direction, and the z-actuator is to move the gripper in the z-direction.

In accordance with another implementation, the gantry of the pick-and-place assembly comprises a three-dimensional gantry.

In accordance with another implementation, the three-dimensional gantry comprises a first rail and a first block for the x-direction, a second rail and a second block for the y-direction, and a third rail and a third block for the z-direction.

In accordance with another implementation, the z-actuator comprises a nested linear actuator.

In accordance with another implementation, the nested linear actuator comprises a lead screw.

In accordance with another implementation, the pick-and-place assembly comprises a vertical linear actuator, a first arm, and a second arm, the first arm coupled to and between the vertical linear actuator and the second arm.

In accordance with another implementation, the vertical linear actuator comprises a rail and a block and the first arm is pivotably coupled to the block and the second arm is pivotably coupled to the first arm.

In accordance with another implementation, further comprising a first actuator and a second actuator, the first actuator to rotate the first arm relative to the block and the second actuator to rotate the second arm relative to the first arm.

In accordance with another implementation, the second arm comprises a distal end and a gripper is coupled at the distal end of the second arm.

In accordance with another implementation, further comprising a gripper actuator carried by the second arm to actuate the gripper.

In accordance with another implementation, the pick-and-place assembly comprises a vertical linear actuator, a first arm, and a second arm, the first arm coupled to and between the vertical linear actuator and the second arm.

In accordance with another implementation, further comprising a horizontal linear actuator. The vertical linear actuator comprises a rail and a block and the first arm is pivotably coupled to the block. The horizontal linear actuator couples the first arm and the second arm.

In accordance with another implementation, the second arm comprises a distal end and a gripper is coupled at the distal end of the second arm.

In accordance with another implementation, further comprising a gripper actuator carried by the second arm to actuate the gripper.

In accordance with another implementation, the carriage comprises a pair of inward extending lips.

In accordance with another implementation, the lips are to engage a portion of a corresponding reagent cartridge to enable the carriage to move the reagent cartridge from the vertical assembly to the cartridge conveyor assembly.

In accordance with another implementation, the carriage defines an opening between the lips.

In accordance with another implementation, the cartridge conveyor assembly comprises a first conveyor, a second conveyor, and a stop, the second conveyor having an end and the stop positioned at the end of the second conveyor.

In accordance with another implementation, the cartridge conveyor assembly comprises a pusher to move the reagent cartridge from the first conveyor to the second conveyer.

In accordance with another implementation, the stop is to be engaged by the reagent cartridge.

In accordance with another implementation, the sipper manifold assembly comprises a sipper actuator to move the sipper relative to the second conveyor.

In accordance with another implementation, the carriage defines an opening and the cartridge actuator is to move the carriage to enable the opening of the carriage to straddle the first conveyor.

In accordance with another implementation, the first conveyor is to move the reagent cartridge from the carriage.

In accordance with another implementation, the sipper manifold assembly comprises a sipper actuator to move the sipper relative to the conveyor.

In accordance with another implementation, the cartridge conveyor assembly comprises a first conveyor, a second conveyor, a third conveyor, the third conveyor positioned beneath the first conveyor.

In accordance with another implementation, the cartridge conveyor assembly further comprises a conveyor actuator to move the second conveyor between a raised position and a lowered position.

In accordance with another implementation, the sipper manifold assembly is positioned to access a reagent cartridge positioned on the second conveyor in the raised position.

In accordance with another implementation, further comprising a flow cell interface to receive a flow cell.

In accordance with another implementation, further comprising a pick-and-place assembly to move the flow cell to the flow cell interface.

In accordance with another implementation, further comprising a reagent cartridge assembly comprising a reagent cartridge and a flow cell, the reagent cartridge assembly to be positioned on the cartridge conveyor assembly.

In accordance with another implementation, the pick-and-place assembly is to move the flow cell from the reagent cartridge assembly to the flow cell interface.

In accordance with another implementation, the pick-and-place assembly comprises an actuator and a gripper, the actuator to move the gripper, and the gripper to move the flow cell from the reagent cartridge assembly to the flow cell interface.

In accordance with another implementation, the sipper actuator enables three-dimensional movement of the sipper.

In accordance with another implementation, the sipper actuator is to move the sipper vertically and horizontally.

In accordance with another implementation, further comprising a first carriage actuator and a second carriage actuator, the first carriage actuator to move the first carriage toward the sipper manifold assembly and the second carriage actuator to move the second carriage toward the sipper manifold assembly.

In accordance with another implementation, further comprising a door that enables access to the first carriage and the second carriage.

In accordance with another implementation, further comprising a lock that is actuatable between a locked position and an unlocked position. The door is movable between a closed position and an open position. The lock in the unlocked position to enable movement of the door from the closed position to the open position. The lock in the locked position to inhibit movement of the door from the closed position to the open position.

In accordance with another implementation, further comprising a flow cell interface to receive a flow cell.

In accordance with another implementation, further comprising a pick-and-place assembly to move the flow cell to the flow cell interface.

In accordance with another implementation, further comprising a reagent cartridge assembly comprising a reagent cartridge and a flow cell, the reagent cartridge assembly to be positioned on the first carriage or the second carriage.

In accordance with another implementation, the pick-and-place assembly is to move the flow cell from the reagent cartridge assembly to the flow cell interface.

In accordance with another implementation, the reagent cartridge assembly comprises a lid.

In accordance with another implementation, the reagent cartridge assembly comprises a body to which the lid is pivotably coupled.

In accordance with another implementation, the lid covers the flow cell.

In accordance with another implementation, further comprising a first carriage actuator to move the first carriage toward the sipper manifold assembly. The lid is to be moved from covering the flow cell.

In accordance with another implementation, further comprising moving the sipper relative to the cartridge receptacle using a sipper actuator.

In accordance with another implementation, positioning the first reagent cartridge in the cartridge receptacle comprises moving a lock of the cartridge receptacle assembly to an unlocked position to enable the first reagent cartridge to be positioned through an opening of the reagent cartridge receptacle and within the cartridge receptacle.

In accordance with another implementation, further comprising moving the lock from the unlocked position to the locked position after the first reagent cartridge is positioned within the receptacle to secure the first reagent cartridge in the cartridge receptacle.

In accordance with another implementation, moving the first reagent cartridge from the queue comprises positioning the carriage beneath the first reagent cartridge and moving the carriage through a first access aperture of a shelf of the queue to lift the first reagent cartridge from the first position.

In accordance with another implementation, moving the first reagent cartridge from the drawer comprises positioning the carriage beneath the first reagent cartridge and moving the carriage through an access aperture of the drawer to lift the first reagent cartridge from the drawer.

In accordance with another implementation, further comprising moving a flow cell from a first reagent cartridge assembly comprising the first reagent cartridge to a flow cell interface using a pick-and-place assembly.

In accordance with another implementation, moving the reagent cartridge from the vertical assembly to the cartridge conveyor assembly comprising positioning the reagent cartridge on a first conveyor of the cartridge conveyor assembly.

In accordance with another implementation, further comprising moving the reagent cartridge from the first conveyor to a second conveyor using a pusher, the second conveyor having an end and the stop positioned at the end of the second conveyor.

In accordance with another implementation, the first conveyor is positioned approximately perpendicular to the second conveyor.

In accordance with another implementation, further comprising moving a sipper of a sipper manifold assembly toward the reagent cartridge on the conveyor using a sipper actuator of the sipper manifold assembly.

In accordance with another implementation, the cartridge conveyor assembly comprises a first conveyor, a second conveyor, a third conveyor, the third conveyor positioned beneath the first conveyor, and accessing the first reagent cartridge comprises accessing the first reagent cartridge on the second conveyor.

In accordance with another implementation, further comprising moving the second conveyor between a raised position and a lowered position, the first reagent cartridge to move onto the third conveyor when the second conveyor is in the lowered position.

In accordance with another implementation, further comprising moving a flow cell to a flow cell interface using a pick-and-place assembly.

In accordance with another implementation, moving the flow cell to the flow cell interface comprises moving the flow cell from a reagent cartridge assembly comprising the reagent cartridge to the flow cell interface.

In accordance with another implementation, further comprising moving the first carriage carrying the first reagent cartridge toward the sipper manifold assembly using a first carriage actuator before drawings the first reagent from the first reagent cartridge.

In accordance with another implementation, further comprising moving the second carriage carrying the second reagent cartridge toward the sipper manifold assembly using a second carriage actuator before drawings the second reagent from the second reagent cartridge.

In accordance with another implementation, the sipper actuator enables three-dimensional movement of the sipper.

In accordance with another implementation, further comprising enabling access to the first carriage and the second carriage using a door.

In accordance with another implementation, further comprising inhibiting the door from moving from a closed position to an open position using a lock.

In accordance with another implementation, further comprising moving the first carriage carrying the first reagent cartridge toward the sipper manifold assembly and the lock inhibits the door from moving from the closed position to the open position when the first carriage is moved toward the sipper manifold assembly.

In accordance with another implementation, further comprising moving a flow cell to a flow cell interface using a pick-and-place assembly.

In accordance with another implementation, the arm actuator comprises a rack-and-pinion rotary actuator.

In accordance with another implementation, the lifting arms comprise inward extending protrusions that interact with the reagent cartridge to enable the lifting arms to lift the reagent cartridge.

In accordance with another implementation, the drawer is to receive a plurality of the reagent cartridges.

In accordance with another implementation, the queue is to receive a plurality of the reagent cartridges.

In accordance with another implementation, the apparatus includes a sipper manifold assembly comprising a sipper and a cartridge receptacle assembly comprising a cartridge receptacle.

In accordance with another implementation, the arm actuator is to actuate the lifting arms to position the lifting arms about the reagent cartridge at the queue and move the reagent cartridge from the queue and into the cartridge receptacle.

In accordance with another implementation, the cartridge receptacle assembly comprises a heater and the reagent cartridge comprises a well, the heater to heat the well when the cartridge receptacle receives the reagent cartridge.

In accordance with another implementation, the apparatus includes a pick-and-place assembly comprising a first arm, a second arm, and a vertical linear actuator, the second arm coupled to and between the vertical linear actuator and the first arm.

In accordance with another implementation, the apparatus includes a third arm, the vertical linear actuator to linearly move the third arm.

In accordance with another implementation, the third arm comprises a distal end and wherein the pick-and-place assembly comprises a gripper coupled at the distal end of the third arm.

In accordance with another implementation, the reagent cartridge contains clustering reagent.

In accordance with another implementation, the reagent cartridge is to contain clustering reagent.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect. In particular, all combinations of claimed subject matter appearing at the end of this disclosure are contemplated as being part of the subject matter disclosed herein.

### BRIEF DESCRIPTION OF THE DRAWINGS

FIG. 1 is a schematic diagram of an implementation of a system in accordance with the teachings of this disclosure.

FIG. 2A is a cross-sectional view of a portion of a system that can be used to implement the system of FIG. 1.

FIG. 2B is a detailed plan view of the sipper manifold assembly and the cartridge receptacle assembly of the system of FIG. 2A.

FIG. 3 is a schematic diagram of an implementation of a portion of a system that can be used to implement the system of FIG. 1.

FIG. 4 is an isometric view of an implementation of an example cartridge moving assembly that can be used to implement the cartridge moving assembly of FIG. 1.

FIG. 5 is an isometric view of the cartridge moving assembly of FIG. 4 and an implementation of an example queue that can be used to implement the system of FIG. 1.

FIG. 6A is an isometric view of an implementation of an example cartridge moving assembly that can be used to implement the cartridge moving assembly of FIG. 1.

FIG. 6B is an isometric view of an implementation of an example cartridge moving assembly that can be used to implement the cartridge moving assembly of FIG. 1.

FIG. 7 is an isometric view of an implementation of an example pick-and-place assembly that can be used to implement the pick-and-place assembly of the system of FIG. 1.

FIG. 8 is an isometric view of a portion of the pick-and-place assembly of FIG. 7.

FIG. 9 is an isometric view of an implementation of an example pick-and-place assembly that can be used to implement the pick-and-place assembly of the system of FIG. 1.

FIG. 10A is an isometric view of an implementation of an example pick-and-place assembly that can be used to implement the pick-and-place assembly of the system of FIG. 1.

FIG. 10B is an isometric view of an implementation of an example pick-and-place assembly that can be used to implement the pick-and-place assembly of the system of FIG. 1.

FIG. 11 is a schematic diagram of an implementation of another example system in accordance with the teachings of this disclosure.

FIG. 12 is an isometric view of an implementation of an example vertical assembly and an example cartridge conveyor assembly that can be used to implement the system of FIG. 11.

FIG. 13 is a schematic diagram of an implementation of another example system in accordance with the teachings of this disclosure.

FIG. 14 is a schematic view of an example first vertical assembly, a second vertical assembly, and a conveyor extending between the vertical assemblies that can be used to implement the system of FIG. 13.

FIG. 15 is a schematic diagram of an implementation of another example system in accordance with the teachings of this disclosure.

FIG. 16 is an isometric view of an implementation of an example cartridge conveyor assembly that can be used to implement the cartridge conveyor assembly of FIG. 15.

FIG. 17 is a schematic implementation of an example cartridge conveyor assembly that can be used to implement the cartridge conveyor assembly of FIG. 15.

FIG. 18A is a schematic diagram of an implementation of another example system in accordance with the teachings of this disclosure.

FIG. 18B is an isometric view of an implementation of an example first carriage, an example second carriage, and an example sipper manifold assembly that can be used to implement the first carriage, the second carriage, and the sipper manifold assembly of the system of FIG. 18A.

FIG. 19 illustrates a flowchart for a process of implementing the examples disclosed herein.

FIG. 20 illustrates a flowchart for a process of implementing the examples disclosed herein.

FIG. 21 illustrates a flowchart for a process of implementing the examples disclosed herein.

FIG. 22 illustrates a flowchart for a process of implementing the examples disclosed herein.

FIG. 23 illustrates a flowchart for a process of implementing the examples disclosed herein.

FIG. 24 depicts a schematic view of an example of a system that may be used to provide biological or chemical analysis.

FIG. 25 depicts a schematic view of an example of a set of components that may cooperate to provide a fluid path in the system of FIG. 24.

FIG. 26 depicts a schematic view of another example of a system that may be used to provide biological or chemical analysis.

FIG. 27 depicts a cross-sectional view of an example of a flow cell that may be used in the system of FIG. 24.

FIG. 28 depicts a cross-sectional view of another example of a flow cell that may be used in the system of FIG. 24.

FIG. 29 depicts a top plan view of the flow cell of FIG. 28, with an upper wafer omitted to reveal a lower wafer.

FIG. 30 depicts a schematic view of another example of a system that may be used to provide biological or chemical analysis.

FIG. 31 depicts a schematic view of an example of imaging components that may be integrated into the system of FIG. 30.

FIG. 32 depicts a schematic view of another example of imaging components that may be integrated into the system of FIG. 30.

FIG. 33 depicts a schematic view of another example of imaging components that may be integrated into the system of FIG. 30.

FIG. 34 depicts a schematic view of an example of a networked system in which the system of FIG. 24, 26, or 30 may be incorporated.

FIG. 35 depicts a schematic view of an example of a base calling arrangement that may be carried out using the system of FIG. 24, 26, 30, or 34.

FIG. 36 depicts a graph showing examples of Gaussian clouds representing a probabilistic distribution of base-wise intensity outputs of the bases during a sequencing operation using the system of FIG. 24, 26, 30, or 34.

FIG. 37 depicts a schematic view of an example of a base caller training technique that may be implemented using the system of FIG. 24, 26, 30, or 34.

FIG. 38 depicts a schematic view of an example of a structural variation graph genome that may be generated using the system of FIG. 24, 26, 30, or 34.

FIG. 39 depicts a schematic view of an example of nucleotide read alignments that may be provided based on the structural variation graph genome of FIG. 38.

### DETAILED DESCRIPTION

Although the following text discloses a detailed description of implementations of methods, apparatuses and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

The following detailed description of certain examples will be better understood when read in conjunction with the appended drawings. To the extent that the figures illustrate diagrams of the functional blocks of various examples, the functional blocks are not necessarily indicative of the division between hardware components. Thus, for example, one or more of the functional blocks (e.g., processors or memories) may be implemented in a single piece of hardware (e.g., a general purpose signal processor or random access memory, hard disk, or the like). Similarly, the programs may be stand-alone programs, may be incorporated as subroutines in an operating system, may be functions in an installed software package, and the like. It should be understood that the various examples are not limited to the arrangements and instrumentality shown in the drawings.

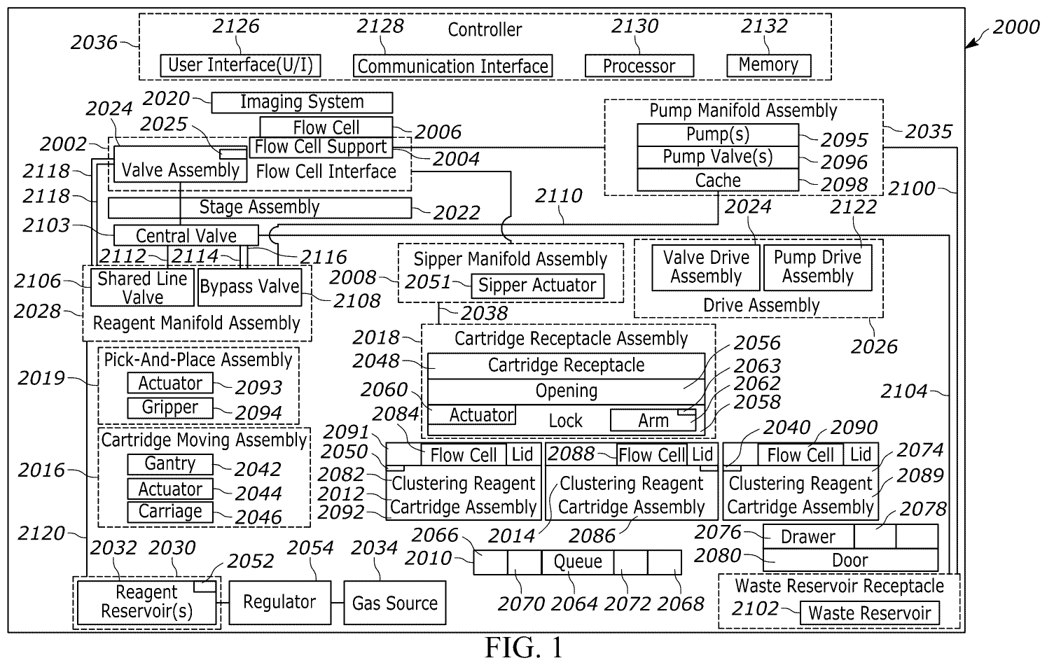

FIG. 1 is a schematic diagram of an implementation of a system 2000 in accordance with the teachings of this disclosure. The system 2000 may provide dynamic queuing and/or processing of reagent cartridges and/or flow cells. The system 2000 can be used to perform an analysis on one or more samples of interest. The sample may include one or more DNA clusters that have been linearized to form a single stranded DNA (sstDNA).

The system 2000 includes a flow cell interface 2002 having a flow cell support 2004 that is adapted to support a flow cell 2006 in the implementation shown. As used herein, a “flow cell” can include a device having a lid extending over a reaction structure to form a flow channel therebetween that is in communication with a plurality of reaction sites of the reaction structure, and can include a detection device that detects designated reactions that occur at or proximate to the reaction sites. The flow cell interface 2002 may be associated with and/or referred to as a flow cell deck and the flow cell support 2004 may be associated with and/or referred to as a flow cell chuck. The flow cell support 2004 can include a vacuum channel, latches, a snap fit mechanism, and/or a tongue-and-groove coupling that is used to secure the flow cell 2006 to the flow cell support 2004.

The system 2000 also includes, in part, a sipper manifold assembly 2008, a queue 2010 to carry a first reagent cartridge 2012 and a second reagent cartridge 2014, a cartridge receptacle assembly 2018, a pick-and-place assembly 2019, an imaging system 2020, a stage assembly 2022, a reagent selector valve assembly 2024 having a valve 2025, a drive assembly 2026, a reagent manifold assembly 2028, a reagent reservoir receptacle 2030 that receives a reagent reservoir 2032, a gas source 2034, a pump manifold assembly 2035, and a controller 2036. The reagent selector valve assembly 2024 may be referred to as a mini-valve assembly. The controller 2036 is electrically and/or communicatively coupled to components of the system 2000, such as the sipper manifold assembly 2008, the cartridge receptacle assembly 2018, the pick-and-place assembly 2019, the imaging system 2020, the stage assembly 2022, the reagent selector valve assembly 2024, the drive assembly 2026, the reagent manifold assembly 2028, and/or the pump manifold assembly 2035 and is adapted to cause the sipper manifold assembly 2008, the cartridge receptacle assembly 2018, the imaging system 2020, the stage assembly 2022, the reagent selector valve assembly 2024, the drive assembly 2026, the reagent manifold assembly 2028, and/or the pump manifold assembly 2035 to perform various functions as disclosed herein.

The sipper manifold assembly 2008 has a sipper 2038 and the queue 2010 carries the first reagent cartridge 2012 and the second reagent cartridge 2014 in the implementation shown. The cartridge moving assembly 2016 includes a gantry 2042, a carriage actuator 2044, and a carriage 2046. The carriage 2046 is coupled to the gantry 2042 and the carriage actuator 2044 moves the carriage 2046 relative to the gantry 2042 in operation.

The cartridge receptacle assembly 2018 has a cartridge receptacle 2048 that receives the first reagent cartridge 2012 or the second reagent cartridge 2014. The carriage 2046 moves the first reagent cartridge 2012 from the queue 2010 and positions the first reagent cartridge 2012 into the cartridge receptacle 2048 in operation. The carriage 2046 may alternatively move the second reagent cartridge 2014 from the queue 2010 and position the second reagent cartridge 2014 into the cartridge receptacle 2048. The system 2000 thus enables the carriage 2046 to dynamically select any reagent cartridge carried by the queue 2010 and/or the system 2000 in any order and position that reagent cartridge within the cartridge receptacle 2048 to enable a corresponding operation to be performed. The system 2000 enables the order that reagent cartridges are processed to be dynamically updated based on changes in priorities, for example.

The first reagent cartridge 2012 and/or the second reagent cartridge 2014 may be referred to as a clustering reagent cartridge and may each contain clustering reagent 2050 that may be used to perform one or more clustering operations. The sipper manifold assembly 2008 has a sipper actuator 2051 to move the sipper 2038 relative to the cartridge receptacle 2048. The sipper 2038 may draw the clustering reagent 2050 from the corresponding reagent reservoir 2012, 2014 into the sipper manifold assembly 2008.

The reagent reservoir 2032 may include reagents 2052 used during sequencing operations and may be referred to as sequencing reagents. Some of the reagents 2052 may include a cleave reagent, an incorporation reagent, a scan reagent, a cleave wash, and/or a wash buffer as examples. The reagents 2052 may be referred to as bulk reagents in some instances. The gas source 2034 may be used to pressurize the reagent regent reservoir 2032 to flow one or more liquid reagents (e.g., A, T, G, C nucleotides) to the flow cell 2006. A regulator 2054 can be positioned between the gas source 2034 and the reagent reservoir 2032 and regulates a pressure of the gas provided to the reagent reservoir 2032. The regulator 2054 may alternatively not be included.

The clustering reagent 2050 from the reagent cartridges 2012 and/or 2014 may be used during clustering operations/generation and the reagent 2052 from the reagent reservoir 2032 may be used during sequencing operations such as sequencing-by-synthesis (SBS). The flow cell 2006 may be positioned on the flow cell interface 2002 during the clustering operations and the sequencing operations. The flow cell 2006 may alternatively be positioned at another location within the system 2000 during the clustering operations and the flow cell 2006 may be positioned on the flow cell interface 2002 during sequencing operations.

The cartridge receptacle assembly 2018 has an opening 2056 and a lock 2058 movable between an unlocked position and a locked position. The first reagent cartridge is positionable through the opening 2056 when the lock 2058 is in the unlocked position and the first reagent cartridge 2012 is securable in the cartridge receptacle 2048 when the lock 2058 is in the locked position. The lock 2058 includes a lock actuator 2060 and an arm 2062 in the implementation shown. The lock 2058 may also include a heater 2063. The heater 2063 may be a resistive heater as an example. The heater 2063 may be carried by the arm 2062. The reagent cartridges 2012, 2014 may include one or more sample wells and the heater 2063 may be used to heat a sample within the sample wells during one or more processes. The processes may include a hybridization process and/or a denaturing process. The heater 2063 may have an aperture(s) that receives the sample well and/or the heater 2063 may surround the sample well in some examples. The lock actuator 2060 moves the arm 2062 from the unlocked position to the locked position. The system 2000 may include additional cartridge receptacle assemblies 2018 than shown. The system 2000 may include four cartridge receptacle assemblies 2018 as an example. The system 2000 may include a number of flow cell supports 2004 that corresponds to the number of cartridge receptacle assemblies 2018. For example, if the system 2000 has eight cartridge receptacle assemblies 2018, the system 2000 may also have eight flow cell supports 2004.

The queue 2010 has a shelf 2064 having a first position 2066 and a second position 2068. The first reagent cartridge 2012 is shown positioned at the first position 2066 and the second reagent cartridge 2014 is shown positioned at the second position 2068. The queue 2010 may include any number of positions to carry a corresponding number of reagent cartridges 2012, 2014, however. For example, the queue 2010 may include four positions, six positions, seven positions, and/or eleven positions.

The shelf 2064 includes a first access aperture 2070 at the first position 2066 and a second access aperture 2072 at the second position 2068 in the implementation shown. The carriage actuator 2044 positions the carriage 2046 beneath the first reagent cartridge 2012 in operation and moves the carriage 2046 through the first access aperture 2070 to lift the first reagent cartridge 2012 from the first position 2066. The carriage actuator 2044 may similarly position the carriage 2046 beneath the second reagent cartridge 2014 and move the carriage 2046 through the second access aperture 2072 to lift the second reagent cartridge 2014 from the second position 2068. The cartridge moving assembly 2016 may dynamically select the reagent cartridge 2012, 2014 to move from the shelf 2064 to perform an associated clustering operation based on an initial order of the queue and/or based on a changed order of the queue.

A third reagent cartridge 2074 is included in the implementation shown and the system 2000 has a drawer 2076 carrying the third reagent cartridge 2074. The drawer 2076 includes an access aperture 2078 in the implementation shown. The carriage actuator 2044 positions the carriage 2046 beneath the third reagent cartridge 2074 in operation and moves the carriage 2046 through the access aperture 2078 of the drawer 2076 to lift the third reagent cartridge 2074 from the drawer 2076. The carriage 2046 moves the third reagent cartridge 2074 from the drawer 2076 onto the queue 2010 and/or into the cartridge receptacle assembly 2018, in operation. The carriage 2046 may position the third reagent cartridge 2074 at the first position 2066 and/or the second position 2068 after the corresponding reagent cartridge 2012, 2014 is moved and/or used. The carriage 2046 may also move reagent cartridges 2012, 2014, and/or 2074 from the cartridge receptacle assembly 2018 to the drawer 2076 after use for disposal. The drawer 2076 may alternatively carry additional reagent cartridges 2074. For example, the drawer 2076 may carry two reagent cartridges 2012, 2014, and/or 2074, four reagent cartridges 2012, 2014, and/or 2074, eight reagent cartridges 2012, 2014, and/or 2074, etc. The system 2000 is also shown including a door 2080 that is movable to enable access to the drawer 2076. The door 2080 may alternatively be omitted in other examples.

A first reagent cartridge assembly 2082 is shown including the first reagent cartridge 2012 and a first flow cell 2084. The first flow cell 284 may be received by the flow cell interface 2002. A second reagent cartridge assembly 2086 is also shown including the second reagent cartridge 2014 and a second flow cell 2088 and a third reagent cartridge assembly 2089 is shown including the third reagent cartridge 2074 and a third flow cell 2090. The flow cells 2084, 2088, 2090 may each carry a sample of interest. The first reagent cartridge assembly 2082 has a lid 2091 and a body 2092 to which the lid 2091 is pivotably coupled. The lid 2091 is coupled to the body 2092 by a hinge in the implementation shown. The lid 2091 covers the first flow cell 2084. The lid 2091 may alternatively be omitted or may be removable from the body 2092, however. The lid 2091 may be removable by an individual in such an example.

The pick-and-place assembly 2019 may move the first flow cell 2006 from the first reagent cartridge assembly 2082 to the flow cell interface 2002 in operation. The pick-and-place assembly 2019 has an actuator 2093 and a gripper 2094. The actuator 2093 moves the gripper 2094 and the gripper 2094 moves the first flow cell 2006 from the first reagent cartridge assembly 2082 to the flow cell interface 2002.

Prior to referring to some of the additional components of the system 2000 of FIG. 1 such as some of the fluidic components, it is noted that while some components of the system 2000 are shown once and coupled to the single flow cell 2006, in some implementations, these components may be duplicated or otherwise multiplied, thereby allowing more flow cells 2006 to be used with the system 2000 (e.g., 2, 3, 4) and each flow cell 2006 can have its own corresponding components as a result. Each flow cell 2006 may be associated with a separate cartridge receptacle assembly 2018 and/or pump manifold assembly 2035 as examples when more than one flow cell 2006 is included with the system 2000.

The pump manifold assembly 2035 includes one or more pumps 2095, one or more pump valves 2096, and a cache 2098. The drive assembly 2026 interfaces with the sipper manifold assembly 2008 and the pump manifold assembly 2035 to flow one or more clustering reagents 2050 that interact with the sample within the corresponding flow cell 2006. One or more of the valves 2096 may be implemented by a rotary valve, a pinch valve, a flat valve, a solenoid valve, a check valve, a piezo valve, and/or a three-way valve. However, different types of fluid control devices may be used. One or more of the pumps 2095 may be implemented by a syringe pump, a peristaltic pump, and/or a diaphragm pump. Other types of fluid transfer devices may be used, however. The cache 2098 may be a serpentine cache and may temporarily store one or more reaction components during bypass manipulations of the system 100 of FIG. 1. While the cache 2098 is shown being included in the pump manifold assembly 2035, in another implementation, the cache 2098 may be located in a different location.

A primary waste fluidic line 2100 is coupled between the pump manifold assembly 2035 and a waste reservoir 2102. The pumps 2095 and/or the pump valves 2096 of the pump manifold assembly 2035 selectively flow the reaction components from the flow cell 2006 to the primary waste fluidic line 2100 in some implementations.

The flow cell 2006 is coupled to a central valve 2103 via the flow cell interface 2002. An auxiliary waste fluidic line 2104 is coupled to the central valve 2103 and to the waste reservoir 2102. The auxiliary waste fluidic line 2104 flows the excess fluid to the waste reservoir 2102 in some implementations. The auxiliary waste fluidic line 2104 may alternatively be omitted.

The reagent manifold assembly 2028 includes a shared line valve 2106 and a bypass valve 2108 in the implementation shown. The shared line valve 2106 may be referred to as a reagent selector valve. The reagent selector valve assembly 2024, the central valve 2103, and/or the valves 2106, 2108 of the reagent manifold assembly 2028 may be selectively actuated to control the flow of fluid through fluidic lines 2110, 2112, 2114, 2116, 2118. One or more of the valves 2025, 2096, 2103, 2106 may be implemented by a rotary valve, a pinch valve, a flat valve, a solenoid valve, a check valve, a piezo valve, and/or a three-way valve. Other fluid control devices may prove suitable.

The reagent manifold assembly 2028 may be coupled to a corresponding number of reagents reservoirs 2032 via fluidic lines 2120. The reagent reservoirs 2032 may contain fluid (e.g., reagent and/or another reaction component). While the system 2000 includes the fluidic lines 2120 and the gas source 2034 to urge the reagent 2052 toward the flow cell 2006 under positive pressure, the system 2000 may alternatively include a sipper manifold assembly including one or more sippers that draw the reagent 2052 to the flow cell 2006, as an example. The gas source 2034 and the regulator 2054 may be omitted in such an example.

The shared line valve 2106 of the sipper manifold assembly 2008 is coupled to the central valve 2103 via the shared reagent fluidic line 2112. Different reagents may flow through the shared reagent fluidic line 2112 at different times. In an implementation, the pump manifold assembly 2035 may draw wash buffer through the shared reagent fluidic line 2112, the central valve 2103, and the corresponding flow cell 2006 when performing a flushing operation before changing between one reagent and another. The shared reagent fluidic line 2112 may, thus, be involved in the flushing operation. While one shared reagent fluidic line 2112 is shown, any number of shared fluidic lines may be included in the system 100.

The bypass valve 2108 of the sipper manifold assembly 2008 is coupled to the central valve 2103 via the reagent fluidic lines 2114, 2116. The central valve 2103 may have one or more ports that correspond to the reagent fluidic lines 2114, 2116.

The dedicated fluidic lines 2118 are coupled between the sipper manifold assembly 2008 and the reagent selector valve assembly 2024. Each of the dedicated reagent fluidic lines 2118 may be associated with a single reagent. The fluids that flow through the dedicated reagent fluidic lines 2118 may be used during sequencing operations and may include a cleave reagent, an incorporation reagent, a scan reagent, a cleave wash, and/or a wash buffer. Because only a single reagent may flow through each of the dedicated reagent fluidic lines 2118, the dedicated reagent fluidic lines 2118 themselves may not be flushed when performing a flushing operation before changing between one reagent and another. The approach of including dedicated reagent fluidic lines 2118 may be helpful when the system 2000 uses reagents that may have adverse reactions with other reagents. Reducing a number of fluidic lines or a length of the fluidic lines that are flushed when changing between different reagents moreover reduces reagent consumption and flush volume and may decrease cycle times of the system 2000. While two dedicated reagent fluidic lines 2118 are shown, any number of dedicated fluidic lines may be included in the system 2000.

The bypass valve 2108 is also coupled to the cache 2098 of the pump manifold assembly 2035 via the bypass fluidic line 2110. One or more reagent priming operations, hydration operations, mixing operations, and/or transfer operations may be performed using the bypass fluidic line 2110. The priming operations, the hydration operations, the mixing operations, and/or the transfer operations may be performed independent of the flow cell 2006. The operations using the bypass fluidic line 2110 may thus occur during incubation of one or more samples of interest within the flow cell 2006. That is, the shared line valve 2106 can be utilized independently of the bypass valve 2108 such that the bypass valve 2108 can utilize the bypass fluidic line 2110 and/or the cache 2098 to perform one or more operations while the shared line valve 2106 and/or the central valve 2103 simultaneously, substantially simultaneously, or offset synchronously perform other operations. The system 2000 can thus perform multiple operations at once, thereby reducing run time.

The drive assembly 2026 includes a pump drive assembly 2122 and a valve drive assembly 2124. The pump drive assembly 2122 may be adapted to interface with the one or more pumps 2095 to pump fluid through the flow cell 2006 and/or to load one or more samples of interest into the flow cell 2006. The valve drive assembly 2124 may be adapted to interface with one or more of the valves 2025, 2096, 2103, 2106, 2108 to control the position of the corresponding valves 2025, 2096, 2103, 2106, 2108.

Referring to the controller 2036, in the implementation shown, the controller 2036 includes a user interface 2126, a communication interface 2128, one or more processors 2130, and a memory 2132 storing instructions executable by the one or more processors 2130 to perform various functions including the disclosed implementations. The user interface 2126, the communication interface 2128, and the memory 2132 are electrically and/or communicatively coupled to the one or more processors 2130.

In an implementation, the user interface 2126 is adapted to receive input from a user and to provide information to the user associated with the operation of the system 2000 and/or an analysis taking place. The user interface 2126 may include a touch screen, a display, a key board, a speaker(s), a mouse, a track ball, and/or a voice recognition system. The touch screen and/or the display may display a graphical user interface (GUI).

In an implementation, the communication interface 2128 is adapted to enable communication between the system 2000 and a remote system(s) (e.g., computers) via a network(s). The network(s) may include the Internet, an intranet, a local-area network (LAN), a wide-area network (WAN), a coaxial-cable network, a wireless network, a wired network, a satellite network, a digital subscriber line (DSL) network, a cellular network, a Bluetooth connection, a near field communication (NFC) connection, etc. Some of the communications provided to the remote system may be associated with analysis results, imaging data, etc. generated or otherwise obtained by the system 2000. Some of the communications provided to the system 2000 may be associated with a fluidics analysis operation, patient records, and/or a protocol(s) to be executed by the system 2000.

The one or more processors 2130 and/or the system 2000 may include one or more of a processor-based system(s) or a microprocessor-based system(s). In some implementations, the one or more processors 2130 and/or the system 2000 includes one or more of a programmable processor, a programmable controller, a microprocessor, a microcontroller, a graphics processing unit (GPU), a digital signal processor (DSP), a reduced-instruction set computer (RISC), an application specific integrated circuit (ASIC), a field programmable gate array (FPGA), a field programmable logic device (FPLD), a logic circuit, and/or another logic-based device executing various functions including the ones described herein.

The memory 2132 can include one or more of a semiconductor memory, a magnetically readable memory, an optical memory, a hard disk drive (HDD), an optical storage drive, a solid-state storage device, a solid-state drive (SSD), a flash memory, a read-only memory (ROM), erasable programmable read-only memory (EPROM), electrically erasable programmable read-only memory (EEPROM), a random-access memory (RAM), a non-volatile RAM (NVRAM) memory, a compact disc (CD), a compact disc read-only memory (CD-ROM), a digital versatile disk (DVD), a Blu-ray disk, a redundant array of independent disks (RAID) system, a cache and/or any other storage device or storage disk in which information is stored for any duration (e.g., permanently, temporarily, for extended periods of time, for buffering, for caching).

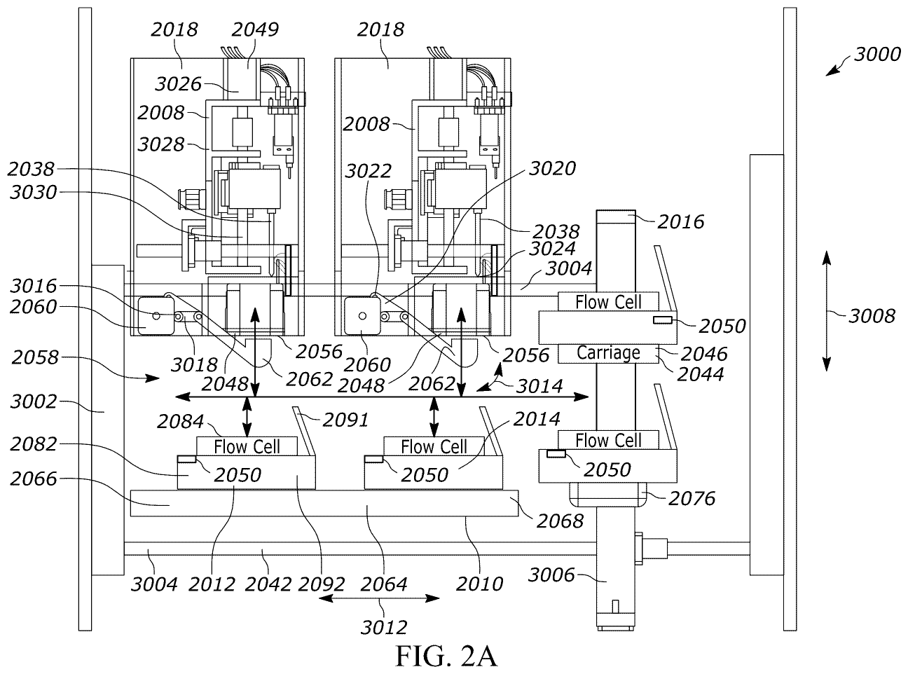

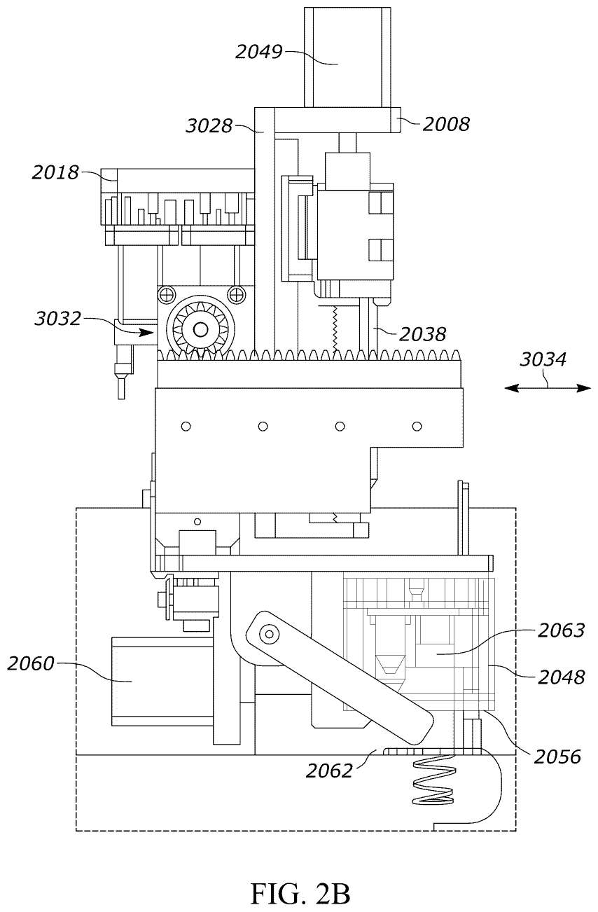

FIG. 2A is a cross-sectional view of a portion of a system 3000 that can be used to implement the system 2000 of FIG. 1. The system 3000 includes the sipper manifold assembly 2008 having the sipper 2038 and the queue 2010 to carry reagent cartridges 2012, 2014. The system 3000 also includes the cartridge moving assembly 2016 including the gantry 2042, the carriage actuator 2044, and the carriage 2046 and the cartridge receptacle assembly 2018 including the cartridge receptacle 2048. The carriage 2046 is coupled to the gantry 2042 and the carriage actuator 2044 moves the carriage 2046 relative to the gantry 2042. The carriage 2046 moves the reagent cartridges from the queue 2010 to the cartridge receptacle assembly 2018 in operation.

The gantry 2042 is a two-dimensional gantry 3002 in the implementation shown and includes a pair of horizontal guides 3004 and a vertical guide 3006 movably coupled to the horizontal guides 3004. The carriage actuator 2044 moves the carriage 2046 along the vertical guide 3006 in operation in a direction generally indicated by arrow 3008. The gantry 4042 also includes a second actuator that moves the carriage along the horizonal guides 3004 in a direction generally indicated by arrow 3012.

The cartridge receptacle assembly 2018 includes the lock 2058 movable between an unlocked position and a locked position in a direction generally indicated by arrow 3014. One of the reagent cartridges 2012, 2014 is positionable within the cartridge receptacle 2048 when the lock 2058 is in the unlocked position and the reagent cartridge 2012, 2014 is securable in the cartridge receptacle 2048 when the lock 2058 is in the locked position

The lock 2058 includes a lock actuator 2060, an actuator rod 3016, a link 3018, and an arm 2062 in the implementation shown. The actuator rod 3016 is coupled to the lock actuator 2060 and the link 3018 pivotably couples the actuator rod 3016 and the arm 2062. The arm 2062 has a distal end 3020 coupled to the lock actuator 2060 at a pivot 3022. The lock actuator 2060 linearly moves the actuator rod 3016 and causes the arm 2062 to move about the pivot 3022 between the locked position and the unlocked position. The lock actuator 2060 may alternatively linearly move the arm 2062 between the locked position and the unlocked position. The lock actuator 2060 may be implemented by a linear actuator in such examples.

The cartridge receptacle assembly 2018 defines a sipper access opening 3024 and the sipper manifold assembly 2008 has the sipper actuator 2049 to move the sipper 2038 through the sipper access opening 3024. The sipper actuator 2049 is shown implemented by a linear actuator 3026. The sipper actuator 2049 may be implemented by different types of actuators, however.

The sipper manifold assembly 2008 includes a frame 3028 and a vertical guide 3030 coupled to the frame 3028 in the implementation shown. The sipper actuator 2049 is coupled to the frame 3028 and the sipper 2038 is movably coupled to the vertical guide 3030. The sipper actuator 2049 moves the sipper 2038 along and/or relative to the vertical guide 3030 in operation.

FIG. 2B is a detailed plan view of the sipper manifold assembly 2008 and the cartridge receptacle assembly 2018 of the system 3000 of FIG. 2A. The sipper manifold assembly 2008 is shown having a rack and pinion actuator 3032 to horizontally move the sipper 2038 in a direction generally indicated by arrow 3034. The rack and pinion actuator 3032 may move the sipper 2038 in the direction generally indicated by arrow 3034 to allow the sipper 2038 to access different wells of the reagent cartridge 2012, 2014, for example.

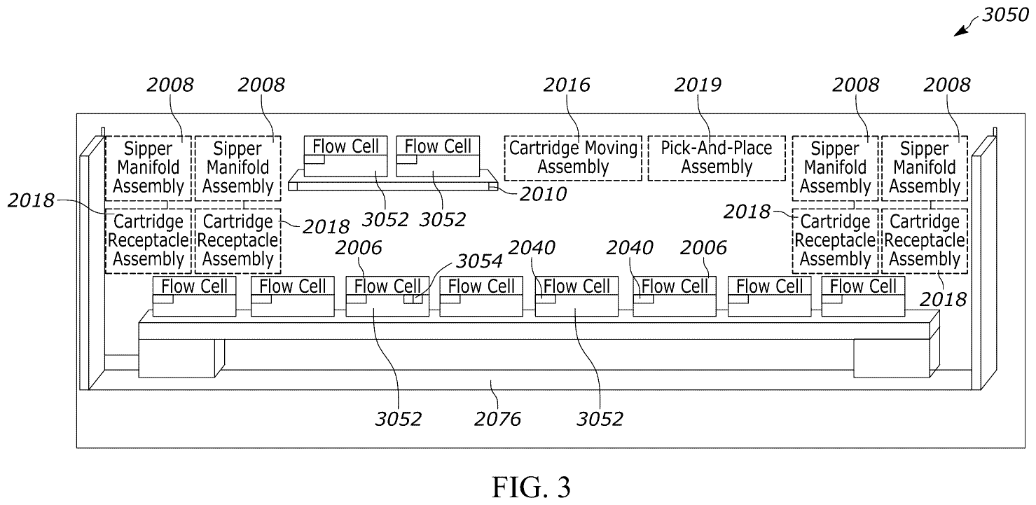

FIG. 3 is a schematic diagram of an implementation of a portion of a system 3050 that can be used to implement the system 2100 of FIG. 1. The system 3050 includes the drawer 2076, the cartridge moving assembly 2016, the queue 2010, the pick-and-place assembly 2019, a plurality of the sipper manifold assemblies 2008 and a corresponding number of cartridge receptacle assemblies 2018. The drawer 2076 is shown carrying a plurality of reagent cartridges 3052 and the queue 2010 is shown carrying a pair of the reagent cartridges 3052. The drawer 2076 is shown carrying eight reagent cartridges 3052 and the queue 2010 is shown carrying two reagent cartridges 3052. The drawer 2076 may carry any number of the reagent cartridges 3052 and the queue 2010 may carry any number of the reagent cartridges 3052.

The reagent cartridges 3052 are each shown carrying a flow cell 2006. The flow cell 2006 may be removed from the reagent cartridge 3052 using the pick-and-place assembly 2019 and moved to a corresponding flow cell support 2004. The reagent cartridges 3052 may include a plurality of wells 3054. One or more of the wells 3054 may include reagent and/or one or more of the wells 3054 may include a sample.

The cartridge moving assembly 2016 may move one of the reagent cartridges 3052 from the drawer 2076 to the queue 2010 in operation and then to one of the cartridge receptacle assemblies 2018. The cartridge moving assembly 2016 may alternatively move one of the reagent cartridges 3052 from the drawer 2076 directly to one of the cartridge receptacle assemblies 2018. The cartridge moving assembly 2016 may move one of the reagent cartridges 3052 from the cartridge receptacle assemblies 2018 to the queue 2010 and/or to the drawer 2076.

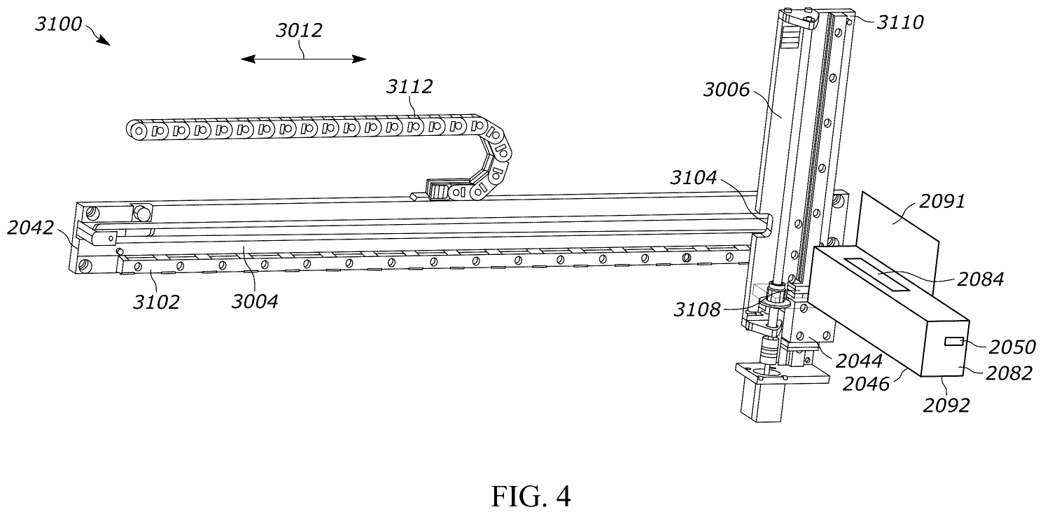

FIG. 4 is an isometric view of an implementation of an example cartridge moving assembly 3100 that can be used to implement the cartridge moving assembly 2016 of FIG. 1. The gantry 2042 of the cartridge moving assembly 3100 is shown including the horizontal guide 3004 and the vertical guide 3006 that is movably coupled the horizontal guide 3004. A single horizontal guide 3004 is shown in FIG. 4. Additional horizontal guides may be included, however.

The horizontal guide 3004 has a first rail 3102 and a first block 3104 and the vertical guide 3006 has a second rail 3106 and a second block 3108. A vertical frame 3110 is coupled to the first block 3104 and the second rail 3106 is coupled to the vertical frame 3110. The carriage actuator 2044 is coupled to the second block 3108 and the vertical frame 3110 moves the second block 3108 and the carriage 2046.

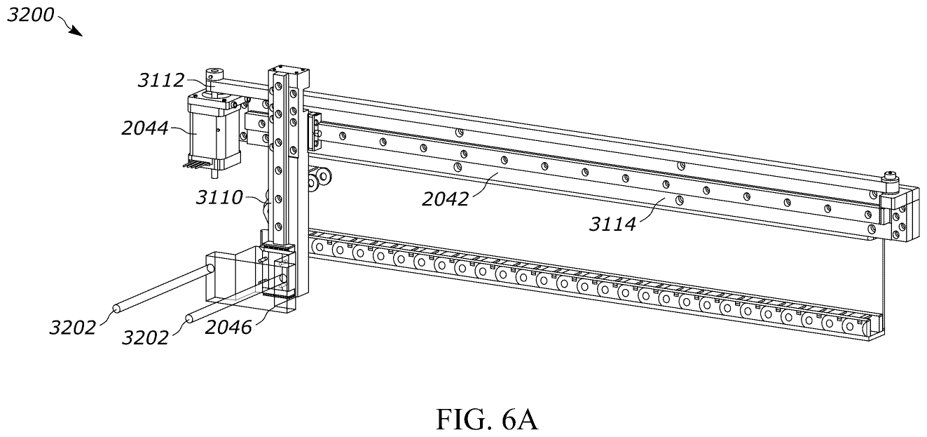

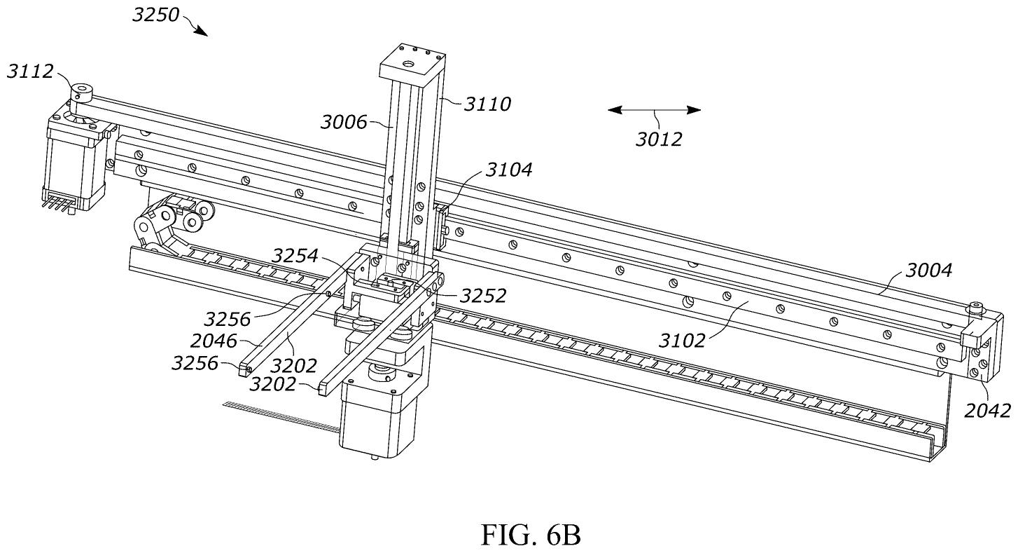

The cartridge moving assembly 3100 also includes a gantry actuator 3112 to horizontally move the carriage 2046 and the vertical frame 3110 to which the horizontal guide 3004 is coupled. The gantry actuator 3112 may be belt-driven actuator in some implementations (see, FIG. 6A). The gantry actuator 3112 horizontally moves the vertical guide 3006 in the direction generally indicated by arrow 3012.

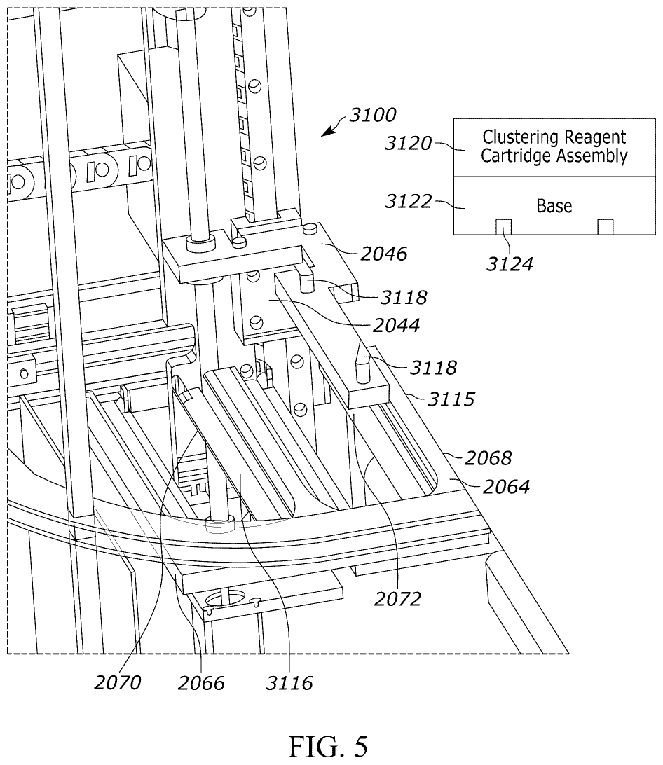

FIG. 5 is an isometric view of the cartridge moving assembly 3100 of FIG. 4 and an implementation of an example queue 3115 that can be used to implement the system 2000 of FIG. 1. The queue 3115 of FIG. 5 has the first position 2066 and the second position 2068 and includes the first access aperture 2070 at the first position 2066 and the second access aperture 2072 at the second position 2068. The reagent cartridges 2012, 2014 are to be at the corresponding first position 2066 or the second position 2068. The queue 3115 has the shelf 2064 including a first receptacle 3116 at the first position 2066 and a second receptacle 3117 at the second position 2068. The receptacles 3116, 3117 receive the corresponding reagent cartridges 2012, 2014 and are recessed in the implementation shown.

The carriage 2046 has a pair of protrusions 3118. A reagent cartridge 3120 is included that has a base 3122 defining downward opening apertures 3124. The apertures 3124 are positioned to receive the protrusions 3118 to position the reagent cartridge 3120 on the carriage 2046. The protrusions 3118 are tapered in the implementation shown to more easily align the protrusions 3118 and the apertures 3124.

FIG. 6A is an isometric view of an implementation of an example cartridge moving assembly 3200 that can be used to implement the cartridge moving assembly 2016 of FIG. 1. The carriage 2046 in the implementation shown has a pair of lifting arms 3202. The carriage actuator 2044 moves the carriage 2046 to position the lifting arms 3202 to lift the corresponding reagent cartridge 2012, 2014 in operation. The lifting arms 3202 may thus be fixed. The lifting arms 3202 may alternatively be implemented by grippers 2094 that are movable toward one another as another example.

FIG. 6B is an isometric view of an implementation of an example cartridge moving assembly 3250 that can be used to implement the cartridge moving assembly 2016 of FIG. 1. The cartridge moving assembly 3250 includes the carriage actuator 2044 and the carriage 2046 including the pair of lifting arms 3202 and an arm actuator 3252. The arm actuator 3252 actuates the lifting arms 3202 in operation to position the lifting arms 3202 about the reagent cartridge 3052 and the carriage 2046 moves the reagent cartridge 3052 from the drawer 2076 to the queue 2010 and/or from the drawer 2076 to the cartridge receptacle assembly 2018. The carriage 2012, 3052 may alternatively move the reagent cartridge 2012, 3052 from the drawer 2076 to the queue 2010 and/or from the drawer 2076 to the cartridge receptacle assembly 2018.

The arm actuator 3252 is shown as a rack-and-pinion rotary actuator 3254. The arm actuator 3252 may be implemented as a different actuator type, however. The lifting arms 3202 include inward extending protrusions 3256 in the implementation shown that interact with the reagent cartridge 2012, 3052 to enable the lifting arms 3202 to lift the reagent cartridge 2012, 3052. The reagent cartridge 2012, 3052 may include corresponding apertures that receive the protrusions 3256. The lifting arms 3202 may additionally or alternatively include different surface structures.

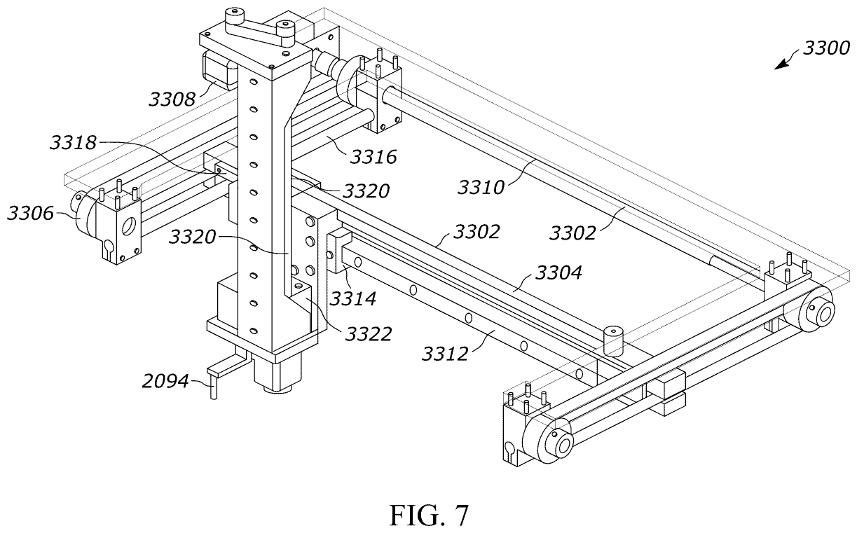

FIG. 7 is an isometric view of an implementation of an example pick-and-place assembly 3300 that can be used to implement the pick-and-place assembly 2019 of the system 2000 of FIG. 1. The pick-and-place assembly 2019 has a gantry 3302, corresponding actuators 3304, 3306, 3308, and the gripper 2094. The actuators 3304, 3306, 3308 move the gripper 2094 in operation. The actuators 3304, 3306, 3308 include an x-actuator 3304, a y-actuator 3306, and a z-actuator 3308. The x-actuator 3304 moves the gripper 2094 in the x-direction, the y-actuator 3306 moves the gripper 2094 in the y-direction, and the z-actuator 3308 moves the gripper 2094 in the z-direction. The actuators 3304, 3306, 3308 may include belts drives, stepper motors, encoders, guide shafts (e.g., circular guide shafts), linear guide rails, worm gears, and/or lead screws. The actuators 3304, 3306, 3308 may be implemented in different ways, however.

The gantry 3302 of the pick-and-place assembly 2019 is shown as a three-dimensional gantry 3310. The three-dimensional gantry 3310 includes a first rail 3312 and a first block 3314 for the x-direction, a second rail 3316 and a second block 3318 for the y-direction, and a third rail 3320 and a third block 3322 for the z-direction. The rails 3312, 3316, and/or 3320 may be referred to as guides and the blocks 3314, 3316, and/or 3322 may define an aperture that surrounds the guides. The rails 3312, 3316, and/or 3320 may alternatively be referred to as linear rails and/or the blocks 3314, 3316, and/or 3322 may be referred to as carriage assemblies.

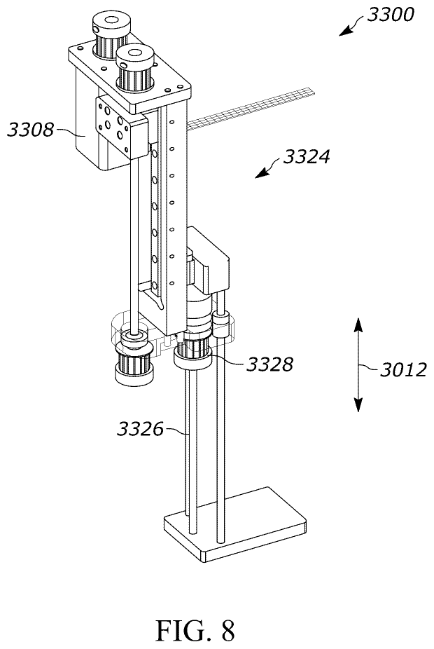

FIG. 8 is an isometric view of a portion of the pick-and-place assembly 3300 of FIG. 7. The z-actuator 3308 is shown as a nested linear actuator 3324 in the implementation shown. The nested linear actuator 3324 has a lead screw 3326 and a rotating nut 3328. The nut 3328 rotates to move the lead screw 3326 in a direction generally indicated by arrow 3012.

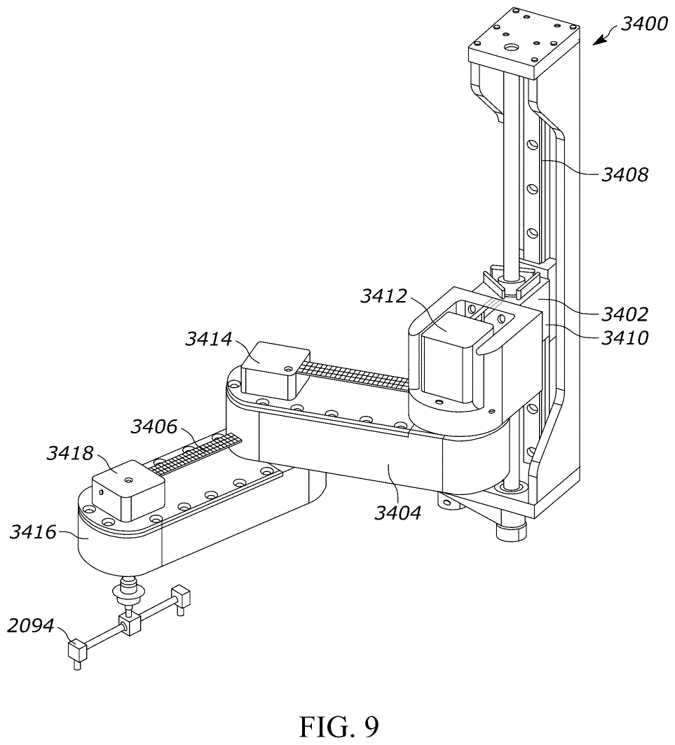

FIG. 9 is an isometric view of an implementation of an example pick-and-place assembly 3400 that can be used to implement the pick-and-place assembly 3400 of the system 2000 of FIG. 1. The pick-and-place assembly 3400 includes a vertical linear actuator 3402, a first arm 3404, and a second arm 3406 in the implementation shown. The first arm 3404 is coupled to and between the vertical linear actuator 3402 and the second arm 3406. The vertical linear actuator 3402 has a rail 3408 and a block 3410 and the first arm 3404 is pivotably coupled to the block 3410. The second arm 3406 is pivotably coupled to the first arm 3404. The pick-and-place assembly 3400 also includes a first actuator 3412 and a second actuator 3414. The actuators 3404, 3412 and/or 3414 may include harmonic drives, belts drives, planetary gears, cycloidal drives, stepper motors, encoders, guide shafts (e.g., circular guide shafts), linear guide rails, worm gears, and/or lead screws. The actuators 3404, 3412, 3414 may be implemented in different ways, however.

The first actuator 3412 rotates the first arm 3404 relative to the block 3410 of the vertical linear actuator 3402 and the second actuator 3414 rotates the second arm 3406 relative to the first arm 3404 in operation. The second arm 3406 has a distal end 3416 and the gripper 2094 is coupled at the distal end 3416 of the second arm 3406. A gripper actuator 3418 is shown being carried by the second arm 3406 that actuates the gripper 2094.

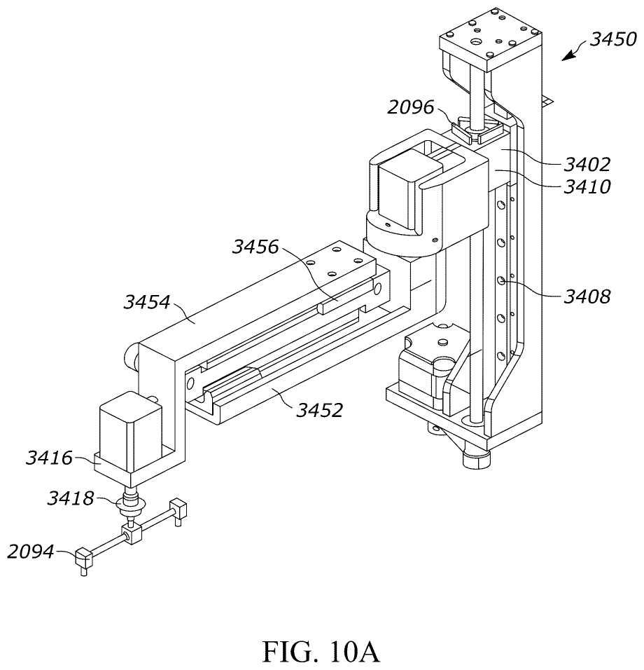

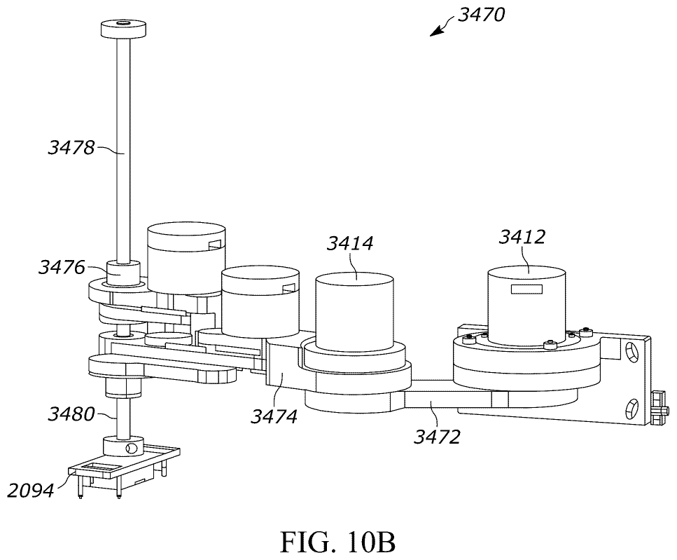

FIG. 10A is an isometric view of an implementation of an example pick-and-place assembly 3450 that can be used to implement the pick-and-place assembly 2019 of the system 2000 of FIG. 1. The pick-and-place assembly 3450 includes the vertical linear actuator 3402, a first arm 3452, and a second arm 3454 in the implementation shown. The first arm 3452 is coupled to and between the vertical linear actuator 3402 and the second arm 3454. The pick-and-place assembly 3450 also includes a horizontal linear actuator 3456. The vertical linear actuator 3402 is shown including the rail 3408 and the block 3410 and the first arm 3452 is pivotably coupled to the block 3410. The horizontal linear actuator 3456 couples the first arm 3452 and the second arm 3454. The second arm 3454 has the distal end 3416 and the gripper 2094 is coupled at the distal end 3416 of the second arm 3454. The gripper actuator 3418 is carried by the second arm 3454 to actuate the gripper 2094.

FIG. 10B is an isometric view of an implementation of an example pick-and-place assembly 3470 that can be used to implement the pick-and-place assembly 2019 of the system 2000 of FIG. 1. The pick-and-place assembly 3470 has a first arm 3472, a second arm 3474, and a vertical linear actuator 3476 in the implementation shown. The second arm 3474 is coupled to and between the vertical linear actuator 3476 and the first arm 3472. The pick-and-place assembly 3470 also includes a third arm 3478 and the vertical linear actuator 3476 linearly moves the third arm 3478. The third arm 3478 is coupled to the second arm 3474. The third arm 3478 comprises a distal end 3480 and the pick-and-place assembly 3470 has the gripper 2094 coupled at the distal end 3480 of the third arm 3478.

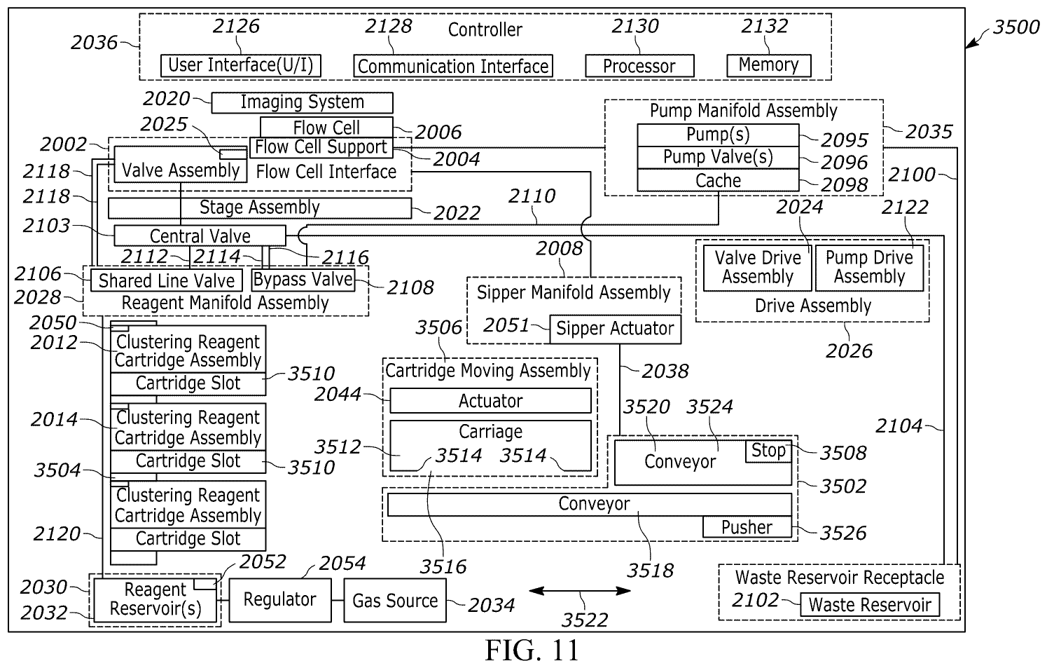

FIG. 11 is a schematic diagram of an implementation of another example system 3500 in accordance with the teachings of this disclosure. The system 3500 may provide dynamic queuing and/or processing of reagent cartridges and/or flow cells. The system 3500 can be used to perform an analysis on one or more samples of interest. The system 3500 is similar to the system 2000 of FIG. 1.

The system 3500 of FIG. 11 includes a cartridge conveyor assembly 3502, a vertical assembly 3504, and a cartridge moving assembly 3506. The cartridge conveyor assembly 3502 has a stop 3508 and the vertical assembly 3504 has a plurality of cartridge slots 3510 to carry reagent cartridges 2012, 2014. The cartridge moving assembly 3506 has a carriage actuator 2044 and a carriage 3512. The carriage actuator 2044 moves the carriage 3512 relative to the cartridge conveyor assembly 3502 and the vertical assembly 3504 in operation and the carriage 3512 moves one of the reagent cartridges 2012, 2014 from the vertical assembly 3504 to the cartridge conveyor assembly 3502.

The carriage 3512 may include a pair of inward extending lips 3514 that engage a portion of a corresponding reagent cartridge 2012, 2014 to enable the carriage 3512 to move the reagent cartridge 2012, 2014 from the vertical assembly 3504 to the cartridge conveyor assembly 3502. The carriage actuator 2044 may move the carriage 3512 into one of the cartridge slots 3510 and position the lips 3514 beneath the reagent cartridge 2012, 2014 to allow the carriage 3512 to move the reagent cartridge 2012, 2014 from the corresponding cartridge slot 3510. The vertical assembly 3504 may alternatively or additionally include a pusher for each of the cartridge slots 3510 that moves the reagent cartridges 2012, 2014 from the cartridge slot 3510 and into the cartridge moving assembly 3506.

The carriage 3512 may define an opening 3516 between the lips 3514 and the cartridge conveyor assembly 3502 includes a first conveyor 3518, a second conveyor 3520, and a stop 3508. The carriage actuator 2044 moves the carriage 3512 to enable the opening 3516 of the carriage 3512 to straddle the first conveyor 3518 in operation and allows the first conveyor 3518 to move the reagent cartridge 2012, 2014 out of the carriage 3512 and onto the first conveyor 3518 in a direction generally indicated by arrow 3522. The first conveyor 3518 can thus move the reagent cartridge 2012, 2014 from the carriage 3512. The cartridge conveyor assembly 3502 includes a pusher 3526 to move the reagent cartridge from the first conveyor 3518 to the second conveyor 3520. The reagent cartridge 2012, 2014 engages the stop 3508 and the sipper actuator 2049 moves the sipper relative to the second conveyor 3520 to draw the clustering reagent 2050 as an example.

The first conveyor 3518 may be positioned approximately perpendicular to the second conveyor 3520 and the second conveyor 3520 is shown having an end 3524 where the stop 3508 is positioned. As set forth herein, the phrase “approximately perpendicular” means between about +/−5 of perpendicular including perpendicular itself and/or accounts for manufacturing tolerances.

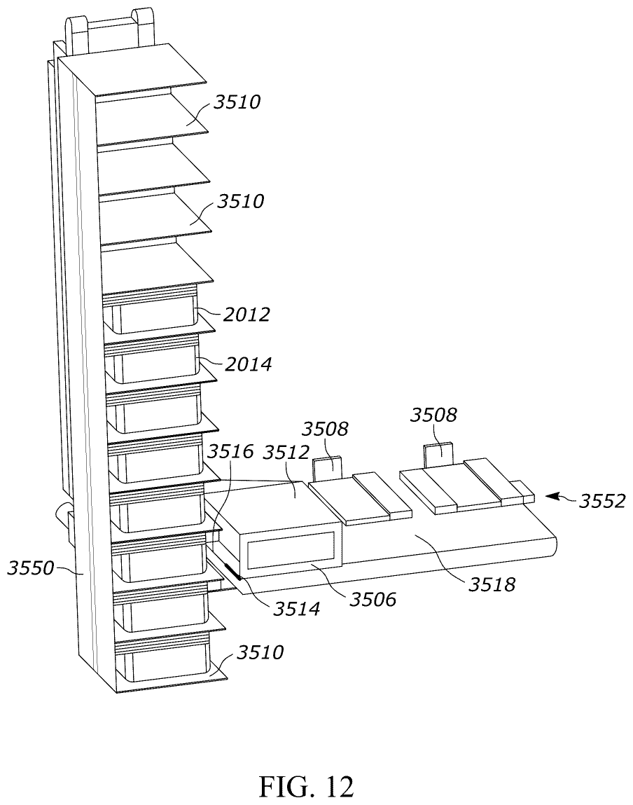

FIG. 12 is an isometric view of an implementation of an example vertical assembly 3550 and an example cartridge conveyor assembly 3552 that can be used to implement the system 3500 of FIG. 11.

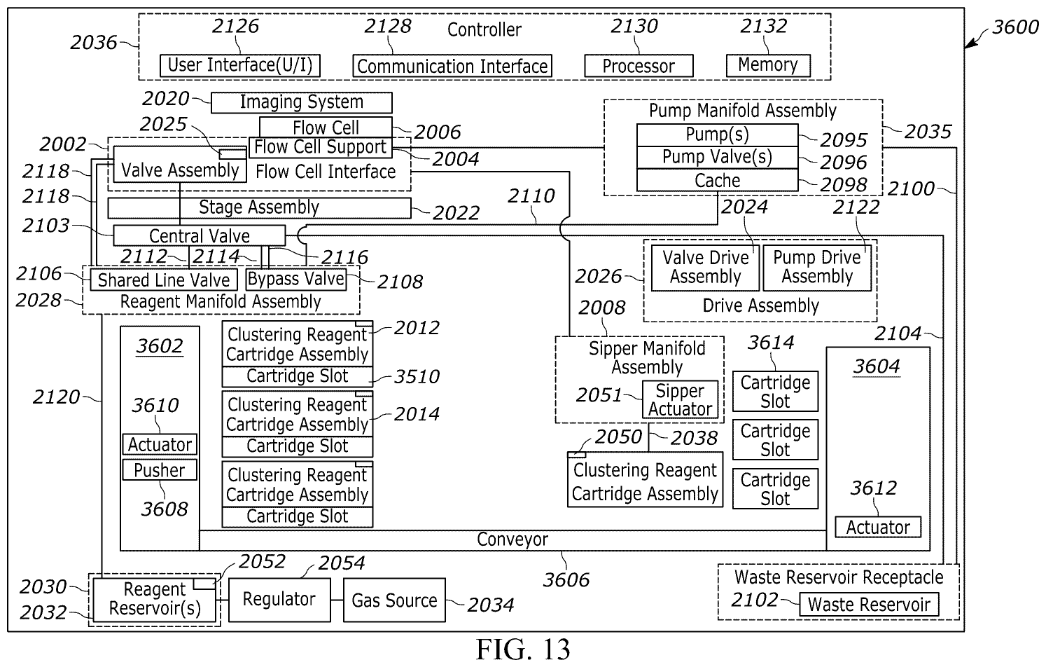

FIG. 13 is a schematic diagram of an implementation of another example system 3600 in accordance with the teachings of this disclosure. The system 3600 may provide dynamic queuing and/or processing of reagent cartridges and/or flow cells. The system 3600 can be used to perform an analysis on one or more samples of interest. The system 3600 is similar to the system 3500 of FIG. 11.

The system 3600 of FIG. 13 includes a first vertical assembly 3602, a second vertical assembly 3604, and a conveyor 3606. The first vertical assembly 3602 has a pusher 3608, a first actuator 3610, and a plurality of first cartridge slots 3510 to carry reagent cartridges 2012, 2014 and the second vertical assembly 3604 has a second actuator 3612 and a plurality of second cartridge slots 3614. The conveyor 3606 extends between the first vertical assembly 3602 and the second vertical assembly 3604.

The first actuator 3610 aligns one of the first cartridge slots 3510 with the conveyor 3606 and the second actuator 3612 aligns one of the second cartridge slots 3614 with the conveyor 3606 in operation. The pusher 3608 moves one of the reagent cartridges 2012, 2014 from the corresponding first cartridge slot 3510 onto the conveyor 3606. The conveyor 3606 may move the reagent cartridges 2012, 2014 into the second cartridge slots 3614. The sipper manifold assembly 2008 includes the sipper actuator 2049 that moves the sipper 2038 relative to the conveyor 3606 to allow the sipper 2038 to draw the clustering reagent 2050 from the reagent cartridge 2012, 2014 when the reagent cartridge 2012, 2014 is on the conveyor 3606.

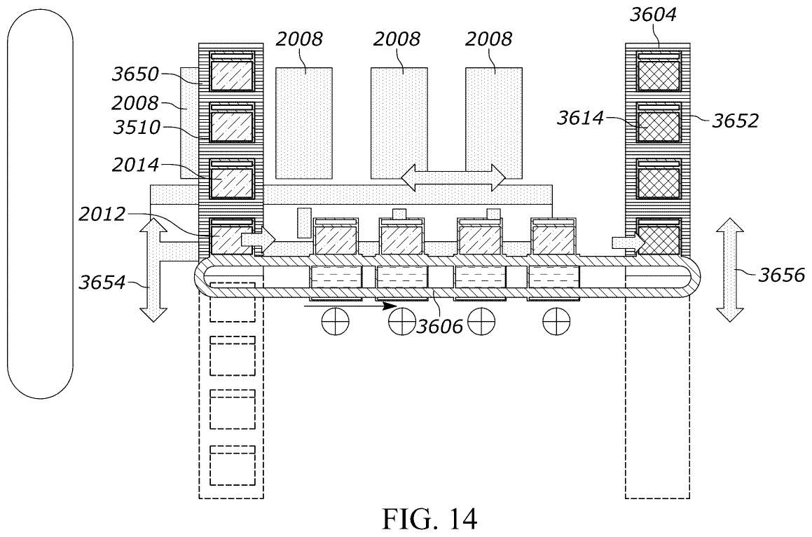

FIG. 14 is a schematic view of an example first vertical assembly 3650, a second vertical assembly 3652, and the conveyor 3606 that extends between the vertical assemblies 3550, 3652 that can be used to implement the system 3600 of FIG. 13. The vertical assemblies 3650, 3652 are movable in a direction generally indicated by arrows 3654, 3656 to align the cartridge slots 3510, 3614 with the conveyor 3606. Four sipper manifold assemblies 2008 are shown included. Another number of sipper manifold assemblies 2008 may be included, however.

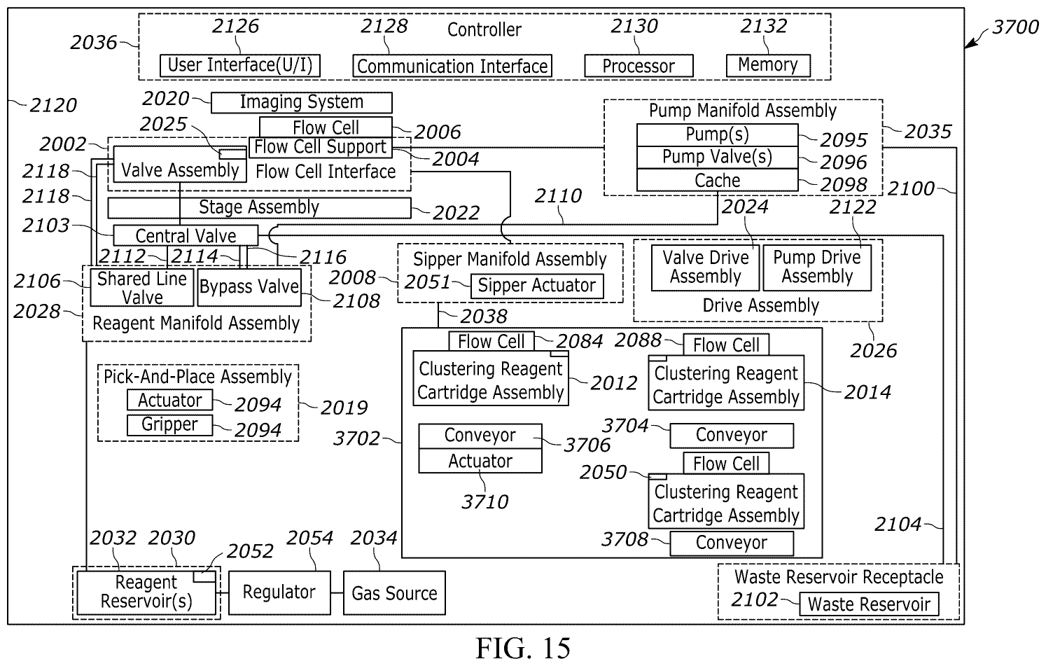

FIG. 15 is a schematic diagram of an implementation of another example system 3700 in accordance with the teachings of this disclosure. The system 3700 may provide static queuing and/or processing of reagent cartridges and/or flow cells. The system 3700 can be used to perform an analysis on one or more samples of interest. The system 3700 is similar to the system 2000 of FIG. 1.

The system 3700 of FIG. 15 includes a cartridge conveyor assembly 3702 to move reagent cartridges 2012, 2014 toward the sipper manifold assembly 2008. The sipper manifold assembly 2008 is positioned to access a reagent cartridge 2012, 2014 positioned on the cartridge conveyor assembly 3702 in the implementation shown. The cartridge conveyor assembly 3702 has a first conveyor 3704, a second conveyor 3706, a third conveyor 3708. The third conveyor 3708 is positioned beneath the first conveyor 3704. The cartridge conveyor assembly 3702 also includes a conveyor actuator 3710 that moves the second conveyor 3706 between a raised position and a lowered position. The first conveyor 3704 may move the reagent cartridge 2012, 2014 to the second conveyor 3706 in the raised position. The second conveyor 3706 may move the reagent cartridge 2012, 2014 to the third conveyor 3708 in the lowered position. The sipper manifold assembly 2008 is positioned to access the reagent cartridge positioned on the second conveyor 3706 in the raised position

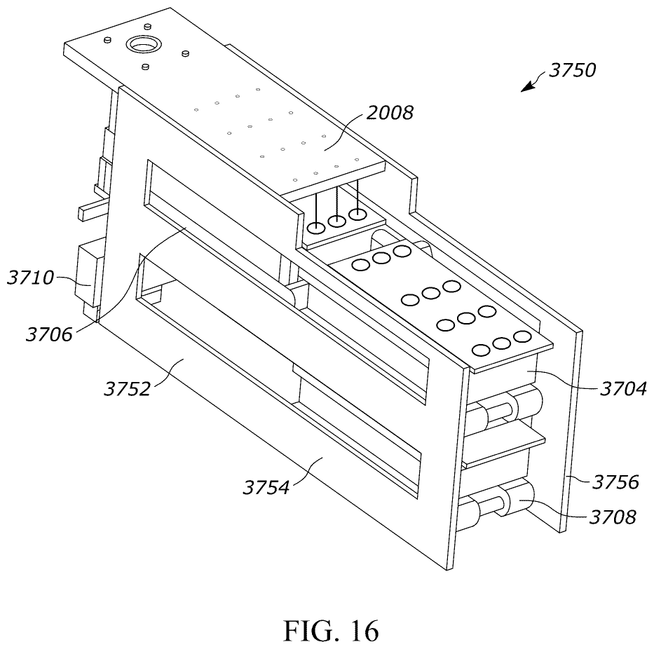

FIG. 16 is an isometric view of an implementation of an example cartridge conveyor assembly 3750 that can be used to implement the cartridge conveyor assembly 3702 of FIG. 15. The cartridge conveyer assembly 3750 includes the first conveyor 3704, the second conveyor 3706, and the third conveyor 3708 and a frame 3752 having sides 3754, 3756 between which the conveyors 3704, 3706, 3708 are positioned.

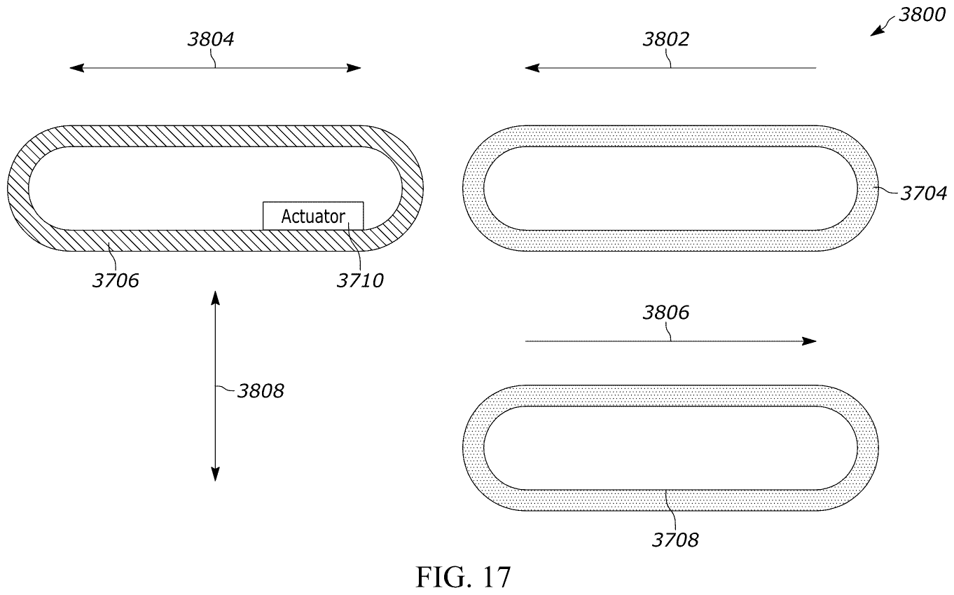

FIG. 17 is a schematic implementation of an example cartridge conveyor assembly 3800 that can be used to implement the cartridge conveyor assembly 3702 of FIG. 15. The arrows 3802, 3804, 3806 represent the direction that the conveyors 3704, 3706, 3708 rotate and the arrow 3808 represents the direction that the second conveyor 3706 moves between the raised position and the lowered position.

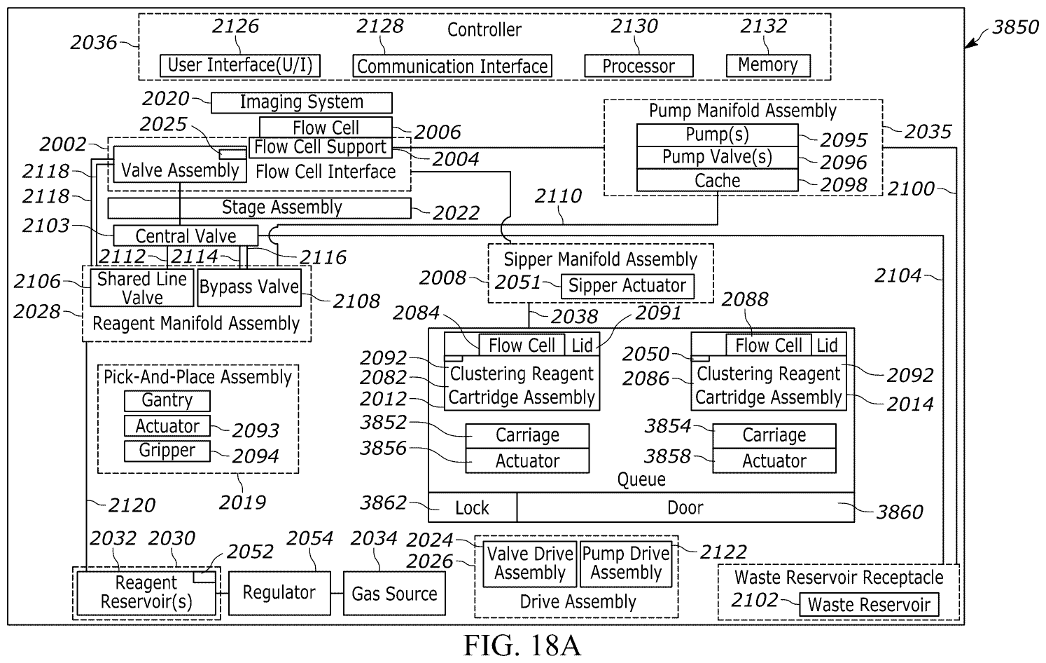

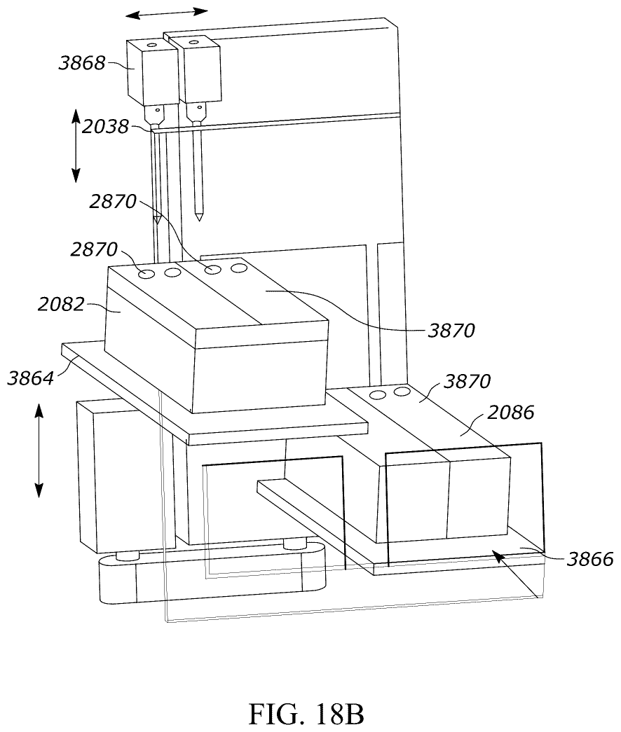

FIG. 18A is a schematic diagram of an implementation of another example system 3850 in accordance with the teachings of this disclosure. The system 3850 may provide dynamic queuing and/or processing of reagent cartridges and/or flow cells. The system 3850 can be used to perform an analysis on one or more samples of interest. The system 3850 is similar to the system 2000 of FIG. 1.

The system 3850 of FIG. 18 includes a sipper manifold assembly 2008, a first carriage 3852 that carries the first reagent cartridge 2012, and a second carriage 3854 that carries the second regent cartridge 2014. The sipper actuator 2049 moves the sipper 2038 relative to the first carriage 3852 and the second carriage 3854 in operation. The sipper actuator 2049 may enable three-dimensional movement of the sipper 2038. The sipper actuator 2049 moves the sipper 2038 vertically and/or horizontally for example.

The system 3850 also includes a first carriage actuator 3856 and a second carriage actuator 3858. The first carriage actuator 3856 moves the first carriage 3852 toward the sipper manifold assembly 2008 and the second carriage actuator 3858 moves the second carriage 3854 toward the sipper manifold assembly 2008 in operation. The first reagent cartridge assembly 2082 is shown including the lid 2091 that covers the flow cell 2006. The lid 2091 may move from covering the flow cell 2006 before the first carriage 3852 is moved toward the sipper manifold assembly 2008 in some examples.

A door 3860 is included in the implementation shown that enables access to the first carriage 3852 and the second carriage 3854. The door 3860 is movable between a closed position and an open position. The door 3860 may be omitted, however. The system 3850 may also include a lock 3862 that is actuatable between a locked position and an unlocked position. The lock 3862 enables movement of the door 3860 from the closed position to the open position in the unlocked position. The lock 3862 inhibits movement of the door 3860 from the closed position to the open position in the locked position.

FIG. 18B is an isometric view of an implementation of an example first carriage 3864, an example second carriage 3866, and an example sipper manifold assembly 3868 that can be used to implement the first carriage 3852, the second carriage 3854, and the sipper manifold assembly 2008 of the system 3850 of FIG. 18A.

The reagent cartridges 2864, 2866 may include wells 2870. The wells 2870 may have similar or the same depths. The wells 2870 may alternatively have different depths. The sipper manifold assembly 3868 may independently move the sippers 2038 in the z-direction/vertical direction to allow the sippers 2038 to be positioned at the bottom of the corresponding well 2870 and inhibit tips of the sippers 2038 from being damaged by being driven into the bottom surface of the well 2870. The sipper manifold assembly 3868 may position a first sipper 2038 in a first well 2870 and have a second sipper 2038 in a second well 2870 that is vertically offset from the first sipper 2038.

The reagent cartridge assemblies 2082, 2086 are shown including a two-part lid 3870 that may open outwardly. The two-part lid 3870 may cover the flow cell 2084 in some examples.

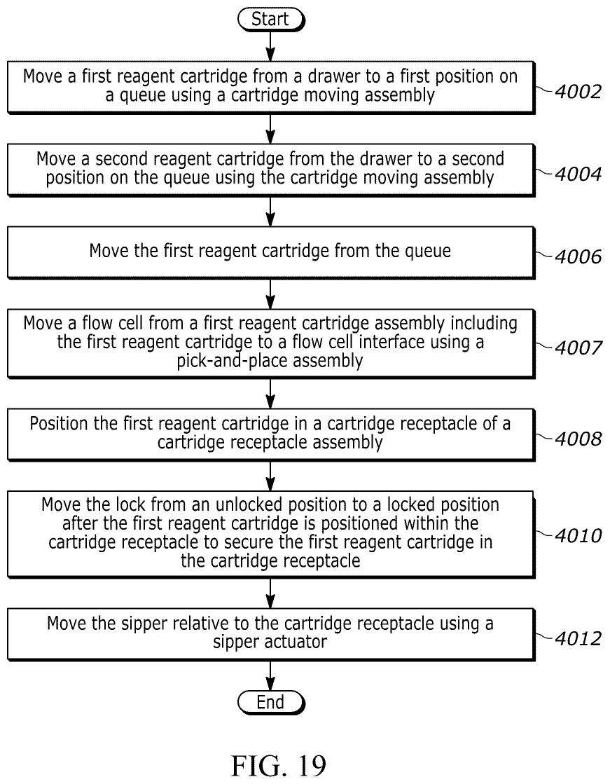

FIGS. 19-23 illustrate flowcharts for methods of implementing the examples disclosed herein. The order of execution of the blocks may be changed, and/or some of the blocks described may be changed, eliminated, combined and/or subdivided into multiple blocks.

The process of FIG. 19 begins by moving the first reagent cartridge 2012 from the drawer 2076 to the first position 2066 on the queue 2010 using the cartridge moving assembly 2016 (Block 4002). The cartridge moving assembly 2016 includes the gantry 2042, the carriage actuator 2044, and the carriage 2046. Moving the first reagent cartridge 2012 from the drawer 2076 may include positioning the carriage 2046 beneath the first reagent cartridge 2012 and moving the carriage 2046 through an access aperture 2078 of the drawer 2076 to lift the first reagent cartridge 2012 from the drawer 2076. The second reagent cartridge 2014 is moved from the drawer 2076 to the second position 2068 on the queue 2010 using the cartridge moving assembly (Block 4004).

The first reagent cartridge 2012 is moved from the queue 2010 (Block 4006). Moving the first reagent cartridge 2012 from the queue 2010 may include positioning the carriage 2046 beneath the first reagent cartridge 2012 and moving the carriage 2046 through a first access aperture 2070 of a shelf 2064 of the queue 2010 to lift the first reagent cartridge 2012 from the first position 2066.

The flow cell 2006 is moved from a first reagent cartridge assembly 2082 including the first reagent cartridge 2012 to the flow cell interface 2002 using the pick-and-place assembly 2019 (Block 4007).

The first reagent cartridge 2012 is positioned in a cartridge receptacle 2048 of a cartridge receptacle assembly 2018 (Block 4008). The cartridge receptacle 2048 is accessible by the sipper 2038 of the sipper manifold assembly 2008. Positioning the first reagent cartridge 2012 in the cartridge receptacle 2048 may include moving the lock 2058 of the cartridge receptacle assembly 2018 to an unlocked position to enable the first reagent cartridge 2012 to be positioned through the opening 2056 of the cartridge receptacle and within the cartridge receptacle 2048. The lock 2058 is moved from the unlocked position to the locked position after the first reagent cartridge 2012 is positioned within the cartridge receptacle 2048 to secure the first reagent cartridge 2012 in the cartridge receptacle 2048 (Block 4010). The sipper 2038 is moved relative to the cartridge receptacle 2048 using the sipper actuator 2049 (Block 4012).

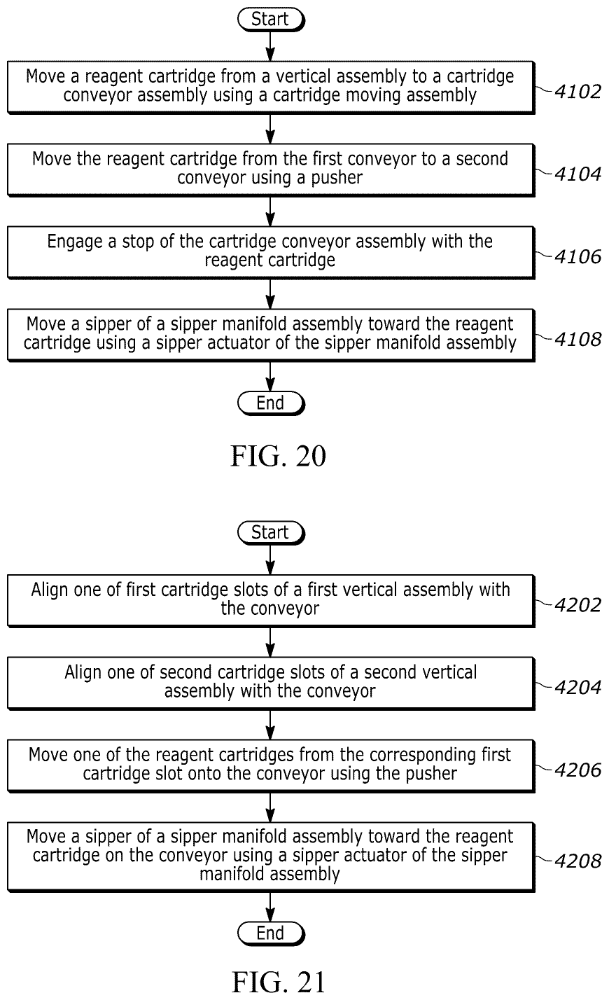

The process of FIG. 20 begins by moving the reagent cartridge 2012 and/or 2014 from the vertical assembly 3504 to the cartridge conveyor assembly 3502 using the cartridge moving assembly 3506 (Block 4102). The cartridge moving assembly 3506 includes the carriage actuator 2044 and the carriage 3512. The vertical assembly 3504 includes the cartridge slots 3510 to carry reagent cartridges 2012, 2014. Moving the reagent cartridge 2012 and/or 2014 from the vertical assembly 3504 to the cartridge conveyor assembly 3502 includes positioning the reagent cartridge 2012 and/or 2014 on a first conveyor 3518 of the cartridge conveyor assembly 3502. The first conveyor 3518 is positioned approximately perpendicular to the second conveyor 3520.

The reagent cartridge 2012 and/or 2014 is moved from the first conveyor 3518 to the second conveyor 3520 using the pusher 3526 (Block 4104). The second conveyor 3520 has the end 3524 and the stop 3508 is positioned at the end of the second conveyor 3520. The stop 3508 of the cartridge conveyor assembly 3502 is engaged with the reagent cartridge 2012 and/or 2014 (Block 4106). The sipper 2038 of the sipper manifold assembly 2008 is moved toward the reagent cartridge 2012 and/or 2014 using the sipper actuator 2049 of the sipper manifold assembly 2008 (Block 4108).

The process of FIG. 21 begins with aligning one of first cartridge slots 3510 of a first vertical assembly 3602 with the conveyor 3606 (Block 4202). The first vertical assembly 3602 includes the pusher 3526, the actuator 3610, and the first cartridge slots 3510 carrying reagent cartridges 2012, 2014. One of second cartridge slots 3614 of the second vertical assembly 3604 is aligned with the conveyor 3606 (Block 4204). One of the reagent cartridges 2012, 2014 is moved from the corresponding first cartridge slot 3510 onto the conveyor 3606 using the pusher 3526 (Block 4206). The sipper 2038 of the sipper manifold assembly 2008 is moved toward the reagent cartridge 2012 and/or 2014 on the conveyor 3606 using a sipper actuator 2049 of the sipper manifold assembly 2008 (Block 4208).

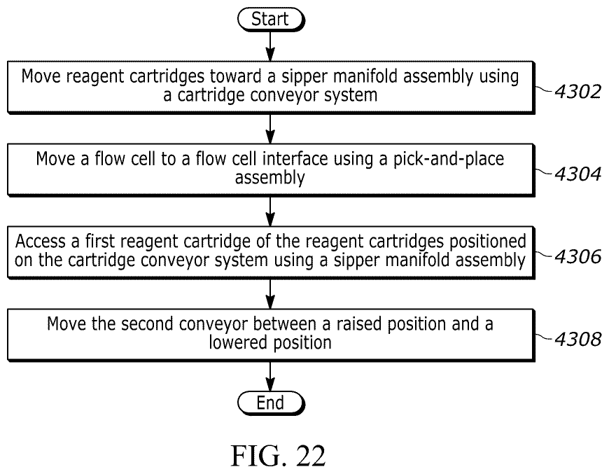

The process of FIG. 22 begins with moving reagent cartridges 2012, 2014 toward the sipper manifold assembly 2008 using the cartridge conveyor system (Block 4302). The flow cell 2006 is moved to the flow cell interface 2002 using the pick-and-place assembly 2019 (Block 4304). Moving the flow cell 2006 to the flow cell interface 2002 may include moving the flow cell 2006 from a reagent cartridge assembly 2082 including the reagent cartridge 2012 to the flow cell interface 2002. The first reagent cartridge 2012 of the reagent cartridges 2012, 2014 positioned on the cartridge conveyor system 3702 is accessed using a sipper manifold assembly 2008 (Block 4306). The cartridge conveyor assembly 3702 includes the first conveyor 3704, the second conveyor 3706, and the third conveyor 3708. The third conveyor 3708 is positioned beneath the first conveyor 3704. Accessing the first reagent cartridge 2012 may include accessing the first reagent cartridge 2012 on the second conveyor 3706 as an example.

The second conveyor 3706 is moved between a raised position and a lowered position (Block 4308). The first reagent cartridge 2012 moves onto the third conveyor 3708 when the second conveyor 3706 is in the lowered position in some examples.

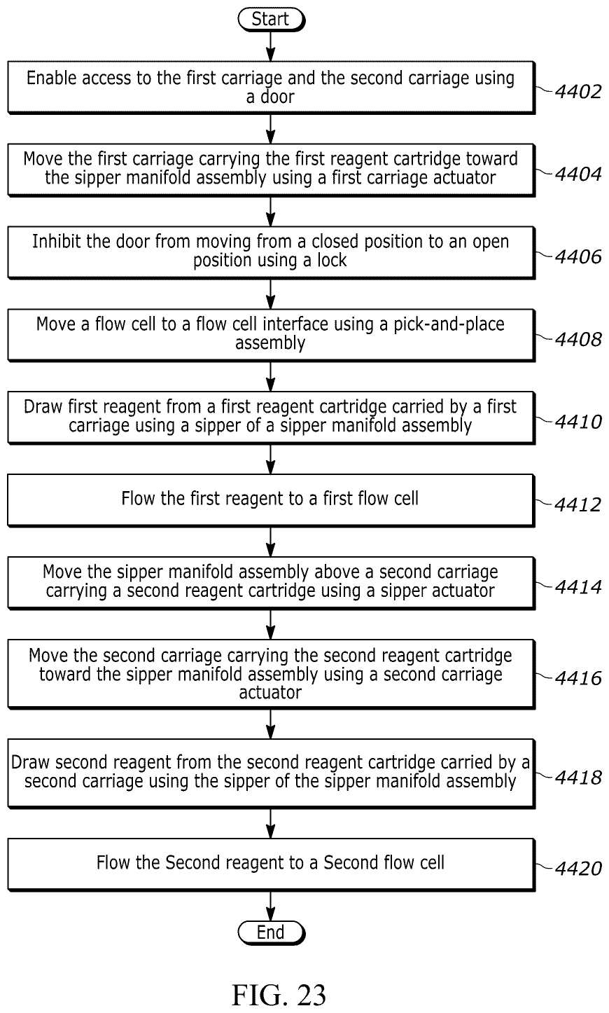

The process of FIG. 23 begins with enabling access to the first carriage 3852 and the second carriage 3854 using a door 3860 (Block 4402). The first carriage 3852 carrying the first reagent cartridge 2012 is moved toward the sipper manifold assembly 2008 using a first carriage actuator 3856 (Block 4404). The door 3860 is inhibited from moving from the closed position to the open position using a lock 3862 (Block 4406). The lock 3862 may inhibit the door 3860 from moving from the closed position to the open position when the first carriage 3852 is moved toward the sipper manifold assembly 2008. The flow cell 2006 may be moved to the flow cell interface 2002 using the pick-and-place assembly 2019 (Block 4408).

Reagent is drawn from the first reagent cartridge 2012 carried by the first carriage 3852 using the sipper 2038 of the sipper manifold assembly 2008 (Block 4410). The first reagent is flowed to the first flow cell 2006 (Block 4412).

The sipper manifold assembly 2008 is moved above the second carriage 3854 carrying the second reagent cartridge 2014 using the sipper actuator 2049 (Block 4414). The sipper actuator 2049 enables three-dimensional movement of the sipper 2038 in some examples. The second carriage 3854 carrying the second reagent cartridge 2014 is moved toward the sipper manifold assembly 2008 using a second carriage actuator 3858 (Block 4416).

Second reagent is drawn from the second reagent cartridge 2014 carried by the second carriage 3854 using the sipper 2038 of the sipper manifold assembly 2008 (Block 4418). The second reagent is flowed the second flow cell 2006 (Block 4420).

### I. OVERVIEW OF SYSTEM FOR BIOLOGICAL OR CHEMICAL ANALYSIS

Examples described herein may be used in various biological or chemical processes and systems for academic analysis, commercial analysis, or other analysis. More specifically, examples described herein may be used in various processes and systems where it is desired to detect an event, property, quality, or characteristic that is indicative of a designated reaction. Bioassay systems such as those described herein may be configured to perform a plurality of designated reactions that may be detected individually or collectively. For example, bioassay systems may be used to sequence a dense array of nucleic acid features through iterative cycles of enzymatic manipulation and image acquisition. In some examples, nucleic acids can be attached to a surface and amplified. Examples of such amplification are described in U.S. Pat. No. 7,741,463, entitled “Method of Preparing Libraries of Template Polynucleotides,” issued Jun. 22, 2010, the disclosure of which is incorporated by reference herein, in its entirety; and/or U.S. Pat. No. 7,270,981, entitled “Recombinase Polymerase Amplification,” issued Sep. 18, 2007, the disclosure of which is incorporated by reference herein, in its entirety.

Components that are used in the bioassay systems may include one or more microfluidic channels that deliver reagents or other reaction components to a reaction site. The reaction sites may be randomly distributed across a substantially planar surface; or may be patterned across a substantially planar surface. Each of the reaction sites may be imaged to detect light from the reaction site. The signals indicating photons emitted from the reaction sites and detected by image sensors may provide illumination values. These illumination values may be combined into an image indicating photons as detected from the reaction sites. These images may be further analyzed to identify compositions, reactions, conditions, etc., at each reaction site.

### II. EXAMPLES OF FLUIDICS DEVICES AND FLUID FLOW PATHS

A. Example of System with Higher Volume Throughput

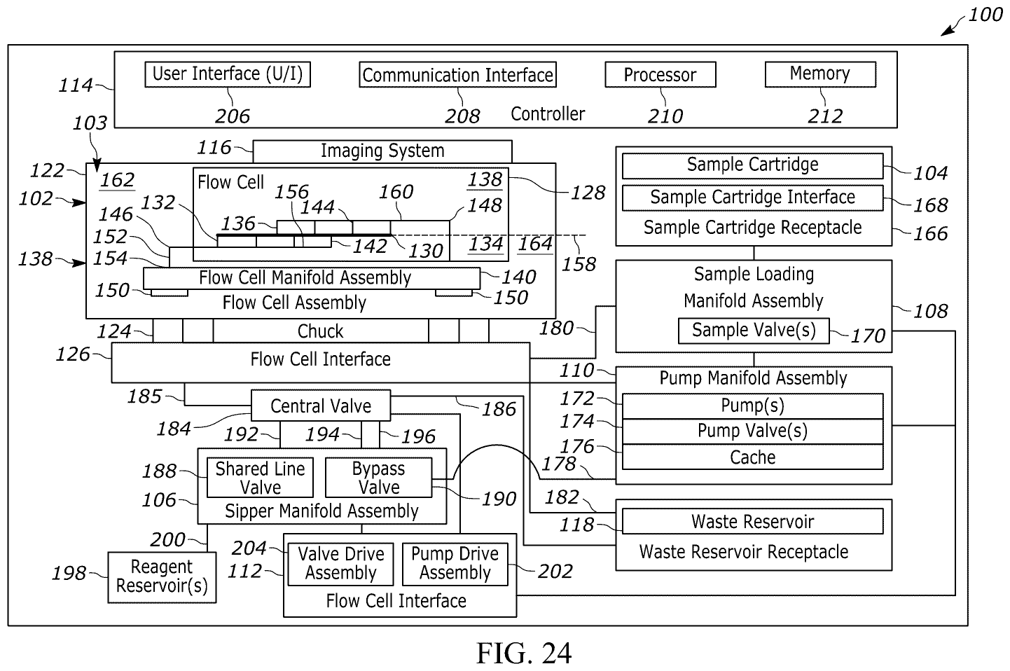

FIG. 24 illustrates a schematic diagram of an example of a system (100) that may be used to perform an analysis on one or more samples of interest. In some implementations, the sample may include one or more clusters of nucleotides (e.g., DNA) that have been linearized to form a single stranded DNA (sstDNA). In the implementation shown, system (100) is configured to receive a flow cell cartridge assembly (102) including a flow cell assembly (103) and a sample cartridge (104). System (100) includes a flow cell receptacle (122) that receives flow cell cartridge assembly (102), a vacuum chuck (124) that supports flow cell assembly (103), and a flow cell interface (126) that is used to establish a fluidic coupling between system (100) and flow cell assembly (103). Flow cell interface (126) may include one or more manifolds. System (100) further includes a sipper manifold assembly (106), a sample loading manifold assembly (108), and a pump manifold assembly (110). System (100) also includes a drive assembly (112), a controller (114), an imaging system (116), and a waste reservoir (118). Controller (114) is electrically and/or communicatively coupled to drive assembly (112) and to imaging system (116); and is configured to cause drive assembly (112) and/or the imaging system (116) to perform various functions as disclosed herein.

In the present example, flow cell assembly (103) includes a flow cell (128) having a channel (130) and defining a plurality of first openings (132), which are fluidically coupled to the channel (130) and arranged on a first side (134) of the channel (130). Flow cell (128) further includes a plurality of second openings (136) fluidically coupled to the channel (130) and arranged on a second side (138) of the channel (130). Fluid may thus flow through flow cell (128) via channel. While the flow cell (128) is shown including one channel (130), flow cell (128) may include two or more channels (130). Flow cell assembly (103) also includes a flow cell manifold assembly (140) coupled to flow cell (128) and having a first manifold fluidic line (142) and a second manifold fluidic line (144). Flow cell manifold assembly (140) may be in the form of a laminate including a plurality of layers as discussed in more detail below.

In the implementation shown, first manifold fluidic line (142) has a first fluidic line opening (146) and is fluidically coupled to each of the first openings (132) of flow cell (128); and second manifold fluidic line (144) has a second fluidic line opening (148) and is fluidically coupled to each of the second openings (136). As shown, flow cell assembly (103) includes gaskets (150) coupled to flow cell manifold assembly (140) and fluidically coupled to fluidic line openings (146, 148). In some implementations where flow cell (128) includes a plurality of channels (130), flow cell manifold assembly (140) may include additional fluidic lines (152) that couple first fluidic line openings (146) to a single manifold port (154). In such implementations, a single gasket (150) may be coupled to flow cell manifold assembly (140) that surrounds the manifold port (154) and is in fluidic communication with a plurality of channels (130). In operation, flow cell interface (126) engages with corresponding gaskets (150) to establish a fluidic coupling between system (100) and flow cell (128). The engagement between flow cell interface (126) and gaskets (150) reduces or eliminates fluid leakage between flow cell interface (126) and flow cell (128).

In the implementation shown, first manifold fluidic line (142) has a portion (156) that is substantially parallel to a longitudinal axis (158) of channel (130); and second manifold fluidic line (144) has a portion (160) that is substantially parallel to longitudinal axis (158) of channel (130). Additionally, first manifold fluidic line (142) is shown being at least partially adjacent a first end (162) of flow cell (128) and spaced from a second end (164) of flow cell (128); and second manifold fluidic line (144) is shown being at least partially adjacent second end (164) of flow cell (128) and spaced from first end (162). Other arrangements of manifold fluidic lines (142, 144) may prove suitable, however.

In the implementation shown, system (100) includes a sample cartridge receptacle (166) that receives sample cartridge (104) that carries one or more samples of interest (e.g., an analyte). System (100) also includes a sample cartridge interface (168) that establishes a fluidic connection with sample cartridge (104). Sample loading manifold assembly (108) includes one or more sample valves (170). Pump manifold assembly (110) includes one or more pumps (172), one or more pump valves (174), and a cache (176). Valves (170, 174) and pumps (172) may take any suitable form. Cache (176) may include a serpentine cache and may temporarily store one or more reaction components during, for example, bypass manipulations of the system (100). While cache (176) is shown being included in pump manifold assembly (110), cache (176) may alternatively be located elsewhere (e.g., in sipper manifold assembly (106) or in another manifold downstream of a bypass fluidic line (178), etc.).

Sample loading manifold assembly (108) and pump manifold assembly (110) flow one or more samples of interest from sample cartridge (104) through a fluidic line (180) toward flow cell cartridge assembly (102). In some implementations, sample loading manifold assembly (108) may individually load or address each channel (130) of flow cell (128) with a respective sample of interest. The process of loading channel (130) with a sample of interest may occur automatically using system (100). As shown in FIG. 24, sample cartridge (104) and sample loading manifold assembly (108) are positioned downstream of flow cell cartridge assembly (102). In the implementation shown, sample loading manifold assembly (108) is coupled between flow cell cartridge assembly (102) and pump manifold assembly (110). To draw a sample of interest from sample cartridge (104) and toward pump manifold assembly (110), sample valves (170), pump valves (174), and/or pumps (172) may be selectively actuated to urge the sample of interest toward pump manifold assembly (110). Sample cartridge (104) may include a plurality of sample reservoirs that are selectively fluidically accessible via the corresponding sample valves (170). To individually flow the sample of interest toward channel (130) of flow cell (128) and away from pump manifold assembly (110), sample valves (170), pump valves (174), and/or pumps (172) may be selectively actuated to urge the sample of interest toward flow cell cartridge assembly (102) and into respective channels (130) of flow cell (128).

Drive assembly (112) interfaces with sipper manifold assembly (106) and pump manifold assembly (110) to flow one or more reagents that interact with the sample within flow cell (128). In some scenarios, a reversible terminator is attached to the reagent to allow a single nucleotide to be incorporated onto a growing DNA strand. In some such implementations, one or more of the nucleotides has a unique fluorescent label that emits a color when excited. The color (or absence thereof) is used to detect the corresponding nucleotide. In the implementation shown, imaging system (116) excites one or more of the identifiable labels (e.g., a fluorescent label) and thereafter obtains image data for the identifiable labels. The labels may be excited by incident light and/or a laser and the image data may include one or more colors emitted by the respective labels in response to the excitation. The image data (e.g., detection data) may be analyzed by system (100). Examples of features and functionalities that may be incorporated into imaging system (116) will be described in greater detail below.

After the image data is obtained, drive assembly (112) interfaces with sipper manifold assembly (106) and pump manifold assembly (110) to flow another reaction component (e.g., a reagent) through flow cell (128) that is thereafter received by waste reservoir (118) via a primary waste fluidic line (182) and/or otherwise exhausted by system (100). Some reaction components may perform a flushing operation that chemically cleaves the fluorescent label and the reversible terminator from the sstDNA. The sstDNA may then be ready for another cycle.

The primary waste fluidic line (182) is coupled between pump manifold assembly (110) and waste reservoir (118). In some implementations, pumps (172) and/or pump valves (174) of pump manifold assembly (110) selectively flow the reaction components from flow cell cartridge assembly (102), through fluidic line (180) and sample loading manifold assembly (108) to primary waste fluidic line (182). Flow cell cartridge assembly (102) is coupled to a central valve (184) via flow cell interface (126). Central valve (184) is coupled with flow cell interface (126) via a fluidic line (185). An auxiliary waste fluidic line (186) is coupled to central valve (184) and to waste reservoir (118). In some implementations, auxiliary waste fluidic line (186) receives excess fluid of a sample of interest from flow cell cartridge assembly (102), via central valve (184), and flows the excess fluid of the sample of interest to waste reservoir (118) when back loading the sample of interest into flow cell (128), as described herein.

Sipper manifold assembly (106) includes a shared line valve (188) and a bypass valve (190). Shared line valve (188) may be referred to as a reagent selector valve. Central valve (184) and the valves (188, 190) of sipper manifold assembly (106) may be selectively actuated to control the flow of fluid through fluidic lines (192, 194, 196). Sipper manifold assembly (106) may be coupled to a corresponding number of reagent reservoirs (198) via reagent sippers (200). Reagent reservoirs (198) may contain fluid (e.g., reagent and/or another reaction component). In some implementations, sipper manifold assembly (106) includes a plurality of ports. Each port of sipper manifold assembly (106) may receive one of the reagent sippers (200). Reagent sippers (200) may be referred to as fluidic lines. Some forms of reagent sippers (200) may include an array of sipper tubes extending downwardly along the z-dimension from ports in the body of sipper manifold assembly (106). Reagent reservoirs (198) may be provided in a cartridge, and the tubes of reagent sippers (200) may be configured to be inserted into corresponding reagent reservoirs (198) in the reagent cartridge so that liquid reagent may be drawn from each reagent reservoir (198) into the sipper manifold assembly (106).

Shared line valve (188) of sipper manifold assembly (106) is coupled to central valve (184) via shared reagent fluidic line (196). Different reagents may flow through shared reagent fluidic line (196) at different times. In some versions, when performing a flushing operation before changing between one reagent and another, pump manifold assembly (110) may draw wash buffer through shared reagent fluidic line (196), central valve (184), and flow cell cartridge assembly (102).

Bypass valve (190) of sipper manifold assembly (106) is coupled to central valve (184) via dedicated reagent fluidic lines (194, 196). Each of the dedicated reagent fluidic lines (194, 196) may be associated with a single reagent. The fluids that may flow through dedicated reagent fluidic lines (194, 196) may be used during sequencing operations and may include a cleave reagent, an incorporation reagent, a scan reagent, a cleave wash, and/or a wash buffer.

Bypass valve (190) is also coupled to cache (176) of pump manifold assembly (110) via bypass fluidic line (178). One or more reagent priming operations, hydration operations, mixing operations, and/or transfer operations may be performed using bypass fluidic line (178). The priming operations, the hydration operations, the mixing operations, and/or the transfer operations may be performed independent of flow cell cartridge assembly (102). Thus, the operations using bypass fluidic line (178) may occur during, for example, incubation of one or more samples of interest within flow cell cartridge assembly (102). That is, shared line valve (188) may be utilized independently of bypass valve (190) such that bypass valve (190) may utilize bypass fluidic line (178) and/or cache (176) to perform one or more operations while shared line valve (188) and/or central valve (184) simultaneously, substantially simultaneously, or offset synchronously perform other operations.

Drive assembly (112) includes a pump drive assembly (202) and a valve drive assembly (204). Pump drive assembly (202) may be adapted to interface with one or more pumps (172) to pump fluid through flow cell (128) and/or to load one or more samples of interest into flow cell (128). Valve drive assembly (204) may be adapted to interface with one or more of the valves (170, 174, 184, 188, 190) to control the position of the corresponding valves (170, 174, 184, 188, 190).

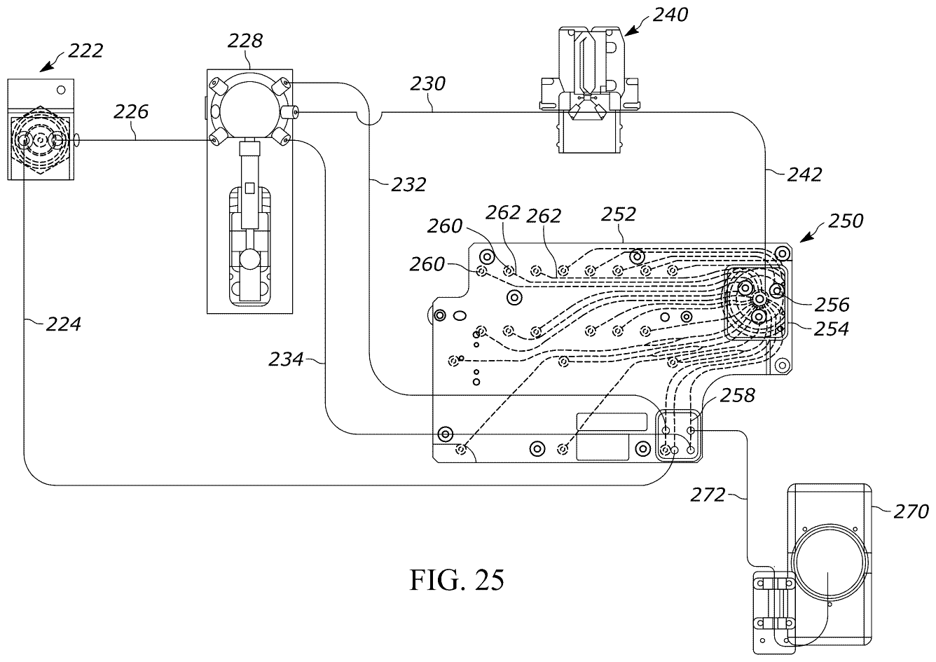

FIG. 25 shows an example of a fluidic arrangement (220) that may be incorporated into a variation of system (100). Fluidic arrangement (220) of this example includes a pump manifold assembly (222), which may operate similar to pump manifold assembly (110) described above; a sample loading manifold assembly (228), which may operate similar to sample loading manifold assembly (108) described above; a flow cell interface (240), which may operate similar to flow cell interface (126) described above; a sipper manifold assembly (250), which may operate similar to sipper manifold assembly (106) described above; and a waste reservoir (270), which may operate similar to waste reservoir (118) described above. Pump manifold assembly (222) is coupled with a port assembly (258) of sipper manifold assembly (250) via a fluidic line (224), which may be similar to fluidic line (178); and with sample loading manifold assembly (228) via a fluidic line (226). Sample loading manifold assembly (228) is coupled with flow cell interface (240) via fluidic line (230), which may be similar to fluidic line (180); and with port assembly (258) via fluidic lines (232, 234). Flow cell interface (240) is coupled with sipper manifold assembly (250) via fluidic line (242), which may be similar to fluidic line (185). Sipper manifold assembly (250) includes a manifold body (252) and a common output port (256), which provides fluid communication via fluidic line (185). A valve assembly (254) controls fluid flow through common output port (256) and may operate similar to central valve (184). Port assembly (258) of sipper manifold assembly (250) is coupled with waste reservoir (270) via fluidic line (272), which may be similar to fluidic line (186).

A plurality of reagent sippers (260) extend from manifold body (252) and are fluidically coupled with valve assembly (254) via respective fluid channels (262) in manifold body (252). Reagent sippers (260) may operate similar to reagent sippers (200). Valve assembly (254) is operable to selectively couple fluid channels (262) with flow cell interface (240) via common output port (256) and fluidic line (230), to thereby selectively provide various reagents to flow cell interface (240). In other words, when each reagent sipper (260) is disposed in a different respective reagent (e.g., in a respective reagent reservoir (198)), a flow cell (e.g., like flow cell (128)) that is coupled with flow cell interface (240) may selectively receive those different reagents based on control of valve assembly (254).

Port assembly (258) may provide a fluidic interface between pump manifold assembly (222) and sipper manifold assembly (250), thereby allowing sipper manifold assembly (250) to receive pressurized fluid from pump manifold assembly (222). Port assembly (258) may also provide a fluidic interface between sample loading manifold assembly (228) and sipper manifold assembly (250), thereby allowing sipper manifold assembly (250) to receive sample fluid from sample loading manifold assembly (228). In addition, port assembly (258) may provide a fluidic interface between waste reservoir (270) and sipper manifold assembly (250), thereby allowing sipper manifold assembly (250) to communicate waste fluid to waste reservoir (270). Communication of fluids via port assembly (258) may be regulated, at least in part, by valve assembly (254).

Referring back to FIG. 24, controller (114) of the present example includes a user interface (206), a communication interface (208), one or more processors (210), and a memory (212) storing instructions executable by the one or more processors (210) to perform various functions including the disclosed implementations. User interface (206), communication interface (133), and memory (212) are electrically and/or communicatively coupled to the one or more processors (210). User interface (206) may be adapted to receive input from a user and to provide information to the user associated with the operation of system (100) and/or an analysis taking place. User interface (206) may include a touch screen, a display, a keyboard, a speaker(s), a mouse, a track ball, and/or a voice recognition system.

Communication interface (208) is adapted to enable communication between system (100) and a remote system(s) (e.g., computers) via a network(s) (e.g., the Internet, an intranet, a local-area network (LAN), a wide-area network (WAN), a coaxial-cable network, a wireless network, a wired network, a satellite network, a digital subscriber line (DSL) network, a cellular network, a Bluetooth connection, a near field communication (NFC) connection, etc.). Some of the communications provided to the remote system may be associated with analysis results, imaging data, etc. generated or otherwise obtained by system (100). Some of the communications provided to system (100) may be associated with a fluidics analysis operation, patient records, and/or a protocol(s) to be executed by system (100).

The one or more processors (210) and/or system (100) may include one or more of a processor-based system(s) or a microprocessor-based system(s). In some implementations, the one or more processors (210) and/or system (100) includes one or more of a programmable processor, a programmable controller, a microprocessor, a microcontroller, a graphics processing unit (GPU), a digital signal processor (DSP), a reduced-instruction set computer (RISC), an application specific integrated circuit (ASIC), a field programmable gate array (FPGA), a field programmable logic device (FPLD), a logic circuit, and/or another logic-based device executing various functions including the ones described herein.

Memory (212) may include one or more of a semiconductor memory, a magnetically readable memory, an optical memory, a hard disk drive (HDD), an optical storage drive, a solid-state storage device, a solid-state drive (SSD), a flash memory, a read-only memory (ROM), erasable programmable read-only memory (EPROM), electrically erasable programmable read-only memory (EEPROM), a random-access memory (RAM), a non-volatile RAM (NVRAM) memory, a compact disc (CD), a compact disc read-only memory (CD-ROM), a digital versatile disk (DVD), a Blu-ray disk, a redundant array of independent disks (RAID) system, a cache and/or any other storage device or storage disk in which information is stored for any duration (e.g., permanently, temporarily, for extended periods of time, for buffering, for caching).

B. Example of System with Lower Volume Throughput

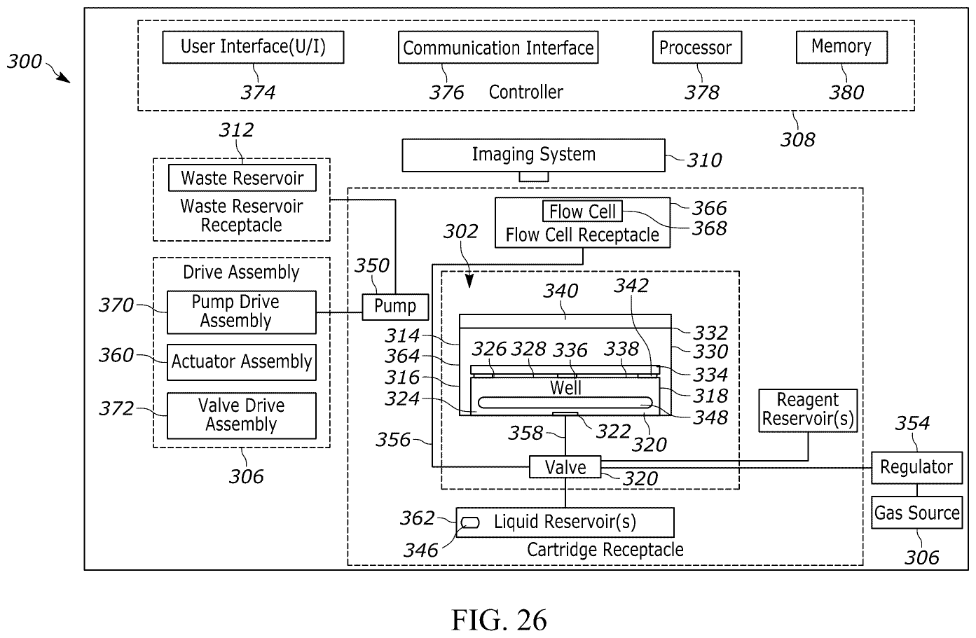

FIG. 26 illustrates a schematic diagram of another example of a system (300) that may be used to perform an analysis on one or more samples of interest. Except as otherwise described below, system (300) of this example may be configured and operable like system (100) described above with reference to FIG. 24. In some instances, system (100) is used to provide a higher volume throughput; while system (300) is used to provide a lower volume throughput. Alternatively, systems (100, 300) may provide any other suitable amount or degree of throughput. System (300) of the present example receives a reagent cartridge (302) and includes, in part, a gas source (304), a drive assembly (306), a controller (308), an imaging system (310), and a waste reservoir (312). Reagent cartridge (302) may be referred to as a consumable, a reagent reservoir, or a reagent assembly. Controller (308) is electrically and/or communicatively coupled to drive assembly (306) and to imaging system (310) and causes drive assembly (306) and/or imaging system (310) to perform various functions as disclosed herein.

Reagent cartridge (302) in the implementation shown includes a well assembly (314) having a body (316). Body (316) has a first wall (318) defining a well (320) having a port (322). First wall (318) has a distal end (324) that defines an opening (326) having an opening perimeter (328). A second wall (330) surrounds first wall (318) and has a distal end (332). Distal end (332) may be referred to as an edge or an outer edge. A cover (334) is coupled to distal end (324) of first wall (318) and covers opening (326) along opening perimeter (328) at a connected portion (336); and is uncoupled from distal end (324) of first wall (318) at an unconnected portion (338). Connection portion (336) may be referred to as connection sections or connected segments and unconnected portion (338) may be referred to as unconnected sections or unconnected segments. First wall (318) has a height and second wall (330) has a height that is greater than the height of first wall (318). First well (318) and second well (330) may alternatively be the same or similar heights. An impermeable barrier (340) is coupled to distal end (332) of second wall (330) and covers well (320). Impermeable barrier (340) may be foil, plastic, etc. and may prevent or inhibit moisture from infiltrating wells (320) of reagent cartridge (302).

Unconnected portion (338) of cover (334) forms a vent (342) that allows air flow out of well (320). Dried reagent (348) is contained within well (320), and vent (342) is sized to substantially retain dried reagent (348) within the well (320). Body (316) may include a plurality of wells (320) while one well (320) is shown in FIG. 26. Liquid (346) may flow into well (320) via port (322) in practice to rehydrate dried reagent (348). Vent (342) may vent gas from well (320) as liquid (346) flows into well (320); and cover (334) prevents or inhibits reagent (348) and/or liquid (346) from escaping from well (320). Put another way, vents (342) retain reagent (348) and/or liquid (346) within wells (320); and prevent or inhibit reagent (348) and/or liquid (346) from migrating out of wells (320). Vent (342) and cover (334) prevent or inhibit cross-contamination between reagents when reagent cartridge (302) includes more than one well (320). Liquid (346) and dried reagent (348) may be flowed into and out of well (320) to mix liquid (346) from liquid reservoir (362) and dried reagent (348). System (300) and/or reagent cartridge (302) may include a mixing chamber that is used to mix liquid (346) and dried reagent (348) in some implementations. Impermeable barrier (340) may be pierced prior to liquid (346) flowing into well (320).

Gas source (304) may be used to pressurize liquid reservoir (362) to flow liquid (346) into well (320); and/or a pump (350) may draw liquid (346) from liquid reservoir (362) and flow liquid (346) into well (320) to rehydrate reagent (348). Gas source (304) may be provided by system (300) and/or may be carried by reagent cartridge (302). Gas source (304) may alternatively be omitted. Pump (350) may be implemented by a syringe pump, a peristaltic pump, a diaphragm pump, etc. While pump (350) may be positioned downstream of flow cell (368) as shown, pump (350) may be positioned upstream of flow cell (368) or omitted entirely.

Reagent cartridge (302) and/or system (300) includes valves (352) that may be selectively actuatable to control the flow of fluid through fluidic lines (356). Such valves (352) may be implemented by a valve manifold, a rotary valve, a selector valve, a pinch valve, a flat valve, a solenoid valve, a check valve, a piezo valve, etc. A regulator (354) may be positioned between gas source (304) and valve (352); and regulate the pressure of the gas provided to valve (352). Regulator (354) may include a valve that controls the flow of the gas from gas source (304).

Body (316) of well assembly (314) has an edge (364); and impermeable barrier (340) may be hermetically connected to body (316) along edge (364). Impermeable barrier (340) may include foil, plastic, and/or any other suitable material(s). System (300) may pierce impermeable barrier (340), impermeable barrier (340) may be pierced by an individual prior to use, or impermeable barrier (340) may be pierced by some other structure or methodology. System (300) includes an actuator assembly (360) in the implementation shown that interfaces with impermeable barrier (340) to pierce impermeable barrier (340). System (300) may include a protrusion such as a post having a blunt or sharp end that is movable by actuator assembly (360) to pierce impermeable barrier (340). Impermeable barrier (340) may alternatively be pierced by an operator prior to reagent cartridge (302) being positioned in system (300). System (300) also includes a liquid reservoir (362) containing liquid (346). Liquid (346) may comprise a rehydrating liquid, a wash buffer, and/or any other suitable kind(s) of liquid.

System (300) further includes a flow cell receptacle (366) that receives a flow cell (368). Flow cell (368) may be configured and operable like flow cell (128). In some variations, flow cell (368) is carried by and/or integrated into reagent cartridge (302). Flow cell (368) may carry the sample of interest. Gas source (304) and/or pump (350) may flow liquid (346) to rehydrate dry reagents (348) and to flow one or more liquid reagents through reagent cartridge (302) that interact with the sample. Imaging system (310) may be configured and operable like imaging system (116), such that imaging system (310) may be used to obtain image data from flow cell (368). After the image data is obtained, drive assembly (306) may interface with reagent cartridge (302) to flow another reaction component (e.g., a reagent) through flow cell (368) that is thereafter received by the waste reservoir (312) and/or otherwise exhausted by reagent cartridge (302). In the present example, drive assembly (306) includes a pump drive assembly (370), a valve drive assembly (372), and actuator assembly (360). Pump drive assembly (370) interfaces with pump (350) to pump fluid through reagent cartridge (302) and/or flow cell (368); and valve drive assembly (372) interfaces with valve (352) to control the position of valve (352).

Controller (308) of this example includes a user interface (374), a communication interface (376), a processor (378), and a memory (380). User interface (374) may be configured and operable like user interface (206) of system (100). Communication interface (376) may be configured and operable like communication interface (208) of system (100). Processor (378) may be configured and operable like processor (210) of system (100). Memory (380) may be configured and operable like memory (212) of system (100).

Further examples and details of how various features of each system (100, 300) may be configured and operable will be described below. By way of further example only, the various features of system (100, 300) may be configured and operable in accordance with at least some of the teachings of U.S. Pat. App. No. 63/250,961, entitled “Flow Cells and Related Flow Cell Manifold Assemblies and Methods,” filed Sep. 30, 2021, the disclosure of which is incorporated by reference herein, in its entirety; U.S. Pat. No. 9,958,465, entitled “Detection Apparatus having a Microfluorometer, a Fluidic System, and a Flow Cell Latch Clamp Module,” issued May 1, 2018, the disclosure of which is incorporated by reference herein, in its entirety; and/or U.S. Pat. App. No. 63/325,462, entitled “Well Assemblies and Related Systems and Methods,” filed Mar. 30, 2022, the disclosure of which is incorporated by reference herein, in its entirety.

### III. EXAMPLES OF FLOW CELL STRUCTURES

As noted above, a system (100, 300) may execute reactions in a flow cell (128, 368) and/or perform analysis on one or more samples of interest in a flow cell (128, 368). The following describes examples of forms that such flow cells (128, 368) may take, it being understood that flow cells (128, 368) may take various other forms and have various other features in addition to or in lieu of the features described below.

### A. Example of Single-Surface Patterned Flow Cell

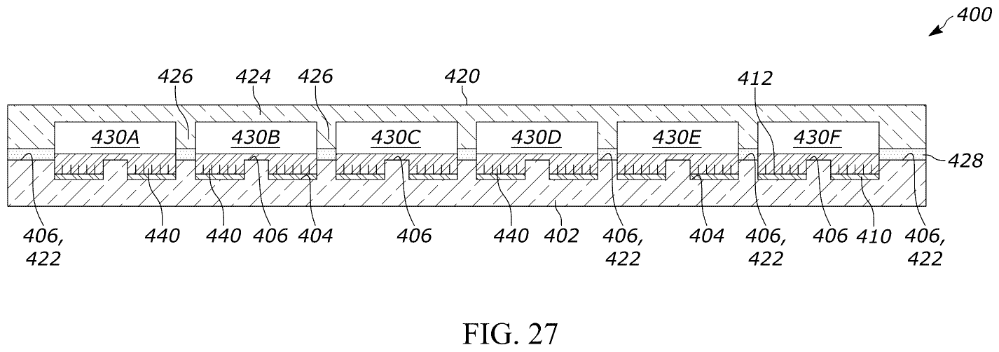

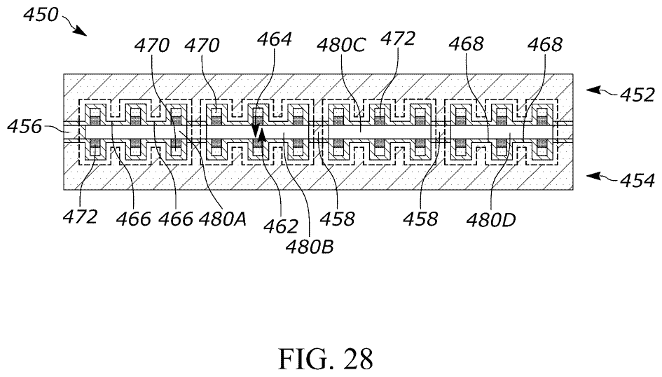

FIG. 27 shows an example of a flow cell (400) that includes a patterned substrate (402), which includes depressions (404) separated by interstitial regions (406), and surface chemistry (410, 412) positioned in the depressions (404). Depressions (404) may be in the form of microwells or nanowells. Depressions (404) may be configured to contain nucleic acid strands or other oligonucleotides and thereby provide a reaction site for SBS and/or for other kinds of processes. In some versions, each depression (404) has a cylindraceous configuration, with a generally circular cross-sectional profile. In some other versions, each depression (404) has a polygonal (e.g., hexagonal, octagonal, square, rectangular, elliptical, etc.) cross-sectional profile. Alternatively, depressions (404) may have any other suitable configuration. It should also be understood that depressions (404) may be arranged in any suitable pattern, including but not limited to a grid pattern.

Surface chemistry (410, 412) of the present example includes functionalized coating layer (410) and primers (412). While not shown, it is to be understood that the depressions (404) may also have surface preparation or treatment chemistry (e.g., silane or a silane derivative) positioned between the substrate (402) and the functionalized coating layer (410). This same surface preparation or treatment chemistry may also be positioned on the interstitial regions (406). In the present example, a hydrogel (440) is applied before lid (420) is bonded to substrate (402). Hydrogel (440) covers surface chemistry (410, 412) in depressions (404), and at least a portion of the patterned substrate (402) (e.g., those interstitial regions (406) that are not also bonding regions (422)). By way of example only, hydrogel (440) may comprise PAZAM, crosslinked polyacrylamide, agarose gel, etc.

Flow cell (400) of this example further includes a lid (420) bonded to bonding region(s) (422) of patterned substrate (402). In the example shown in FIG. 27, lid (420) includes a top portion (424) that is connected to several sidewalls (426), and these components (424, 426) define a portion of each of the six flow channels (430A, 430B, 430C, 430D, 430E, 430F). The respective sidewalls (426) isolate one flow channel (430A, 430B, 430C, 430D, 430E, 430F) from each adjacent flow channel (430A, 430B, 430C, 430D, 430E, 430F). Each flow channel (430A, 430B, 430C, 430D, 430E, 430F) is in selective fluid communication with a respective set of depressions (404).

Lid (420) may be bonded to bonding region (422) of substrate (402) using any suitable technique, such as laser bonding, diffusion bonding, anodic bonding, eutectic bonding, plasma activation bonding, glass frit bonding, or other methods known in the art. In some versions, a spacer layer (428) may be used to bond lid (420) to bonding region (422). Spacer layer (428) may comprise any material that will seal at least some of interstitial regions (404) (e.g., bonding region (422)) of substrate (402) and lid (420) together. While not shown, lid (420) or the patterned substrate (402) may include inlet and outlet ports that are to fluidically engage other ports (not shown), such as those of sample cartridge interface (168), for directing fluid(s) into the respective flow channels (430A, 430B, 430C, 430D, 430E, 430F) (e.g., from a reagent cartridge or other fluid storage system) and out of the flow channel (e.g., to waste reservoir (118) or another waste removal system). Flow channels (430A, 430B, 430C, 430D, 430E, 430F) may serve to, for example, selectively introduce reaction components or reactants to hydrogel (440) and the underlying surface chemistry (410, 412) in order initiate designated reactions in/at depressions (404).

While flow cell (400) includes a pattern of depressions (404) to provide an array of reaction sites, other variations may provide reaction sites on or at various other kinds of structural features, including but not limited to continuously planer surfaces and/or protruding surfaces, etc. By way of further example only, flow cell (400) may be constructed and operable in accordance with at least some of the teachings of U.S. Pat. No. 10,919,033, entitled “Flow Cells with Hydrogel Coating,” issued Feb. 16, 2021, the disclosure of which is incorporated by reference herein, in its entirety.

### B. Example of Dual-Surface Patterned Flow Cell

While FIG. 27 shows an example of a flow cell (400) that has a single surface patterned with reaction sites (i.e., depressions (404) formed in substrate (402)), it may be desirable in some instances to provide a variation of flow cell (400) that provide two surfaces patterned with reaction sites. An example of a dual-surface patterned flow cell (450) is shown in FIGS. 5-6. In this example, flow cell (450) includes a pair of wafers (452, 454) that are bonded together, with a spacer layer (456) interposed between wafers (452, 454). Each wafer (452, 454) is patterned to provide a respective plurality of depressions (462, 464), such that depressions (462) of wafer (452) align with depressions (464) of wafer (454) when flow cell (450) is assembled. Depressions (462) are separated from each other by interstitial regions (466); and depressions (464) are separated from each other by interstitial regions (468). Spacer layer (456) does not contact interstitial regions (466, 468) in this example.

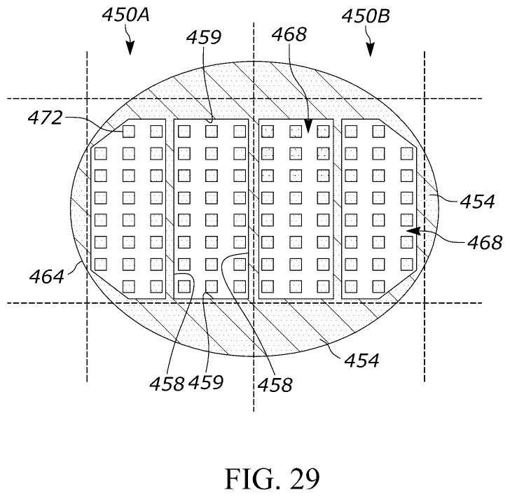

Depressions (462, 464) of flow cell (450) may be configured and operable like depressions (404) of flow cell (400) described above. Each depression (462, 464) of the present example includes a grafted coating (470), which may be similar to functionalized coating layer (410); and primers (472), which may be similar to primers (412) described above. Each depression (462, 464) may further include hydrogel, like hydrogel (440), and/or any other suitable feature(s). As shown in FIGS. 5-6, depressions (462, 464) are provided within a plurality of flow channels (480A, 480B, 480C, 480D). Flow channels (480A, 480B, 480C, 480D) are separated from each other by walls (458) and ends (459) formed by spacer layer (456). In the example shown in FIG. 29, flow cell (450) provides four flow channels (480A, 480B, 480C, 480D), with each flow channel (480A, 480B, 480C, 480D) containing several rows and columns of depressions (462, 464). When flow cell (450) is used in system (100, 300), flow channels (480A, 480B, 480C, 480D) may serve to, for example, selectively introduce reaction components or reactants surface chemistry (470, 472) in order initiate designated reactions in/at depressions (462, 464). In some instances, since each wafer (452, 454) has its own set of depressions (462, 464) providing corresponding reaction sites, flow cell (450) may provide twice as many reactions as a similarly sized flow cell (400) during a given time period.

The broken lines in FIG. 29 indicate how flow cell (450) may be diced to effectively form smaller flow cells (450A, 450A), with each smaller flow cell (450A, 450A) having its own respective pair of flow channels (480A, 480B, 480C, 480D). In the present example, however, a single flow cell (450) has more than two flow channels (480A, 480B, 480C, 480D). While flow cell (450) includes a pattern of depressions (462, 464) to provide an array of reaction sites, other variations may provide reaction sites on or at various other kinds of structural features, including but not limited to continuously planer surfaces and/or protruding surfaces, etc. By way of further example only, flow cell (450) may be constructed and operable in accordance with at least some of the teachings of U.S. Pat. No. 10,955,332, entitled “Flow Cell Package and Method for Making the Same,” issued Mar. 23, 2021, the disclosure of which is incorporated by reference herein, in its entirety.

### IV. EXAMPLES OF IMAGING SYSTEM FEATURES

As noted above, system (100, 300) includes an imaging system (116, 310) that excites one or more identifiable labels (e.g., a fluorescent label) in samples in reaction sites provided by depressions (404, 462, 464) of a flow cell (128, 368, 400, 450); and thereafter obtains image data for the identifiable labels. This image data is used to identify nucleotides as part of a nucleic acid sequencing process. Alternatively, the image data may be used for various other purposes. The following description provides details on how some versions of imaging system (116, 310) may be configured and operable.

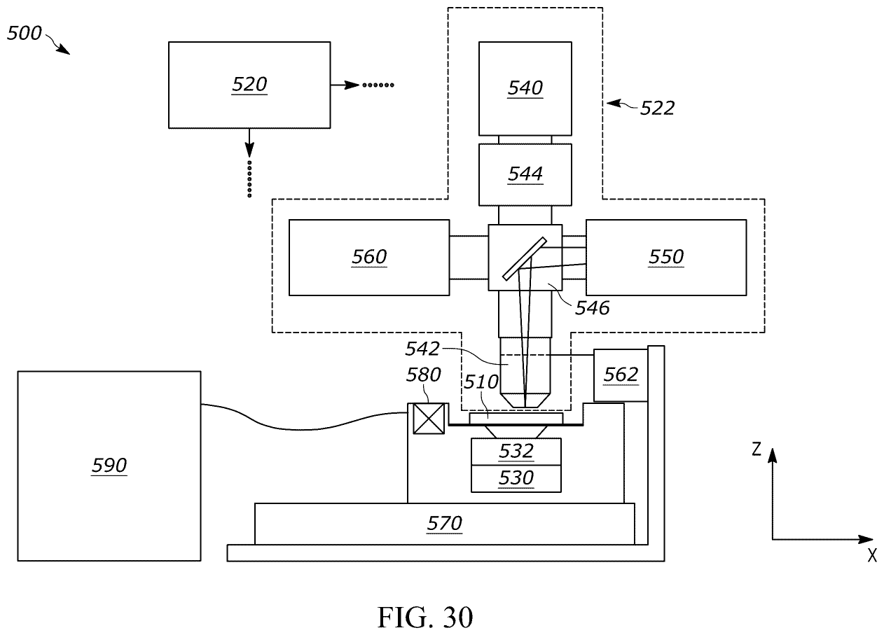

FIG. 30 illustrates a schematic diagram of another example of a system (500) that may be used to perform an analysis on one or more samples of interest. Except as otherwise described below, system (500) of this example may be configured and operable like systems (100, 300) described above. System (500) is configured to perform a large number of parallel reactions within a flow cell (510). Flow cell (510) may be configured and operable like flow cells (400, 450) described above or may have any other suitable configuration. Flow cell (510) may thus include one or more flow channels that receive a solution from system (500) and direct the solution toward reaction sites of flow cell (510).

System (500) includes a system controller (520) that may communicate with the various components, assemblies, and sub-systems of the system (500). Controller (520) may be configured and operable like controllers (114, 308) described above. An imaging assembly (522) of system (500) includes a light emitting assembly (550) that emits light that reaches reaction sites on flow cell (510). Light emitting assembly (550) may include an incoherent light emitter (e.g., emit light beams output by one or more excitation diodes), or a coherent light emitter such as emitter of light output by one or more lasers or laser diodes. In some implementations, light emitting assembly (550) may include a plurality of different light sources (not shown), each light source emitting light of a different wavelength range. Some versions of light emitting assembly (550) may also include one or more collimating lenses (not shown), a light structuring optical assembly (not shown), a projection lens (not shown) that is operable to adjust a structured beam shape and path, epifluorescence microscopy components, and/or other components. Although system (500) is illustrated as having a single light emitting assembly (550), multiple light emitting assemblies (550) may be included in some other implementations.

In the present example, the light from light emitting assembly (550) is directed by dichroic mirror assembly (546) through an objective lens assembly (542) onto a sample of a flow cell (510), which is positioned on a motion stage (570). In the case of fluorescent microscopy of a sample, a fluorescent element associated with the sample of interest fluoresces in response to the excitation light, and the resultant light is collected by objective lens assembly (542) and is directed to an image sensor of camera system (540) to detect the emitted fluorescence. In some implementations, a tube lens assembly may be positioned between the objective lens assembly (542) and the dichroic mirror assembly (546) or between the dichroic mirror (546) and the image sensor of the camera system (540). A moveable lens element may be translatable along a longitudinal axis of the tube lens assembly to account for focusing on an upper interior surface or lower interior surface of the flow cell (510) and/or spherical aberration introduced by movement of the objective lens assembly (542).

In the present example, a filter switching assembly (544) is interposed between dichroic mirror assembly (546) and camera system (540). Filter switching assembly (544) includes one or more emission filters that may be used to pass through particular ranges of emission wavelengths and block (or reflect) other ranges of emission wavelengths. For example, emission filters may be used to direct different wavelength ranges of emitted light to different image sensors of the camera system (540) of imaging assembly (522). For instance, the emission filters may be implemented as dichroic mirrors that direct emission light of different wavelengths from flow cell (510) to different image sensors of camera system (540). In some variations, a projection lens is interposed between filter switching assembly (544) and camera system (540). Filter switching assembly (544) may be omitted in some versions.

System (500) further includes a fluid delivery assembly (590) that may direct the flow of reagents (e.g., fluorescently labeled nucleotides, buffers, enzymes, cleavage reagents, etc.) to (and through) flow cell (510) and waste valve (580). Fluid delivery assembly (590) may be configured and operable like the various fluid delivery components described above in the context of FIGS. 1-3. System (500) of the present example also includes a temperature station actuator (530) and heater/cooler (532) that may optionally regulate the temperature of conditions of the fluids within the flow cell (510). In some implementations, the heater/cooler (532) may be fixed to sample stage (570), upon which the flow cell (510) is placed, and/or may be integrated into sample stage (570).

Flow cell (510) may be removably mounted on sample stage (570), which may provide movement and alignment of flow cell (510) relative to objective lens assembly (542). Sample stage (570) may have one or more actuators to allow sample stage (570) to move in any of three dimensions. For example, actuators may be provided to allow sample stage (570) to move in the x, y, and z directions relative to objective lens assembly (542), tilt relative to objective lens assembly (542), and/or otherwise move relative to objective lens assembly (542). Movement of sample stage (570) may allow one or more sample locations on flow cell (510) to be positioned in optical alignment with objective lens assembly (542). Movement of sample stage (570) relative to objective lens assembly (542) may be achieved by moving sample stage (570) itself, by moving objective lens assembly (542), by moving some other component of imaging assembly (522), by moving some other component of system (500), or any combination of the foregoing. For instance, in some implementations, the sample stage (570) may be actuatable in the x and y directions relative to the objective lens assembly (542) while a focus component (562) or z-stage may move the objective lens assembly (542) along the z direction relative to the sample stage (570).

In some implementations, a focus component (562) may be included to control positioning of one or more elements of objective lens assembly (542) relative to the flow cell (510) in the focus direction (e.g., along the z-axis or z-dimension). Focus component (562) may include one or more actuators physically coupled to the objective lens assembly (542), the optical stage, the sample stage (570), or a combination thereof, to move flow cell (510) on sample stage (570) relative to the objective lens assembly (542) to provide proper focusing for the imaging operation. In the present example, the focus component (562) utilizes a focus tracking module (560) that is configured to detect a displacement of the objective lens assembly (542) relative to a portion of the flow cell (510) and output data indicative of an in-focus position to the focus component (562) or a component thereof or operable to control the focus component (562), such as controller (520), to move the objective lens assembly (542) to position the corresponding portion of the flow cell (510) in focus of the objective lens assembly (542).

In some implementations, an actuator of focus component (562) or for sample stage (570) may be physically coupled to objective lens assembly (542), the optical stage, sample stage (570), or a combination thereof, such as, for example, by mechanical, magnetic, fluidic, or other attachment or contact directly or indirectly to or with the stage or a component thereof. The actuator of focus component (562) may be configured to move objective lens assembly (542) in the z-direction while maintaining sample stage (570) in the same plane (e.g., maintaining a level or horizontal attitude, perpendicular to the optical axis). In some implementations, sample stage (570) includes an x direction actuator and a y direction actuator to form an x-y stage. Sample stage (570) may also be configured to include one or more tip or tilt actuators to tip or tilt sample stage (570) and/or a portion thereof, to account for any slope in its surfaces.

Camera system (540) may include one or more image sensors to monitor and track the imaging (e.g., sequencing) of flow cell (510). Camera system (540) may be implemented, for example, as a CCD or CMOS image sensor camera, but other image sensor technologies (e.g., active pixel sensor) may be used. By way of further example only, camera system (540) may include a dual-sensor time delay integration (TDI) camera, a single-sensor camera, a camera with one or more two-dimensional image sensors, and/or other kinds of camera technologies. While camera system (540) and associated optical components are shown as being positioned above flow cell (510) in FIG. 30, one or more image sensors or other camera components may be incorporated into system (500) in numerous other ways as will be apparent to those skilled in the art in view of the teachings herein. For instance, one or more image sensors may be positioned under flow cell (510), such as within the sample stage (570) or below the sample stage (570); or may even be integrated into flow cell (510).

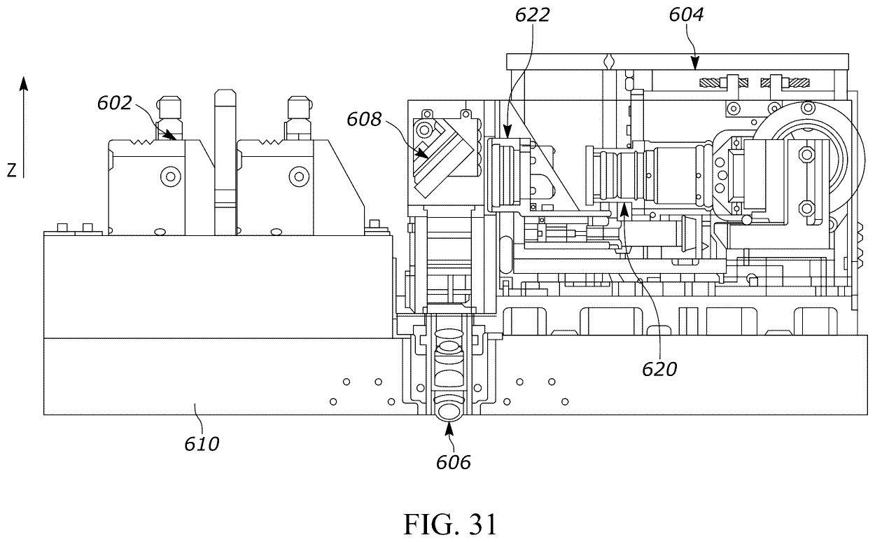

FIG. 31 shows an example of various components that may be integrated into imaging assembly (522) of system (500). In particular, the arrangement shown in FIG. 31 may represent a variation of light emitting assembly (550). The arrangement shown in FIG. 31 may be particularly useful in scenarios where camera system (540) includes a TDI camera. In the arrangement shown in FIG. 31, a line generation module (LGM) (602) and emission optics module (EOM) (604) are aligned and mechanically coupled to precision mounting plate (610), as well as to each other. EOM (604) includes an objective (606) that is aligned, via a mirror (608) with a tube lens (622), which in turn is optically coupled to LGM (602). LGM (602) may include one or more light sources (e.g., coherent light sources such as laser diodes). In some examples, LGM (602) may include a first light source configured to emit light in red wavelengths, and a second light source configured to emit light in green wavelengths. LGM (602) may further include optical components, such as focusing surfaces, lenses, reflective surfaces, or mirrors. The optical components may be positioned within an enclosure of LGM (602) to direct and focus the light emitted from the one or more light sources into an adjacent modular subassembly. One or more of the optical components of LGM (602) may also be configured to shape the light emitted from the one or more light sources into desired patterns. For example, in some implementations, the optical components may shape the light into line patterns (e.g., by using one or more Powell lenses, or other beam shaping lenses, diffractive or scattering components). In some variations, LGM (602) may include one or more laser modules which may be individually removed from LGM (602) and replaced.

Light beams generated by LGM (602) transmit through an interface baffle between LGM (602) and EOM (604), pass through objective (606), and strike an optical target (e.g., flow cell (510)). In some versions, the interface baffle includes an aperture shaped to enable light to pass through its center, while obscuring interference from external light sources. Responsive light radiation from the target may pass back through objective (606) and into tube lens (622). A lens element (622), which may form part of tube lens (620), is configured to articulate along an axis (e.g., a z-axis) to correct for spherical aberration artifacts introduced by objective (606) imaging through varied thickness of flow cell (510) components. As illustrated, lens element (622) may be articulated closer to or further away from objective (606) to adjust the beam shape and path. Objective (606) may emit excitation light toward the optical target (e.g., flow cell (510)) and receive fluorescence emission from the optical target. An actuator may be configured to position objective (606) to a region of interest proximate to the optical target. The processor of controller (520) may then execute program instructions for detecting fluorescence emission from the optical target.

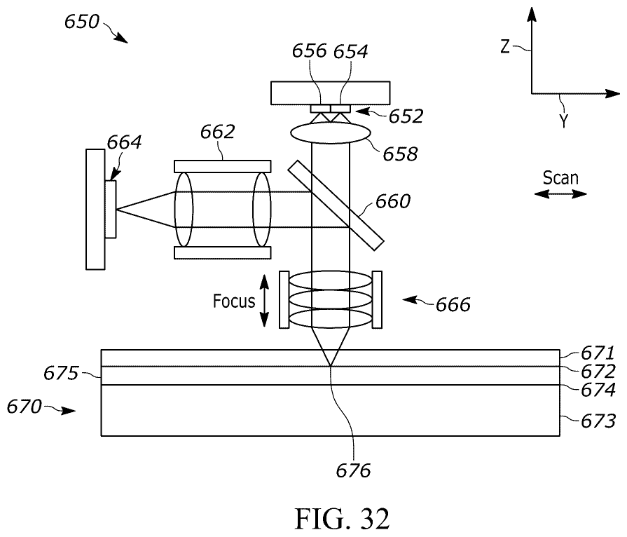

FIG. 32 shows an example of another configuration that may be provided in imaging assembly (522). In particular, FIG. 32 shows an imaging assembly (650) positioned in relation to a flow cell (670). Flow cell (670) may be representative of any of the variations of flow cells (128, 368, 400, 450, 510) described herein. Flow cell (670) has an upper layer (671) and a lower layer (673) that are separated by a fluid filled channel (675). In the configuration shown, upper layer (671) is optically transparent and imaging assembly (650) is focused to an area (676) on inner surface (672) of upper layer (671). In other variations, imaging assembly (650) may be focused on inner surface (674) of lower layer (673). One or both of surfaces (672, 674) may include array features that are to be detected by imaging assembly (650).

Imaging assembly (650) includes an objective (666) that is configured to direct excitation radiation from a radiation source (652) to flow cell (670); and to direct emission from flow cell (670) to a detector (664). In the arrangement shown, excitation radiation from radiation source (652) passes through a lens (658), though a beam splitter (660), and through objective (666) on to reach flow cell (670). In the present example, radiation source (652) includes two light emitting diodes (LEDs) (656, 654), which produce radiation at different wavelengths from each other. The emission radiation from flow cell (670) is captured by objective (666) and is reflected by beam splitter (660) through conditioning optics (662) and to detector (664) (e.g., a CMOS sensor). Beam splitter (660) functions to direct the emission radiation in a direction that is orthogonal to the path of the excitation radiation. The position of objective (666) may be moved in the z dimension to alter focus of imaging assembly (650). The imaging assembly (650) may be moved back and forth in the y direction to capture images of several areas of at least one inner surface (672, 674) of flow cell (670).

In the present example, a single imaging assembly (650) includes two LEDs (656, 654) that emit light at two different respective wavelengths, with a single detector (664) detecting light emitted from fluorophore labels in flow cell (670) in response to irradiation at these two different wavelengths. In some other versions, there are two or more imaging assemblies (650), with each imaging assembly (650) including a single LED (656, 654) and a single detector (664), such that each imaging assembly (650) provides irradiation at only one single respective wavelength. As another variation, two or more detectors (664) may receive excitation radiation from a common radiation source (652).

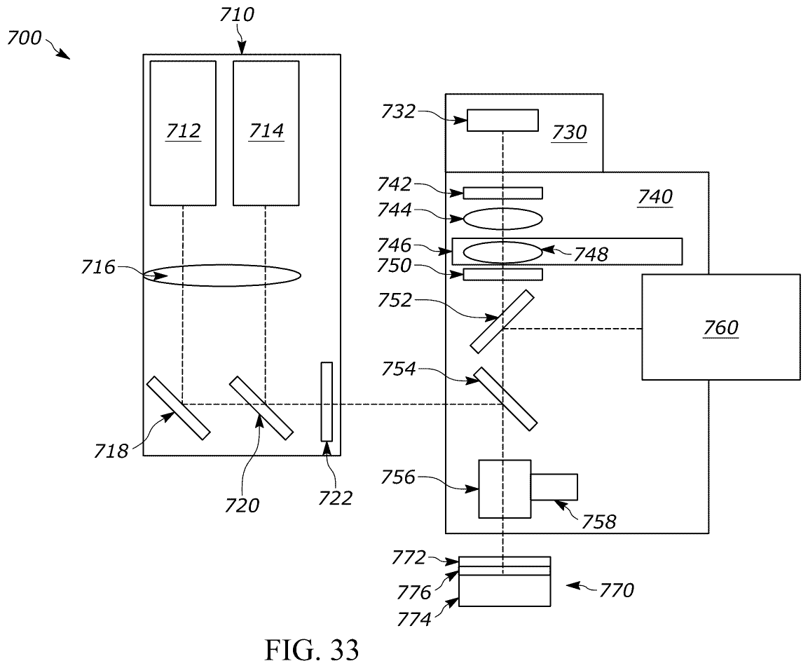

FIG. 33 shows an example of another configuration that may be provided in imaging assembly (522). In particular, FIG. 33 shows an imaging assembly (700) positioned in relation to a flow cell (774). Flow cell (774) may be representative of any of the variations of flow cells (128, 368, 400, 450, 510) described herein. Flow cell (770) has a translucent cover plate (772), a substrate (774), and a liquid layer (776) that is interposed between cover plate (772) and substrate (774). A biological sample may be located on an inside surface of cover plate (772) (above liquid layer (776)) and/or on an inside surface of substrate (774) (below liquid layer (776)).

Imaging assembly (700) of this example includes an LGM (710) with two light sources (712, 714), disposed therein. Light sources (712, 714) may include laser diodes, diode pumped solid state lasers, or other light sources as known in the art, which output laser beams at different wavelengths (e.g., red or green light). The light beams output from light sources (712, 714) are directed through a beam shaping lens or lenses (716). In some implementations, one or more light shaping lenses may be used to shape the light beams output from each or both light sources. LGM (710) may use one or more Powell lenses to spread and/or shape the laser beams from single or near-single mode laser light sources. Other beam shaping optics may be used to control uniformity and increase tolerance such as an active beam expander, an attenuator, one relay lenses, cylindrical lenses, actuated mirrors, diffractive elements, and scattering components. Laser beams may intersect at the back focal point of the objective lens to provide better tolerance on surfaces of flow cell (770).

LGM (710) of this example further includes mirrors (718, 720). A light beam generated by light source (712) reflects off mirror (718), as to be directed through an aperture or semi-reflective surface of mirror (720), and into EOM (740) through a single interface port. Similarly, a light beam generated by light source (714) reflects off of mirror (720) as to be directed into EOM (740) through a single interface port. In some examples, an additional set of articulating mirrors may be incorporated adjacent to mirrors (718, 720) to provide additional tuning surfaces. Both light beams may be combined using dichroic mirror (720). Mirrors (718, 720) may each be configured to articulate using manual or automated controls to align the light beams from light sources (712, 714). The light beams also pass through a shutter element (722) in the present example.

EOM (740) includes an objective (756) and a z-stage (758), which moves objective (756) longitudinally closer to or further away from flow cell (770). LGM (710) is configured to generate a uniform line illumination through objective (756). Z-stage (758) may then move objective (756) as to focus the light beams onto either of the inside surfaces of flow cell (770) (e.g., focused on a biological sample). In some implementations, the objective (756) may be configured to focus the light beams at a focal point beyond flow cell (770), such as to increase the line width of the light beams at the surfaces of flow cell (770).

EOM (740) of the present example also include a semi-reflective mirror (754) to direct light through objective (756), while allowing light returned from flow cell (774) to pass through. EOM (740) further includes a tube lens (744) and a corrective lens (748). Corrective lens (748) may be articulated longitudinally by a z-stage (746), either closer to or further away from objective (756), to ensure accurate imaging (e.g., to correct spherical aberration caused by moving objective (756); and/or from imaging through a thicker substrate, etc.). Light transmitted through corrective lens (748) and tube lens (744) passes through filter element (742) and into camera system (730). Camera system (730) includes one or more optical sensors (732) to detect light emitted from the biological sample in response to the incident light beams.

In the present example, EOM (740) further includes semi-reflective mirror (752) to reflect a focus tracking light beam emitted from a focus tracking module (FTM) (760) onto flow cell (774), and then to reflect light returned from flow cell (774) back into FTM (760). FTM (760) may include a focus tracking optical sensor to detect characteristics of the returned focus tracking light beam and generate a feedback signal to optimize focus of objective (756) on flow cell (774).

The direction, size, and/or polarization of the laser beams may be adjusted by using lenses, mirrors, and/or polarizers. Optical lenses (e.g., cylindrical, spherical, or aspheric) may be used to actively adjust the illumination focus on dual surfaces of the flow cell (770) target. LGM (710) may also include multiple units, with each unit being designed for particular/different wavelengths and polarization. Stacking multiple units may be used to increase the laser power and wavelength options. Two or more laser wavelengths may be combined with dichroics and polarizers.

By way of example only, focus tracking module (560) and/or other components of imaging assembly (522) may be constructed and operable in accordance with at least some of the teachings of U.S. Pat. No. 10,416,428, entitled “Systems and Methods for Improved Focus Tracking Using a Light Source Configuration,” issued Sep. 17, 2019, the disclosure of which is incorporated by reference herein, in its entirety; U.S. Pat. App. No. 63/300,531, entitled “Dynamic Detilt Focus Tracking,” filed Jan. 18, 2022, the disclosure of which is incorporated by reference herein, in its entirety; and/or U.S. Pat. App. No. 63/410,961, entitled “Spot Error Handling for Focus Tracking,” filed Sep. 28, 2022, the disclosure of which is incorporated by reference herein, in its entirety. By way of further example only, components of imaging assembly (522) may be configured and operable in accordance with at least some of the teachings of U.S. Pat. No. 10,774,371, entitled “Laser Line Illuminator for High Throughput Sequencing,” issued Sep. 15, 2020, the disclosure of which is incorporated by reference herein, in its entirety; and/U.S. Pat. No. 9,958,465, entitled “Detection Apparatus having a Microfluorometer, a Fluidic System, and a Flow Cell Latch Clamp Module,” issued May 1, 2018, the disclosure of which is incorporated by reference herein, in its entirety.

### V. EXAMPLES OF DATA PROCESSING FEATURES

### A. Example of Networked Data Processing Arrangement

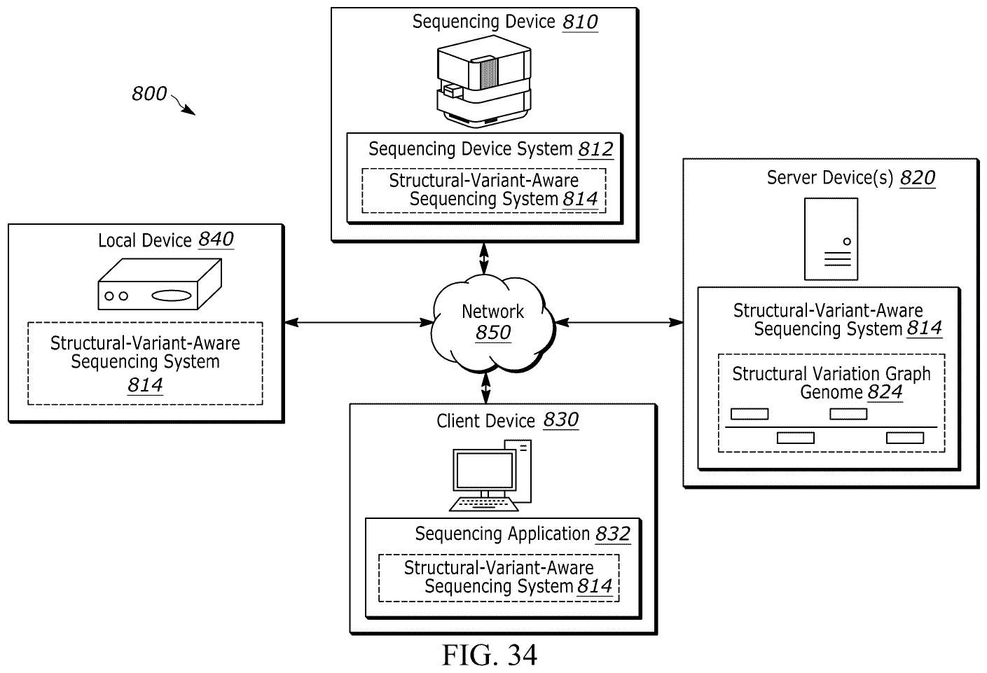

As noted above, a system (100, 300, 500) may include a controller (114, 308, 520) that is configured to process data, execute algorithms, etc., as needed to perform a sequencing operation or other kind of operation. In some scenarios, system (100, 300, 500) may be coupled with other devices via a network to perform further data processing, data storage, execution of algorithms, etc. FIG. 34 shows an example of such an arrangement. In particular, FIG. 34 shows a networked system (800) that includes a sequencing device (810), a server device (820), a client device (830), and a local device (840), with all devices (810, 820, 830, 840) being coupled together via a network (850). Network (850) may take any suitable form as will be apparent to those skilled in the art in view of the teachings herein.

As shown in FIG. 34, sequencing device (810) comprises a computing device and a sequencing device system (812) for sequencing a genomic sample or other nucleic-acid polymer. In some versions, by executing sequencing device system (812) using a processor, sequencing device (810) analyzes nucleotide fragments or oligonucleotides extracted from genomic samples to generate nucleotide reads or other data utilizing computer implemented methods and systems either directly or indirectly on sequencing device (810). More particularly, sequencing device (810) receives nucleotide-sample slides (e.g., flow cells (128, 368, 400, 450, 510, 670, 770)) comprising nucleotide fragments extracted from samples and further copies and determines the nucleobase sequence of such extracted nucleotide fragments. It should be understood that sequencing device (810) may represent a version of systems (100, 300, 500) described above.

In some versions, the sequencing device (810) utilizes SBS to sequence nucleotide fragments into nucleotide reads and determine nucleobase calls for the nucleotide reads. By executing sequencing device system (812), sequencing device (810) may further store the nucleobase calls as part of base-call data that is formatted as a binary base call (BCL) file and send the BCL file to the local device (840) and/or the server device(s) (820). Sequencing device (810) may communicate the BCL file and/or other data to local device (840) and/or client device (830) via network (850) or directly (i.e., bypassing network (850)).

In some scenarios, local device (840) is located at or near a same physical location of sequencing device (810). For instance, local device (840) and sequencing device (810) may be integrated into a single computing device. Local device (840) may run sequencing system (814) to generate, receive, analyze, store, and transmit digital data, such as by receiving base-call data or determining variant calls based on analyzing such base-call data. By executing software in the form of sequencing system (814), local device (840) may align nucleotide reads with a structural variation graph genome (824) and determine genetic variants based on the aligned nucleotide reads. Local device (840) may also send data to client device (830), including a variant call file (VCF) or other information indicating nucleobase calls, sequencing metrics, error data, or other metrics.

Server device(s) (820) may be located remotely from the local device (840) and sequencing device (810). Server device(s) (820) may comprise a distributed collection of servers, where server device(s) (820) include a number of server devices distributed across network (850) and located in the same or different physical locations. Similar to local device (840), server device(s) (820) may include a version of sequencing system (814). Accordingly, server device(s) (820) may generate, receive, analyze, store, and transmit digital data, such as by receiving base-call data or determining variant calls based on analyzing such base-call data. As indicated above, sequencing device (810) may send (and server device(s) (820) may receive) base-call data from sequencing device (810). Server device(s) (820) may also send data to client device (830), including VCFs or other sequencing related information.

As indicated above, as part of server device(s) (820) or local device (840), sequencing system (814) may generate or implement a structural variation graph genome with alternate contiguous sequences representing structural variant haplotypes. For instance, system (814) may identify candidate structural variants of a threshold frequency (or that otherwise satisfy another occurrence threshold) within a genomic sample database. From among the candidate structural variants, sequencing system (814) selects structural variant haplotypes based on one or both of satisfying another occurrence threshold and finding flanking variants adjacent to particular structural variant haplotypes. Sequencing system (814) may likewise select reference haplotypes of genomic regions corresponding to the selected structural variant haplotypes from a reference genome. Based on the selected haplotypes, sequencing system (814) generates a structural variation graph genome comprising both alternate contiguous sequences representing the structural variant haplotypes and reference sequences representing the reference haplotypes. Based on comparing nucleotide reads of a genomic sample with alternate contiguous sequences representing structural variant haplotypes, sequencing system (814) can determine nucleobase calls for the genomic sample.

By executing a sequencing application (832), client device (830) may generate, store, receive, and send digital data. In particular, client device (830) may receive sequencing data from local device (840) or receive call files (e.g., BCL) and sequencing metrics from sequencing device (810). Furthermore, client device (830) may communicate with local device (840) or server device(s) (820) to receive a VCF comprising nucleobase calls and/or other metrics, such as a base-call-quality metrics or pass-filter metrics. Client device (830) may accordingly present or display information pertaining to variant calls or other nucleobase calls within a graphical user interface of sequencing application (832) to a user associated with client device (830). For example, client device (830) may present structural variant calls and/or sequencing metrics for a sequenced genomic sample within a graphical user interface of sequencing application (832).

As shown in FIG. 34, sequencing application (832) is included in client device (830). Sequencing application (832) may include a web application or a native application stored and executed on client device (830) (e.g., a mobile application, desktop application). Sequencing application (832) may include instructions that (when executed) cause client device (830) to receive data from sequencing system (814) and present, for display at client device (830), base-call data or data from a VCF. Furthermore, sequencing application (832) may instruct client device (830) to display summaries for multiple sequencing runs.

As further illustrated in FIG. 34, a version of sequencing system (814) may be located and implemented (e.g., entirely or in part) on client device (830) or sequencing device (810). In some versions, sequencing system (814) is implemented by one or more other components of networked system (800), such as local device (840). In particular, sequencing system (814) may be implemented in a variety of different ways across sequencing device (810), local device (840), server device(s) (820), and client device (830). For example, sequencing system (814) may be downloaded from server device(s) (820) to sequencing system (814) and/or local device (840) where all or part of the functionality of sequencing system (814) is performed at each respective device within networked system (800).

### B. Examples of Base Calling Schemes

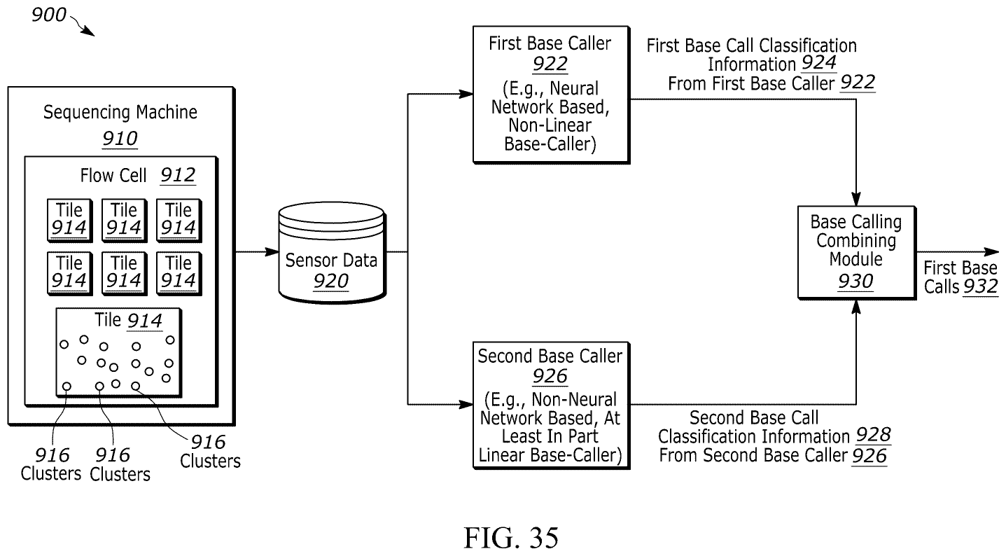

FIG. 35 illustrates a system (900) that employs two or more base callers for base calling operations on the raw images (i.e., sensor data) output by image sensors in a sequencing machine sequencing machine (910). Sequencing machine (910) of this example includes a flow cell (912), which includes a plurality of tiles (914). Each tile (914) includes a plurality of clusters (916). Sequencing machine (910) may be understood to represent a version of systems (100, 300, 500) or sequencing device (810) described above; while flow cell (912) may be understood to represent a version of flow cells (128, 368, 400, 450, 510, 670, 770) described above. Sequencing machine (910) thus outputs sensor data (920) comprising raw images from the tiles (914) of flow cell (912).

In the present example, system (900) comprises a first base caller (922) and a second base caller (926), though some variations may include more than two base callers (922, 926). Each base caller (922, 926) of this example outputs corresponding base call classification information. For example, first base caller (922) outputs first base call classification information (924); and second base caller (926) outputs second base call classification information (928). A base calling combining module (930) generates final base calls (932), based on one or both first base call classification information (924) and/or second base call classification information (928). In some versions, first base caller (922) is a neural-network based base-caller; while second base caller (926) is a non-neural network based base-caller. For example, first base caller (922) may include a non-linear system employing one or more neural network models for base calling. The first base caller (922) may also be referred to as a DeepRTA (Deep Real Time Analysis) base caller or Deep Neural Network base caller.

By way of further example only, second base caller (926) may include, at least in part, a linear system used for base calling. For example, some versions of second base caller (926) do not employ a neural network for base calling (or use a smaller neural network model for base calling, compared to a larger neural network model used by first base caller (922)). Second base caller (926) may also be referred to as an RTA (Real Time Analysis) base caller. An RTA base caller may use linear intensity extractors to extract features from sequencing images for base calling. In some such versions, RTA performs a template generation step to produce a template image that identifies locations of clusters (916) on a tile (914) using sequencing images from some number of initial sequencing cycles called template cycles. The template image is used as a reference for subsequent registration and intensity extraction steps. The template image is generated by detecting and merging bright spots in each sequencing image of the template cycles, which in turn involves sharpening a sequencing image (e.g., using the Laplacian convolution), determining an “on” threshold by a spatially segregated Otsu approach, and subsequent five-pixel local maximum detection with subpixel location interpolation.

In another example, locations of clusters (916) on a tile (914) are identified using fiducial markers. A solid support upon which a biological specimen is imaged may include such fiducial markers, to facilitate determination of the orientation of the specimen or the image thereof in relation to probes that are attached to the solid support. Examples of fiducials include, but are not limited to, beads (with or without fluorescent moieties or moieties such as nucleic acids to which labeled probes can be bound), fluorescent molecules attached at known or determinable features, or structures that combine morphological shapes with fluorescent moieties.

RTA then registers a current sequencing image against the template image. This is achieved by using image correlation to align the current sequencing image to the template image on a sub-region, or by using non-linear transformations (e.g., a full six-parameter linear affine transformation). RTA generates a color matrix to correct cross-talk between color channels of the sequencing images. RTA implements empirical phasing correction to compensate noise in the sequencing images caused by phase errors. After different corrections are applied to the sequencing images, RTA extracts signal intensities for each spot location in the sequencing images. For example, for a given spot location, signal intensity may be extracted by determining a weighted average of the intensity of the pixels in a spot location. For example, a weighted average of the center pixel and neighboring pixels may be performed using bilinear or bicubic interpolation. In some implementations, each spot location in the image may comprise a few pixels (e.g., 1-5 pixels). RTA then spatially normalizes the extracted signal intensities to account for variation in illumination across the sampled imaged. For example, intensity values may be normalized such that a 5th and 95th percentiles have values of 0 and 1, respectively. The normalized signal intensities for the image (e.g., normalized intensities for each channel) may be used to calculate mean chastity for the plurality of spots in the image.

In some implementations, RTA uses an equalizer to maximize the signal-to-noise ratio of the extracted signal intensities. The equalizer may be trained (e.g., using least square estimation, adaptive equalization algorithm) to maximize the signal-to-noise ratio of cluster intensity data in sequencing images. In some implementations, the equalizer is a lookup table (LUT) bank with a plurality of LUTs with subpixel resolution, also referred to as “equalizer filters” or “convolution kernels.” By way of example only, the number of LUTs in the equalizer may depend on the number of subpixels into which pixels of the sequencing images can be divided. For example, if the pixels are divisible into n by n subpixels (e.g., 5×5 subpixels), then the equalizer generates n2 LUTs (e.g., 25 LUTs).

In some implementations of training the equalizer, data from the sequencing images is binned by well subpixel location. It should be understood that a “well” may include depressions (404, 462, 464) of a flow cell (400, 450) or any other kind of reaction site (e.g., in a flow cell or otherwise). In an example of sequencing images being binned by well subpixel location, for a 5×5 LUT, 1/25th of the wells have a center that is in bin (1,1) (e.g., the upper left corner of a sensor pixel), 1/25th of the wells are in bin (1,2), and so on. The equalizer coefficients for each bin may be determined using least squares estimation on the subset of data from the wells corresponding to the respective bins. This way, the resulting estimated equalizer coefficients are different for each bin. Each LUT/equalizer filter/convolution kernel has a plurality of coefficients that are learned from the training. The number of coefficients in a LUT may correspond to the number of pixels that are used for base calling a cluster. For example, if a local grid of pixels (image or pixel patch) that is used to base call a cluster is of size p×p (e.g., 9×9 pixel patch), then each LUT has p2 coefficients (e.g., 81 coefficients). The training may produce equalizer coefficients that are configured to mix/combine intensity values of pixels that depict intensity emissions from a target cluster being base called and intensity emissions from one or more adjacent clusters in a manner that maximizes the signal-to-noise ratio. The signal maximized in the signal-to-noise ratio is the intensity emissions from the target cluster, and the noise minimized in the signal-to-noise ratio is the intensity emissions from the adjacent clusters, i.e., spatial crosstalk, plus some random noise (e.g., to account for background intensity emissions). The equalizer coefficients are used as weights and the mixing/combining includes executing element-wise multiplication between the equalizer coefficients and the intensity values of the pixels to calculate a weighted sum of the intensity values of the pixels, i.e., a convolution operation.

RTA then performs base calling by fitting a mathematical model to the optimized intensity data. Suitable mathematical models that can be used include, for example, a k-means clustering algorithm, a k-means-like clustering algorithm, expectation maximization clustering algorithm, a histogram based method, and the like. Four Gaussian distributions may be fit to the set of two-channel intensity data such that one distribution is applied for each of the four nucleotides represented in the data set. In some implementations, an expectation maximization (EM) algorithm may be applied. As a result of the EM algorithm, for each X, Y value (referring to each of the two channel intensities respectively) a value may be generated which represents the likelihood that a certain X, Y intensity value belongs to one of four Gaussian distributions to which the data is fitted. Where four bases give four separate distributions, each X, Y intensity value will also have four associated likelihood values, one for each of the four bases. The maximum of the four likelihood values indicates the base call. For example, if a cluster is “off” in both channels, the base call is G. If the cluster is “off” in one channel and “on” in another channel the base call is either C or T (depending on which channel is on), and if the cluster is “on” in both channels the base call is A.

In some implementations of RTA, the base calling errors get averaged out across many training examples. In some other implementations, the ground truth may be sourced using aligned genomic data, which may provide better quality because aligned genomic data may use reference genome and truth information that incorporate the knowledge gained from multiple sequencing platforms and sequencing runs to average out the noise. The ground truth may include base-specific intensity values (or feature values) that reliably represent intensity profiles of bases A, C, G, and T, respectively. A base caller like RTA base caller (926) base calls clusters by processing the sequencing images and producing, for each base call, color-wise intensity values/outputs. The color-wise intensity values may be considered base-wise intensity values because, depending on the type of chemistry (e.g., 2-color chemistry or 4-color chemistry), the colors map to each of the bases A, C, G, and T. The base with the closest matching intensity profile is called.

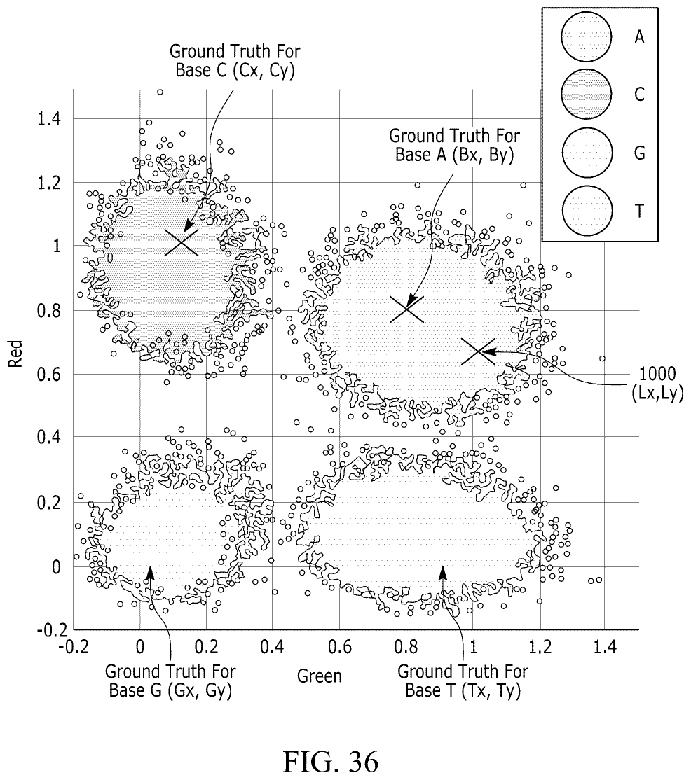

FIG. 36 shows one implementation of base-wise Gaussian fits that contain at their centers base-wise intensity targets that are used as ground truth values for error calculation during training. Base-wise intensity outputs produced by base caller (926) for a multiplicity of base calls in the training data (e.g., tens, hundreds, thousands, or millions of base calls) are used to produce a base-wise intensity distribution. FIG. 36 shows a chart with four Gaussian clouds that are a probabilistic distribution of the base-wise intensity outputs of the bases A, C, G, and T, respectively. Intensity values at the centers of the four Gaussian clouds are used as the ground truth intensity targets (or feature value targets) of the ground truth for the bases A, C, G, and T, respectively, and referred to herein as the targets (e.g., intensity or feature value targets).

Consider that, during the training, input image data that is fed to base caller (926) is annotated with base “A” as the ground truth base call. The ground truth also includes base-specific intensity values that reliably represent intensity profiles of bases A, C, G, and T, respectively. Thus, for example, the ground truth also includes, for base A, coordinates of an average intensity or average feature value for base A (i.e., a center of the green cloud in FIG. 36), as illustrated in FIG. 36 (feature values have been discussed herein later). Then, the target/desired output of the base caller (926) is the intensity value or feature value at the center of the green cloud in FIG. 36, i.e., the intensity target for base A. Similarly, for base “C,” ground truth comprises the intensity value or feature value at the center of the blue cloud in FIG. 36, i.e., the intensity target (or the feature value target) for base C having coordinates (Cx, Cy). Similarly, for base “T,” ground truth comprises the intensity value or feature value at the center of the red cloud in FIG. 36, i.e., the intensity target (or the feature value target) for base T having coordinates (Tx, Ty). Also, for base “G,” ground truth comprises the intensity value or feature value at the center of the brown cloud in FIG. 36, i.e., the intensity target (or the feature value target) for base G having coordinates (Gx,Gy). Accordingly, targets or desired outputs during the training of base caller (926) are the average intensities (or average feature values) for the respective bases A, C, G, and T after averaging in the training data. In one implementation, the trainer uses the least squares estimation to fit the coefficients of sharpening masks, to minimize the output error to these targets.

In some versions of the training, base caller (926) applies the coefficients in a given sharpening mask to pixels of a sequencing image labelled with a given base. This includes element-wise multiplying the coefficients with the intensity values of the pixels and generating a weighted sum of the intensity values of a feature map, with the coefficients serving/acting/used as the weights. The feature map includes various features having corresponding feature values. The center of a cluster may not necessarily align with the center of a pixel of the sequencing images. To account for such misalignment, in the feature map generated from the sequencing images (where the feature map is generated by convolving a sharpening mask with a corresponding section of the image), a weighted feature value assigned to a cluster is generated by bilinear interpolation, e.g., where neighboring features are interpolated to generate the weighted feature value corresponding to a cluster. The interpolated feature value corresponding to the cluster then becomes the predicted output of base caller (926) for that cluster. Then, based on a cost/error function (e.g., sum of squared errors (SSE)), an error (e.g., the least square error, the least means squared error) is calculated between the interpolated weighted feature value and the intensity target determined for the given base of the cluster (e.g., from the center of the corresponding intensity Gaussian fit as the average intensity observed for the given base). The cost function, such as the SSE, is a differentiable function used to estimate sharpening mask coefficients using an adaptive approach, and the derivatives of the error may be evaluated with respect to the coefficients, and these derivatives are then used to update the coefficients with values that minimize the error. This process is repeated until the updated coefficients do not reduce the error anymore.

In other implementations, batch least squares approach is used to train base caller (926). For example, assume that the center of the green cloud in FIG. 36, i.e., the intensity target for base A is (Ax,Ay), which is the target or desired output (e.g., a target feature value) for base A base calls. Assume that during a sequencing run, a cluster (1000) has a weighted feature value represented at coordinate (Ix,Iy). In an example, base caller (926) updates coefficients in a given sharpening mask, such that the intensity of cluster (1000) is transposed to the coordinates (Ax,Ay) from the coordinates (Ix,Iy). Thus, the training aims to minimize or reduce the distance between the coordinates (Ax,Ay) and (Ix,Iy).

By way of example only, the base-wise intensity distributions/Gaussian clouds shown in FIG. 36 may be generated on a well-by-well basis and corrected for noise by addition of a DC offset, amplification coefficient, and/or phasing parameter. This way, depending upon the well location of a particular well, the corresponding base-wise Gaussian clouds can be used to generate target intensity values for that particular well (or a cluster corresponding to the well). As noted above, a “well” may be understood to include depressions (404, 462, 464) of a flow cell (400, 450) or any other kind of reaction site (e.g., in a flow cell or otherwise).

In some versions, a bias term is added to the dot product that produces the output of base caller (926). During training, the bias parameter may be estimated using a similar approach used to learn the coefficients of the sharpening masks, e.g., least squares or least mean squares (LMS). In some implementations, the value for the bias parameter is a constant value equal to one, e.g., a value that does not vary with the input pixel intensities. There is one bias per set of coefficients. The bias is learned during the training and thereafter fixed for use during inference. The learned bias represents a DC offset that is used in every calculation during the inference, along with the learned coefficients of each sharpening mask. The bias accounts for random noise caused by different cluster sizes, different background intensities, varying stimulation responses, varying focus, varying sensor sensitivities, and varying lens aberrations. In yet other decision-directed implementations, the outputs of base caller (926) are presumed to be correct for the training purposes.

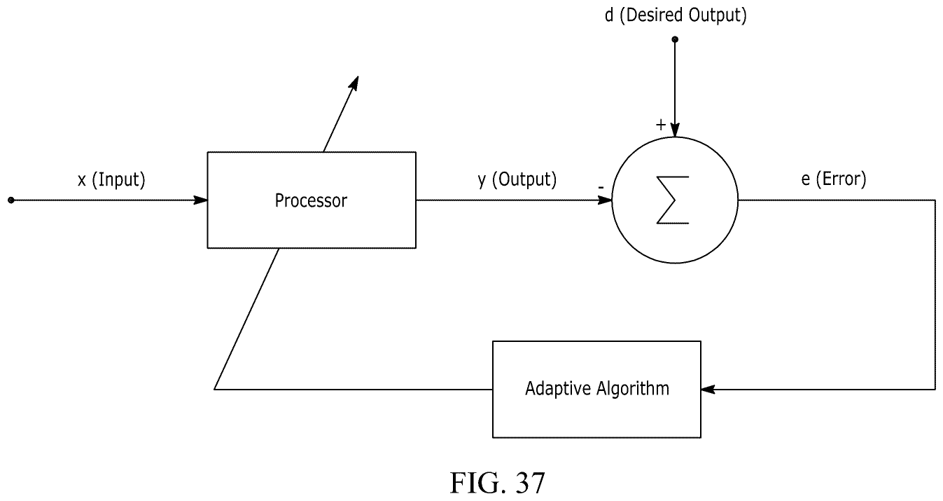

A trainer may train base caller (926) and generate the trained coefficients of the sharpening masks using various training techniques. FIG. 37 shows one implementation of an adaptive technique that may be used to train base caller (926), e.g., using an offline or online mode. Here, the logic is y=x·h+d, where x is the input pixel intensities, h is the sharpening mask coefficients, d is the DC offset. In some implementations, x and h are row and column vectors respectively, with length 81. This vector model is equivalent to a dot product of 9×9 matrices representing input pixels and coefficients. The cost is the expected value of error squared. The gradient update moves each coefficient in a direction that reduces the expected value of error squared. This leads to the following update:

$$\hat{h} ( n + 1 ) = \hat{h} ( n ) - \frac{μ}{2} ∇ C ( n ) = \hat{h} ( n ) + μ E \{ x ( n ) {e}^{*} ( n ) \}$$

For most systems the expectation function E{x(n)e*(n)} must be approximated. This can be done with the following unbiased estimator

$$\hat{E} \{ x ( n ) {e}^{*} ( n ) \} = \frac{1}{N} {\sum }_{i = 0}^{N - 1} x ( n - i ) {e}^{*} ( n - i )$$

where N indicates the number of samples, we use for that estimate. The simplest case is N=1.

$$\hat{E} \{ x ( n ) {e}^{*} ( n ) \} = x ( n ) {e}^{*} ( n )$$

For that simple case the update algorithm follows as

$$\hat{h} ( n + 1 ) = h ( n ) + μ x ( n ) {e}^{*} ( n )$$

Indeed, this constitutes the update algorithm for the LMS filter.

In equations above, h is a vector of sharpening mask coefficients, x is a vector of input intensities, and e is the error for the calculation that was performed using the values in x, i.e., only 1 error term per output. Applying this update generates a new estimate of the coefficients that moves them in a direction that (on average) reduces the mean squared error (MSE). In some implementations, Mu is a small constant used to change the adaptation rate/convergence speed. A DC term update can be calculated in a similar way. A gain term update also can be calculated in a similar way.

In some implementations, since linear interpolation is applied on the coefficient sets, the updates are applied slightly differently in the following manner:

$$h ( q , n + 1 ) = h ( q , n ) + lambda\_q \cdot mu \cdot x ( n ) \cdot e ( n )$$

In the equation above, h(q, n) is weight q at cycle n, lambda_q is the linear interpolation weight for a particular set of coefficients and can include four updates per output due to linear interpolation in two dimensions. The recursive least-squares technique extends the least squares technique to a recursive algorithm.

### C. Examples of Structural Variation Graph Genome Generation

In some scenarios, a secondary analysis may be performed iteratively while sequence reads are generated by a sequencing system such as systems (100, 300, 500, 814) described herein. Secondary analyses may encompass both alignment of sequence reads to a reference sequence (e.g., the human reference genome sequence) and utilization of this alignment to detect differences between a sample and the reference. Secondary analyses may enable detection of genetic differences, variant detection and genotyping, identification of single nucleotide polymorphisms (SNPs), small insertions and deletion (indels) and structural changes in the DNA, such as copy number variants (CNVs) and chromosomal rearrangements.

By performing secondary analyses while sequence reads are generated, system (100, 300, 500, 814) may determine preliminary variant calls iteratively in real-time (or with zero or low latency). Final results of variant determinations may be available soon after (or immediately after) the end of a sequencing run. Alternatively, a sequencing run may be terminated early if variant calls are available with sufficient confidence during the run. In some scenarios, only information related to variant determinations (e.g., variant calls) is transferred off the sequencing system (100, 300, 500, 814). This may decrease, or minimize, the data bandwidth required in comparison to performing the variant determinations in a system that is external. In addition, only variant information may be sent to a computing system (e.g., a cloud computing system) for further processing. In this example, sequencing runs may be terminated prior to completion of an entire sequencing process. For example, if the identity of a pathogen of interest is determined after a number of sequencing cycles of a sequencing run, the sequencing run may be terminated. Thus, the time to a particular answer (e.g., pathogen identification) may be decreased. In some implementations, outputs and intermediate results of system (100, 300, 500, 814) may include histograms of duplicates, exact matches, single and double SNPs, and single and double indels.

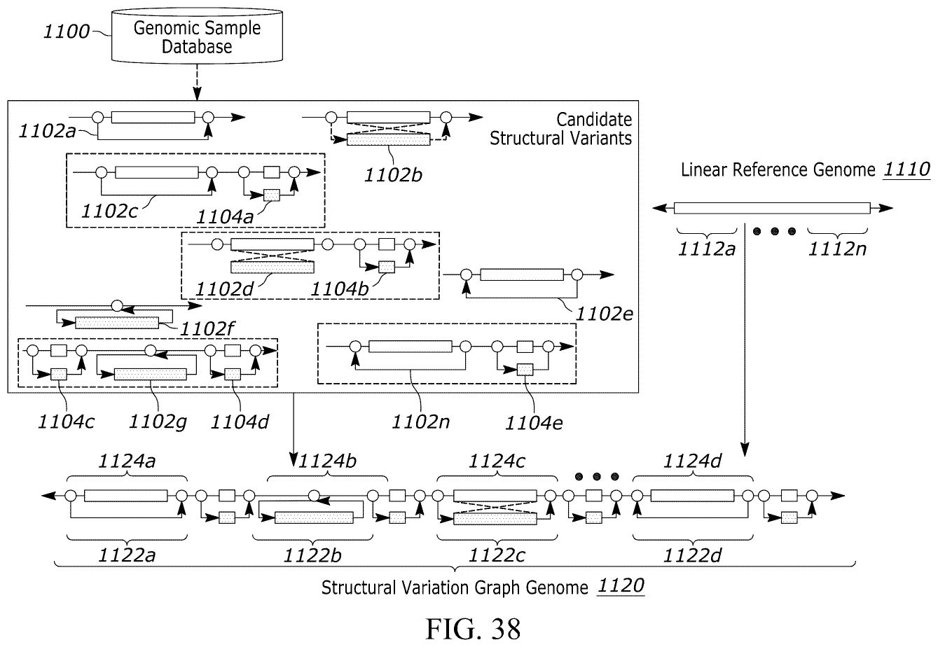

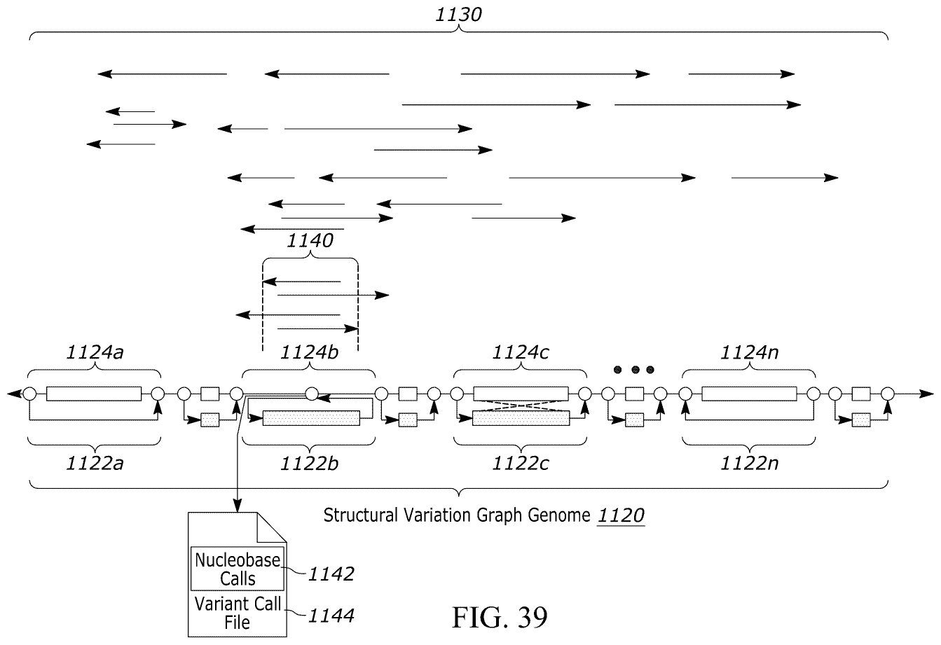

FIGS. 38-39 show examples of how systems (100, 300, 500, 814) as described herein may be used to generate and implement a structural variation graph genome. In particular, FIG. 38 illustrates an example of a sequencing system (100, 300, 500, 814) generating a structural variation graph genome (1120) comprising alternate contiguous sequences representing structural variant haplotypes and reference sequences representing reference haplotypes. FIG. 39 illustrates an example of sequencing system (100, 300, 500, 814) aligning nucleotide reads of a genomic sample with the structural variation graph genome (1120) and determining nucleobase calls for the genomic sample based on the aligned nucleotide reads.

As shown in FIG. 38, sequencing system (100, 300, 500, 814) identifies candidate structural variants (1102a-1102n) from a genomic sample database (1100) based on an occurrence threshold. For example, sequencing system (100, 300, 500, 814) identifies the candidate structural variants (1102a-1102n) that satisfy a threshold quantity of occurrences within the genomic sample database (1100). By selecting structural variants that satisfy a threshold count (e.g., 3 or more occurrences) or that satisfy a threshold frequency (e.g., 10%, 30% variant frequency) at target genomic coordinates in the genomic sample database (1100), in some implementations, sequencing system (100, 300, 500, 814) selects the candidate structural variants (1102a-1102n) from the genomic sample database (1100). The genomic sample database (1100) may include a variety of databases comprising nucleotide reads from a diverse set of genomic samples as will be apparent to those skilled in the art in view of the teachings herein.

As further indicated by FIG. 38, sequencing system (100, 300, 500, 814) identifies a variety of structural-variant types among the candidate structural variants (1102a-1102n). Based on satisfying a threshold quantity of occurrence, for instance, sequencing system (100, 300, 500, 814) identifies the candidate structural variants (1102a, 1102c) exhibiting deletions exceeding a threshold number of base pairs; the candidate structural variants (1102b, 1102d) exhibiting translocations; the candidate structural variants (1102f, 1102g) exhibiting insertions exceeding a threshold number of base pairs; and the candidate structural variants (1102e, 1102n) exhibiting duplications exceeding a threshold number of base pairs. For illustrative purposes and space constraints, FIG. 38 depicts the candidate structural variants (1102a-1102n) as merely illustrative examples. Sequencing system (100, 300, 500, 814) may identify, from the genomic sample database (1100), different types of structural variants (e.g., translocations, CNVs) and additional structural variants not depicted in FIG. 38.

From among the candidate structural variants (1102a-1102n), as further shown in FIG. 38, sequencing system (100, 300, 500, 814) selects structural variant haplotypes. In some cases, sequencing system (100, 300, 500, 814) selects structural variant haplotypes that satisfy an additional threshold quantity of occurrences at particular genomic regions, as categorized in the genomic sample database (1100). For example, in certain implementations, sequencing system (100, 300, 500, 814) selects structural variant haplotypes that satisfy a threshold variant frequency (e.g., 15%, 25%) or a threshold count (3, 10) at target genomic coordinates corresponding to the candidate structural variants (1102a-1102n).

In addition, or in the alternative, to an occurrence threshold, sequencing system (100, 300, 500, 814) may select structural variant haplotypes that are adjacent to flanking variants within contiguous sequences of the genomic sample database (1100). In some cases, the flanking variants are in phase with respective structural variant haplotypes in nucleotide sequences of the genomic sample database (1100). As indicated by FIG. 38, for instance, sequencing system (100, 300, 500, 814) determines the candidate structural variant (1102c) is in phase with a flanking variant (1104a) within a contiguous sequence (or other nucleotide sequence) of the genomic sample database (1100). Similarly, sequencing system (100, 300, 500, 814) determines the candidate structural variant (1102d) is in phase with a flanking variant (1104b), the candidate structural variant (1102g) is in phase with flanking variants (1104c, 1104d), and the candidate structural variant (1102n) is in phase with a flanking variant (1104e)—each within respective contiguous sequences (or other nucleotide sequences) of the genomic sample database (1100). Accordingly, as indicated by the dotted-line circles of FIG. 38, in some scenarios, sequencing system (100, 300, 500, 814) selects the candidate structural variants (1102c, 1102d, 1102g, 1102n) as structural variant haplotypes to include within the structural variation graph genome (1120).

In addition to selecting the candidate structural variants (1102c, 1102d, 1102g, 1102n) as structural variant haplotypes, as further shown in FIG. 38, sequencing system (100, 300, 500, 814) identifies, from a linear reference genome (1110), reference haplotypes (1112a-1112n) corresponding to the selected structural variant haplotypes. For example, in some cases, sequencing system (100, 300, 500, 814) identifies the reference haplotypes (1112a-1112n) at genomic coordinates of the linear reference genome (1110) corresponding to the selected structural variant haplotypes. Indeed, sequencing system (100, 300, 500, 814) may identify genomic coordinates of the reference haplotypes (1112a-1112n) above which to incorporate the selected variant haplotypes as liftover groups in the structural variation graph genome (1120).

As further shown in FIG. 38, sequencing system (100, 300, 500, 814) generates the structural variation graph genome (1120). As shown, the structural variation graph genome (1120) comprises alternate contiguous sequences (1122a, 1122b, 1122c, 1122n) representing the selected structural variant haplotypes. In some scenarios, one or more of the alternate contiguous sequences also include flanking variants (1104a-1104e).

To organize different structural variant haplotypes for a particular genomic region, in certain cases, sequencing system (100, 300, 500, 814) generates the structural variation graph genome (1120) by ordering different subsets of alternate contiguous sequences corresponding to different genomic regions according to structural variant frequency within the genomic sample database (1100). Accordingly, in some cases, sequencing system (100, 300, 500, 814) generates the structural variation graph genome (1120) by ordering: (i) a first subset of alternate contiguous sequences corresponding to a first genomic region according to frequency within the genomic sample database (1100); and (ii) a second subset of alternate contiguous sequences corresponding to a second genomic region according to frequency within the genomic sample database (1100).

As further shown in FIG. 38, the structural variation graph genome (1120) comprises reference sequences (1124a, 1124b, 1124c, 1124n) representing the reference haplotypes corresponding to the selected structural variant haplotypes. Indeed, in some cases, the structural variation graph genome (1120) includes and is backwards compatible with the linear reference genome (1110). Sequencing system (100, 300, 500, 814) may generate the structural variation graph genome (1120) by constructing a hash table or other organizational structure.

In addition, or in the alternative, to generating the structural variation graph genome (1120), in some embodiments, sequencing system (100, 300, 500, 814) aligns nucleotide reads of a genomic sample with the structural variation graph genome (1120) and determines nucleobase calls for the genomic sample based on the aligned nucleotide reads. FIG. 39 depicts an example of one such implementation of the structural variation graph genome (1120). As shown in FIG. 39, sequencing system (100, 300, 500, 814) identifies or receives nucleotide reads (1130) for a genomic sample. In some cases, for instance, sequencing system (100, 300, 500, 814) receives base-call data (e.g., BCL file or FASTQ file) from a sequencing device (100, 300, 500, 810), which has sequenced oligonucleotides extracted from the genomic sample and determined individual nucleobase calls for the nucleotide reads (1130) in the base-call data. Depending on the type of sequencing performed, in some scenarios, sequencing system (100, 300, 500, 814) identifies either single-end reads or paired-end reads and either short nucleotide reads (e.g., <300 base pairs or <10,000 base pairs) or long nucleotide reads (e.g., >300 base pairs or >10,000 base pairs) as the nucleotide reads (1130).

As further shown in FIG. 39, sequencing system (100, 300, 500, 814) aligns the nucleotide reads (1130) with different sequences of the structural variation graph genome (1120). In particular, sequencing system (100, 300, 500, 814) aligns a subset of nucleotide reads (1140) from the nucleotide reads (1130) with the alternate contiguous sequence (1122b) of the structural variation graph genome (1120). As FIG. 39 suggests, some or all of the subset of nucleotide reads (1140) overlap with the alternate contiguous sequence (1122b). In this particular example, the subset of nucleotide reads (1140) overlap with the alternate contiguous sequence (1122b) representing the candidate structural variant (1102f)—that is, an insertion exceeding a threshold number of bases.

In addition to the alternate contiguous sequence (1122b), in some cases, sequencing system (100, 300, 500, 814) aligns different subsets of nucleotide reads for the genomic sample with one or more of the alternate contiguous sequences (1122a, 1122c, 1122n) or the reference sequences (1124a-1124n) of the structural variation graph genome (1120). Accordingly, in certain implementations, sequencing system (100, 300, 500, 814) aligns certain nucleotide reads with alternate contiguous sequences representing different types of structural variant haplotypes, including, but not limited to, insertions, deletions, duplications, inversions, translocations, or CNVs. Likewise, in some cases, sequencing system (100, 300, 500, 814) aligns certain nucleotide reads with reference sequences representing reference haplotypes from the linear reference genome.

As further shown in FIG. 39, sequencing system (100, 300, 500, 814) determines nucleobase calls (1142) for the genomic sample based on the subset of nucleotide reads (1140) aligning with the alternate contiguous sequence (1122b). For example, sequencing system (100, 300, 500, 814) generates one or more variant calls corresponding to a structural variant haplotype represented by the alternate contiguous sequence (1122b). Sequencing system (100, 300, 500, 814) determines such variant calls in part because an alignment of the subset of nucleotide reads (1140) with the alternate contiguous sequence (1122b) exhibits better mapping metrics, base-call-quality metrics, or other sequencing metrics than an alignment of the subset of nucleotide reads (1140) with the reference sequence (1124b). In some embodiments, sequencing system (100, 300, 500, 814) generates a variant call file (1144) comprising the nucleobase calls (1142) along with other nucleobase calls based on read alignments. As noted above, sequencing system (100, 300, 500, 814) may select structural variant haplotypes from a genomic sample database to include within a structural variation graph genome.

By way of further example only, base calling and/or other aspects of system (100, 300, 500, 800, 814) may be carried out in accordance with at least some of the teachings of U.S. Pat. App. No. 63/367,075, entitled “GENERATING AND IMPLEMENTING A STRUCTURAL VARIATION GRAPH GENOME,” filed Jun. 27, 2022, the disclosure of which is incorporated by reference herein, in its entirety; U.S. Pat. App. No. 63/223,408, entitled SPECIALIST SIGNAL PROFILERS FOR BASE CALLING,” filed Jul. 19, 2021, the disclosure of which is incorporated by reference herein, in its entirety; U.S. patent application Ser. No. 17/876,528, entitled “Base Calling Using Multiple Base Caller Models,” filed Jul. 28, 2022, the disclosure of which is incorporated by reference herein, in its entirety; U.S. Pat. No. 10,152,776, entitled “Optical Distortion Correction for Imaged Samples,” issued Nov. 20, 2018, the disclosure of which is incorporated by reference herein, in its entirety; U.S. Pat. No. 10,540,783, entitled “Image Analysis Useful for Patterned Objects,” issued Jan. 21, 2020, the disclosure of which is incorporated by reference herein, in its entirety; U.S. Pat. No. 10,689,696, entitled “Methods and Systems for Analyzing Image Data,” issued Jun. 23, 2020, the disclosure of which is incorporated by reference herein, in its entirety; U.S. Pat. No. 8,965,076, entitled “Data Processing System and Methods,” issued Feb. 24, 2015, the disclosure of which is incorporated by reference herein, in its entirety; U.S. Pat. No. 11,188,778, entitled “Equalization-Based Image Processing and Spatial Crosstalk Attenuator,” issued Nov. 30, 2021, the disclosure of which is incorporated by reference herein, in its entirety; and/or U.S. Pub. No. 2020/0302297, entitled “Artificial Intelligence-Based Base Calling,” published Sep. 24, 2020, the disclosure of which is incorporated by reference herein, in its entirety.

### VII. EXAMPLES OF COMBINATIONS

The following examples relate to various non-exhaustive ways in which the teachings herein may be combined or applied. The following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

Example 1. An apparatus, comprising: a first reagent cartridge; a second reagent cartridge; a system, comprising: a sipper manifold assembly comprising a sipper; a queue to carry the first reagent cartridge and the second reagent cartridge; a cartridge moving assembly comprising a gantry, a carriage actuator, and a carriage, the carriage coupled to the gantry and the carriage actuator to move the carriage relative to the gantry; and a cartridge receptacle assembly comprising a cartridge receptacle to receive the first reagent cartridge or the second reagent cartridge, wherein the carriage is to move the first reagent cartridge from the queue and position the first reagent cartridge into the cartridge receptacle.

Example 2. The apparatus of example 1, wherein the sipper manifold assembly comprises a sipper actuator to move the sipper relative to the cartridge receptacle.

Example 3. The apparatus of example 1, wherein the cartridge receptacle assembly comprises an opening and a lock movable between an unlocked position and a locked position, the first reagent cartridge positionable through the opening when the lock is in the unlocked position and the first reagent cartridge securable in the cartridge receptacle when the lock is in the locked position.

Example 4. The apparatus of example 3, wherein the lock comprises a lock actuator and an arm, the lock actuator to move the arm from the unlocked position to the locked position.

Example 5. The apparatus of any one of the preceding examples, wherein the queue comprises a shelf having a first position and a second position, the first reagent cartridge being positioned at the first position and the second reagent cartridge being positioned at the second position.

Example 6. The apparatus of example 5, wherein the shelf comprises a first access aperture at the first position and a second access aperture at the second position.

Example 7. The apparatus of example 6, wherein the carriage actuator is to position the carriage beneath the first reagent cartridge and move the carriage through the first access aperture to lift the first reagent cartridge from the first position.

Example 8. The apparatus of any one the preceding examples, further comprises a third reagent cartridge and a drawer carrying the third reagent cartridge.

Example 9. The apparatus of example 8, wherein the carriage is to move the third cartridge from the drawer onto the queue.

Example 10. The apparatus of example 9, wherein the drawer comprises an access aperture and wherein the carriage actuator is to position the carriage beneath the third reagent cartridge and move the carriage through the access aperture of the drawer to lift the third reagent cartridge from the drawer.

Example 11. The apparatus of any one of examples 7-10, wherein the system further comprises a door that is movable to enable access to the drawer.

Example 12. The apparatus of any one of the preceding examples, further comprising a first reagent cartridge assembly comprising the first reagent cartridge and a first flow cell.

Example 13. The apparatus of example 12, wherein the system comprises a flow cell interface to receive the first flow cell.

Example 14. The apparatus of any one of examples 12-13, wherein the first reagent cartridge assembly comprises a lid.

Example 15. The apparatus of example 14, wherein the first reagent cartridge assembly comprises a body to which the lid is pivotably coupled.

Example 16. The apparatus of any one of examples 14-15, wherein the lid covers the flow cell.

Example 17. The apparatus of any one of examples 13-16, wherein the system comprises a pick-and-place assembly to move the first flow cell from the first reagent cartridge assembly to the flow cell interface.

Example 18. The apparatus of example 17, wherein the pick-and-place assembly comprises an actuator and a gripper, the actuator to move the gripper, and the gripper to move the first flow cell from the first reagent cartridge assembly to the flow cell interface.

Example 19. An apparatus, comprising: a system, comprising: a sipper manifold assembly comprising a sipper; a queue to carry reagent cartridges; a cartridge moving assembly comprising a gantry, a carriage actuator, and a carriage, the carriage coupled to the gantry and the carriage actuator to move the carriage relative to the gantry; and a cartridge receptacle assembly comprising a cartridge receptacle, wherein the carriage is to move the reagent cartridges from the queue to the cartridge receptacle assembly.

Example 20. The apparatus of example 19, wherein the gantry comprises a two-dimensional gantry.

Example 21. The apparatus of any one of examples 19-20, wherein the gantry comprises a pair of horizontal guides and a vertical guide movably coupled to the horizontal guides.

Example 22. The apparatus of example 21, wherein the carriage actuator is to move the carriage along the vertical guide.

Example 23. The apparatus of any one of examples 19-22, wherein the cartridge receptacle assembly comprises a lock movable between an unlocked position and a locked position, a corresponding reagent cartridge positionable within the cartridge receptacle when the lock is in the unlocked position and the corresponding reagent cartridge is securable in the cartridge receptacle when the lock is in the locked position.

Example 24. The apparatus of example 23, wherein the lock comprises a lock actuator, an actuator rod, a link, and an arm, the actuator rod coupled to the lock actuator, the link pivotably coupling the actuator rod and the arm, the arm comprising a distal end coupled to the lock actuator at a pivot.

Example 25. The apparatus of example 24, wherein the lock actuator is to linearly move the actuator rod and cause the arm to move about the pivot between the locked position and the unlocked position.

Example 26. The apparatus of any one of examples 23-25, wherein the cartridge receptacle assembly defines a sipper access opening.

Example 27. The apparatus of example 26, wherein the sipper manifold assembly comprises a sipper actuator to move the sipper through the sipper access opening.

Example 28. The apparatus of example 27, wherein the sipper actuator comprises a linear actuator.

Example 29. The apparatus of any one of examples 27-28, wherein the sipper manifold assembly comprises a frame and a vertical guide coupled to the frame, the sipper actuator coupled to the frame and the sipper movably coupled to the vertical guide.

Example 30. The apparatus of example 29, wherein the sipper actuator to move the sipper along the vertical guide.

Example 31. The apparatus of any one of examples 27-30, wherein the sipper manifold assembly comprises a rack and pinion actuator to horizontally move the sipper.

Example 32. The apparatus of any one of example 19, 20, 23-31, wherein the gantry comprises a horizontal guide and a vertical guide movably coupled to the horizontal guide.

Example 33. The apparatus of example 32, wherein the horizontal guide comprises a first rail and a first block and the vertical guide comprises a second rail and a second block.

Example 34. The apparatus of example 33, further comprising a vertical frame coupled to the first block, the second rail coupled to the vertical frame, the carriage actuator coupled to the second block and the vertical frame to move the second block and the carriage.

Example 35. The apparatus of any one of examples 32-34, further comprising a gantry actuator to horizontally move the carriage.

Example 36. The apparatus of example 35, further comprising a horizonal frame to which the horizontal guide is coupled, wherein the gantry actuator is to horizontally move the vertical guide.

Example 37. The apparatus of any one of examples 19-36, wherein the queue comprises a first position and a second position and comprises a first access aperture at the first position and a second access aperture at the second position, the reagent cartridges to be at the corresponding first position or the second position.

Example 38. The apparatus of example 37, wherein the queue comprises a shelf comprising a first receptacle at the first position and a second receptacle at the second position.

Example 39. The apparatus of any one of examples 37-38, wherein the carriage actuator is to move the carriage through the first access aperture to lift a corresponding reagent cartridge from the first position.

Example 40. The apparatus of example 39, wherein the carriage has a pair of protrusions.

Example 41. The apparatus of example 40, further comprising the reagent cartridges.

Example 42. The apparatus of example 41, wherein the reagent cartridges each have a base defining downward opening apertures to receive the protrusions.

Example 43. The apparatus of any one of examples 19-38, 41, wherein the carriage has a pair of lifting arms.

Example 44. The apparatus of example 43, wherein the carriage actuator is to move the carriage to position the lifting arms to lift the corresponding reagent cartridge.

Example 45. The apparatus of any one of examples 19-42, further comprising a flow cell interface to receive a flow cell.

Example 46. The apparatus of example 45, further comprising a pick-and-place assembly to move the flow cell to the flow cell interface.

Example 47. The apparatus of example 46, wherein the pick-and-place assembly comprises a gantry, corresponding actuators, and a gripper, the actuators to move the gripper.

Example 48. The apparatus of example 47, wherein the actuators comprises an x-actuator, a y-actuator, and a z-actuator.

Example 49. The apparatus of example 48, wherein the x-actuator is to move the gripper in the x-direction, the y-actuator is to move the gripper in the y-direction, and the z-actuator is to move the gripper in the z-direction.

Example 50. The apparatus of any one of examples 47-49, wherein the gantry of the pick-and-place assembly comprises a three-dimensional gantry.

Example 51. The apparatus of example 50, wherein the three-dimensional gantry comprises a first rail and a first block for the x-direction, a second rail and a second block for the y-direction, and a third rail and a third block for the z-direction.

Example 52. The apparatus of example 51, wherein the z-actuator comprises a nested linear actuator.

Example 53. The apparatus of example 52, wherein the nested linear actuator comprises a lead screw.

Example 54. The apparatus of example 46, wherein the pick-and-place assembly comprises a vertical linear actuator, a first arm, and a second arm, the first arm coupled to and between the vertical linear actuator and the second arm.

Example 55. The apparatus of example 54, wherein the vertical linear actuator comprises a rail and a block and wherein the first arm is pivotably coupled to the block and wherein the second arm is pivotably coupled to the first arm.

Example 56. The apparatus of example 55, further comprising a first actuator and a second actuator, the first actuator to rotate the first arm relative to the block and the second actuator to rotate the second arm relative to the first arm.

Example 57. The apparatus of anyone of examples 54-56, wherein the second arm comprises a distal end and a gripper is coupled at the distal end of the second arm.

Example 58. The apparatus of example 57, further comprising a gripper actuator carried by the second arm to actuate the gripper.

Example 59. The apparatus of example 46, wherein the pick-and-place assembly comprises a vertical linear actuator, a first arm, and a second arm, the first arm coupled to and between the vertical linear actuator and the second arm.

Example 60. The apparatus of example 59, further comprising a horizontal linear actuator, wherein the vertical linear actuator comprises a rail and a block and wherein the first arm is pivotably coupled to the block, the horizontal linear actuator couples the first arm and the second arm.

Example 61. The apparatus of anyone of examples 59-60, wherein the second arm comprises a distal end and a gripper is coupled at the distal end of the second arm.

Example 62. The apparatus of example 61, further comprising a gripper actuator carried by the second arm to actuate the gripper.

Example 63. An apparatus, comprising: a system, comprising: a sipper manifold assembly comprising a sipper; a cartridge conveyor assembly having a stop; a vertical assembly comprising a plurality of cartridge slots to carry reagent cartridges; and a cartridge moving assembly comprising a carriage actuator and a carriage, the carriage actuator to move the carriage relative to the cartridge conveyor assembly and the vertical assembly, wherein the carriage is to move one of the reagent cartridges from the vertical assembly to the cartridge conveyor assembly.

Example 64. The apparatus of example 63, wherein the carriage comprises a pair of inward extending lips.

Example 65. The apparatus of example 64, wherein the lips are to engage a portion of a corresponding reagent cartridge to enable the carriage to move the reagent cartridge from the vertical assembly to the cartridge conveyor assembly.

Example 66. The apparatus of any one of examples 64-65, wherein the carriage defines an opening between the lips.

Example 67. The apparatus of any one of examples 63-66, wherein the cartridge conveyor assembly comprises a first conveyor, a second conveyor, and a stop, the second conveyor having an end and the stop positioned at the end of the second conveyor.

Example 68. The apparatus of example 67, wherein the first conveyor is positioned approximately perpendicular to the second conveyor.

Example 69. The apparatus of any one or examples 67-68, wherein the cartridge conveyor assembly comprises a pusher to move the reagent cartridge from the first conveyor to the second conveyer.

Example 70. The apparatus of any one of examples 63-69, wherein the stop is to be engaged by the reagent cartridge.

Example 71. The apparatus of anyone of examples 67-70, wherein the sipper manifold assembly comprises a sipper actuator to move the sipper relative to the second conveyor.

Example 72. The apparatus of any one of examples 67-71, wherein the carriage defines an opening and the carriage actuator is to move the carriage to enable the opening of the carriage to straddle the first conveyor.

Example 73. The apparatus of example 72, wherein the first conveyor is to move the reagent cartridge from the carriage.

Example 74. An apparatus, comprising: a system, comprising: a sipper manifold assembly comprising a sipper; a first vertical assembly comprising a pusher, an actuator, and a plurality of first cartridge slots to carry reagent cartridges; a second vertical assembly comprising a second actuator and a plurality of second cartridge slots; and a conveyor extending between the first vertical assembly and the second vertical assembly, wherein the first actuator is to align one of the first cartridge slots with the conveyor and the second actuator is to align one of the second cartridge slots with the conveyor, and wherein the pusher is to move one of the reagent cartridges from the corresponding first cartridge slot onto the conveyor.

Example 75. The apparatus of anyone of example 74, wherein the sipper manifold assembly comprises a sipper actuator to move the sipper relative to the conveyor.

Example 76. An apparatus, comprising: a system, comprising: a sipper manifold assembly comprising a sipper; and a cartridge conveyor assembly to move reagent cartridges toward the sipper manifold assembly, wherein the sipper manifold assembly is positioned to access a reagent cartridge positioned on the cartridge conveyor assembly.

Example 77. The apparatus of example 76, wherein the cartridge conveyor assembly comprises a first conveyor, a second conveyor, a third conveyor, the third conveyor positioned beneath the first conveyor.

Example 78. The apparatus of example 77, wherein the cartridge conveyor assembly further comprises a conveyor actuator to move the second conveyor between a raised position and a lowered position.

Example 79. The apparatus of any one of examples 76-78, wherein the sipper manifold assembly is positioned to access a reagent cartridge positioned on the second conveyor in the raised position

Example 80. The apparatus of any one of examples 76-78, further comprising a flow cell interface to receive a flow cell.

Example 81. The apparatus of example 80, further comprising a pick-and-place assembly to move the flow cell to the flow cell interface.

Example 82. The apparatus of example 81, further comprising a reagent cartridge assembly comprising a reagent cartridge and a flow cell, the reagent cartridge assembly to be positioned on the cartridge conveyor assembly.

Example 83. The apparatus of example 82, wherein the pick-and-place assembly is to move the flow cell from the reagent cartridge assembly to the flow cell interface.

Example 84. The apparatus of example 83, wherein the pick-and-place assembly comprises an actuator and a gripper, the actuator to move the gripper, and the gripper to move the flow cell from the reagent cartridge assembly to the flow cell interface.

Example 85. An apparatus, comprising: a system, comprising: a sipper manifold assembly comprising a sipper and a sipper actuator; a first carriage to carry a first reagent cartridge; and a second carriage to carry a second regent cartridge, wherein the sipper actuator is to move the sipper relative to the first carriage and the second carriage.

Example 86. The apparatus of example 85, wherein the sipper actuator enables three-dimensional movement of the sipper.

Example 87. The apparatus of anyone of examples 85-86, wherein the sipper actuator is to move the sipper vertically and horizontally.

Example 88. The apparatus of any one of examples 85-87, further comprising a first carriage actuator and a second carriage actuator, the first carriage actuator to move the first carriage toward the sipper manifold assembly and the second carriage actuator to move the second carriage toward the sipper manifold assembly.

Example 89. The apparatus of any one of examples 85-88, further comprising a door that enables access to the first carriage and the second carriage.

Example 90. The apparatus of example 89, further comprising a lock that is actuatable between a locked position and an unlocked position, wherein the door is movable between a closed position and an open position, the lock in the unlocked position to enable movement of the door from the closed position to the open position, the lock in the locked position to inhibit movement of the door from the closed position to the open position.

Example 91. The apparatus of any one of examples 85-90, further comprising a flow cell interface to receive a flow cell.

Example 92. The apparatus of example 91, further comprising a pick-and-place assembly to move the flow cell to the flow cell interface.

Example 93. The apparatus of example 92, further comprising a reagent cartridge assembly comprising a reagent cartridge and a flow cell, the reagent cartridge assembly to be positioned on the first carriage or the second carriage.

Example 94. The apparatus of example 93, wherein the pick-and-place assembly is to move the flow cell from the reagent cartridge assembly to the flow cell interface.

Example 95. The apparatus of any one of examples 93-94, wherein the reagent cartridge assembly comprises a lid.

Example 96. The apparatus of example 95, wherein the reagent cartridge assembly comprises a body to which the lid is pivotably coupled.

Example 97. The apparatus of example 96, wherein the lid covers the flow cell.

Example 98. The apparatus of example 97, further comprising a first carriage actuator to move the first carriage toward the sipper manifold assembly, wherein the lid is to be moved from covering the flow cell.

Example 99. A method, comprising: moving a first reagent cartridge from a drawer to a first position on a queue using a cartridge moving assembly comprising a gantry, a carriage actuator, and a carriage; moving a second reagent cartridge from the drawer to a second position on the queue using the cartridge moving assembly; moving the first reagent cartridge from the queue; and positioning the first reagent cartridge in a cartridge receptacle of a cartridge receptacle assembly, the cartridge receptacle accessible by a sipper of a sipper manifold assembly.

Example 100. The method of example 99, further comprising moving the sipper relative to the cartridge receptacle using a sipper actuator.

Example 101. The method of any one of examples 99-100, wherein positioning the first reagent cartridge in the cartridge receptacle comprises moving a lock of the cartridge receptacle assembly to an unlocked position to enable the first reagent cartridge to be positioned through an opening of the reagent cartridge receptacle and within the cartridge receptacle.

Example 102. The apparatus of example 101, further comprising moving the lock from the unlocked position to the locked position after the first reagent cartridge is positioned within the receptacle to secure the first reagent cartridge in the cartridge receptacle.

Example 103. The method of any one of examples 99-102, wherein moving the first reagent cartridge from the queue comprises positioning the carriage beneath the first reagent cartridge and moving the carriage through a first access aperture of a shelf of the queue to lift the first reagent cartridge from the first position.

Example 104. The method of anyone of examples 99-103, wherein moving the first reagent cartridge from the drawer comprises positioning the carriage beneath the first reagent cartridge and moving the carriage through an access aperture of the drawer to lift the first reagent cartridge from the drawer.

Example 105. The method of any one of examples 99-104, further comprising moving a flow cell from a first reagent cartridge assembly comprising the first reagent cartridge to a flow cell interface using a pick-and-place assembly.

Example 106. A method, comprising: moving a reagent cartridge from a vertical assembly to a cartridge conveyor assembly using a cartridge moving assembly comprising a carriage actuator and a carriage, the vertical assembly comprising a plurality of cartridge slots to carry reagent cartridges; engaging a stop of the cartridge conveyor assembly with the reagent cartridge; and moving a sipper of a sipper manifold assembly toward the reagent cartridge using a sipper actuator of the sipper manifold assembly.

Example 107. The method of example 106, wherein moving the reagent cartridge from the vertical assembly to the cartridge conveyor assembly comprising positioning the reagent cartridge on a first conveyor of the cartridge conveyor assembly.

Example 108. The method of example 107, further comprising moving the reagent cartridge from the first conveyor to a second conveyor using a pusher, the second conveyor having an end and the stop positioned at the end of the second conveyor.

Example 109. The apparatus of example 108, wherein the first conveyor is positioned approximately perpendicular to the second conveyor.

Example 110. A method, comprising: aligning one of first cartridge slots of a first vertical assembly with a conveyor, the first vertical assembly comprising a pusher, a first actuator, and the first cartridge slots carrying reagent cartridges; aligning one of second cartridge slots of a second vertical assembly with the conveyor, the second vertical assembly comprising a second actuator and second cartridge slots; and moving one of the reagent cartridges from the corresponding first cartridge slot onto the conveyor using the pusher.

Example 111. The method of example 110, further comprising moving a sipper of a sipper manifold assembly toward the reagent cartridge on the conveyor using a sipper actuator of the sipper manifold assembly.

Example 112. A method, comprising: moving reagent cartridges toward a sipper manifold assembly using a cartridge conveyor system; and accessing a first reagent cartridge of the reagent cartridges positioned on the cartridge conveyor system using a sipper manifold assembly.

Example 113. The method of example 112, wherein the cartridge conveyor assembly comprises a first conveyor, a second conveyor, a third conveyor, the third conveyor positioned beneath the first conveyor, and wherein accessing the first reagent cartridge comprises accessing the first reagent cartridge on the second conveyor.

Example 114. The method of example 113, further comprising moving the second conveyor between a raised position and a lowered position, the first reagent cartridge to move onto the third conveyor when the second conveyor is in the lowered position.

Example 115. The method of any one of examples 110-114, further comprising moving a flow cell to a flow cell interface using a pick-and-place assembly.

Example 116. The method of example 115, wherein moving the flow cell to the flow cell interface comprises moving the flow cell from a reagent cartridge assembly comprising the reagent cartridge to the flow cell interface.

Example 117. A method, comprising: drawings first reagent from a first reagent cartridge carried by a first carriage using a sipper of a sipper manifold assembly; flowing the first reagent to a first flow cell; moving the sipper manifold assembly above a second carriage carrying a second reagent cartridge using a sipper actuator; drawings second reagent from the second reagent cartridge carried by the second carriage using the sipper of the sipper manifold assembly; and flowing the second reagent to a second flow cell.

Example 118. The method of example 117, further comprising moving the first carriage carrying the first reagent cartridge toward the sipper manifold assembly using a first carriage actuator before drawings the first reagent from the first reagent cartridge.

Example 119. The method of any one of examples 117-118, further comprising moving the second carriage carrying the second reagent cartridge toward the sipper manifold assembly using a second carriage actuator before drawings the second reagent from the second reagent cartridge.

Example 120. The method of any one of examples 117-119, wherein the sipper actuator enables three-dimensional movement of the sipper.

Example 121. The method of any one of examples 117-119, further comprising enabling access to the first carriage and the second carriage using a door.

Example 122. The method of example 121, further comprising inhibiting the door from moving from the closed position to the open position using a lock.

Example 123. The method of example 122, further comprising moving the first carriage carrying the first reagent cartridge toward the sipper manifold assembly and wherein the lock inhibits the door from moving from the closed position to the open position when the first carriage is moved toward the sipper manifold assembly.

Example 124. The method of any one of examples 117-123, further comprising moving a flow cell to a flow cell interface using a pick-and-place assembly.

Example 125. An apparatus, comprising: a system, comprising: a drawer to receive a reagent cartridge; a cartridge moving assembly comprising a gantry, a carriage actuator, and a carriage comprising a pair of lifting arms and an arm actuator; and a queue, wherein the arm actuator is to actuate the lifting arms to position the lifting arms about the reagent cartridge and the carriage is to move the reagent cartridge from the drawer to the queue.

Example 126. The apparatus of example 125, wherein the arm actuator comprises a rack-and-pinion rotary actuator.

Example 127. The apparatus of any one of examples 125-126, wherein the lifting arms comprise inward extending protrusions that interact with the reagent cartridge to enable the lifting arms to lift the reagent cartridge.

Example 128. The apparatus of any one of examples 125-127, wherein the drawer is to receive a plurality of the reagent cartridges.

Example 129. The apparatus of any one of examples 125-128, wherein the queue is to receive a plurality of the reagent cartridges.

Example 130. The apparatus of any one of examples 125-129, further comprising a sipper manifold assembly comprising a sipper and a cartridge receptacle assembly comprising a cartridge receptacle.

Example 131. The apparatus of example 130, wherein the arm actuator is to actuate the lifting arms to position the lifting arms about the reagent cartridge at the queue and move the reagent cartridge from the queue and into the cartridge receptacle.

Example 132. The apparatus of any one of examples 130-132, wherein the cartridge receptacle assembly comprises a heater and the reagent cartridge comprises a well, the heater to heat the well when the cartridge receptacle receives the reagent cartridge.

Example 133. The apparatus of any one of examples 125-132, further comprising a pick-and-place assembly comprising a first arm, a second arm, and a vertical linear actuator, the second arm coupled to and between the vertical linear actuator and the first arm.

Example 134. The apparatus of example 133, further comprising a third arm, the vertical linear actuator to linearly move the third arm.

Example 135. The apparatus of example 134, wherein the third arm comprises a distal end and wherein the pick-and-place assembly comprises a gripper coupled at the distal end of the third arm.

Example 136. An apparatus, comprising: a reagent cartridge assembly comprising a reagent cartridge and a flow cell, wherein the reagent cartridge assembly comprises a lid and a body to which the lid is pivotably coupled, wherein the lid covers the flow cell.

Example 137. The apparatus of example 136, wherein the reagent cartridge contains clustering reagent.

Example 138. The apparatus of example 136, wherein the reagent cartridge is to contain clustering reagent.

### VIII. MISCELLANEOUS

While the foregoing examples are provided in the context of a system (100) that may be used in nucleotide sequencing processes, the teachings herein may also be readily applied in other contexts, including in systems that perform other processes (i.e., other than nucleotide sequencing procedures). The teachings herein are thus not necessarily limited to systems that are used to perform nucleotide sequencing processes.

It is to be understood that the subject matter described herein is not limited in its application to the details of construction and the arrangement of components set forth in the description herein or illustrated in the drawings hereof. The subject matter described herein is capable of other implementations and of being practiced or of being carried out in various ways. Also, it is to be understood that the phraseology and terminology used herein is for the purpose of description and should not be regarded as limiting. As used herein, an element or step recited in the singular and proceeded with the word “a” or “an” should be understood as not excluding plural of said elements or steps, unless such exclusion is explicitly stated. Furthermore, references to “one example” are not intended to be interpreted as excluding the existence of additional examples that also incorporate the recited features. The use of “including,” “comprising,” or “having” and variations thereof herein is meant to encompass the items listed thereafter and equivalents thereof as well as additional items.

When used in the claims, the term “set” should be understood as one or more things which are grouped together. Similarly, when used in the claims “based on” should be understood as indicating that one thing is determined at least in part by what it is specified as being “based on.” Where one thing is required to be exclusively determined by another thing, then that thing will be referred to as being “exclusively based on” that which it is determined by.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. Also, it is to be understood that phraseology and terminology used herein with reference to device or element orientation (such as, for example, terms like “above,” “below,” “front,” “rear,” “distal,” “proximal,” and the like) are only used to simplify description of one or more examples described herein, and do not alone indicate or imply that the device or element referred to must have a particular orientation. In addition, terms such as “outer” and “inner” are used herein for purposes of description and are not intended to indicate or imply relative importance or significance.

It is to be understood that the above description is intended to be illustrative, and not restrictive. For example, the above-described examples (and/or aspects thereof) may be used in combination with each other. In addition, many modifications may be made to adapt a particular situation or material to the teachings of the presently described subject matter without departing from its scope. While the dimensions, types of materials and coatings described herein are intended to define the parameters of the disclosed subject matter, they are by no means limiting and instead illustrations. Many further examples will be apparent to those of skill in the art upon reviewing the above description. The scope of the disclosed subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f) paragraph, unless and until such claim limitations expressly use the phrase “means for” followed by a statement of function void of further structure.

The following claims recite aspects of certain examples of the disclosed subject matter and are considered to be part of the above disclosure. These aspects may be combined with one another.

1. An apparatus, comprising:
a first reagent cartridge;
a second reagent cartridge; and
a system, comprising:
a sipper manifold assembly comprising a sipper;
a queue to carry the first reagent cartridge and the second reagent cartridge;
a cartridge moving assembly comprising a gantry, a carriage actuator, and a carriage, the carriage coupled to the gantry and the carriage actuator to move the carriage relative to the gantry; and
a cartridge receptacle assembly comprising a cartridge receptacle to receive the first reagent cartridge or the second reagent cartridge,
wherein the carriage is to move the first reagent cartridge from the queue and position the first reagent cartridge into the cartridge receptacle.

2. (canceled)

3. The apparatus of claim 1, wherein the cartridge receptacle assembly comprises an opening and a lock movable between an unlocked position and a locked position, the first reagent cartridge positionable through the opening when the lock is in the unlocked position and the first reagent cartridge securable in the cartridge receptacle when the lock is in the locked position.

4. The apparatus of claim 3, wherein the lock comprises a lock actuator and an arm, the lock actuator to move the arm from the unlocked position to the locked position.

5. The apparatus of claim 1, wherein the queue comprises a shelf having a first position and a second position, the first reagent cartridge being positioned at the first position and the second reagent cartridge being positioned at the second position.

6. The apparatus of claim 5, wherein the shelf comprises a first access aperture at the first position and a second access aperture at the second position.

7. The apparatus of claim 6, wherein the carriage actuator is to position the carriage beneath the first reagent cartridge and move the carriage through the first access aperture to lift the first reagent cartridge from the first position, further comprises a third reagent cartridge and a drawer carrying the third reagent cartridge, wherein the carriage is to move the third cartridge from the drawer onto the queue, wherein the drawer comprises an access aperture and wherein the carriage actuator is to position the carriage beneath the third reagent cartridge and move the carriage through the access aperture of the drawer to lift the third reagent cartridge from the drawer.

8-10. (canceled)

11. The apparatus of claim 7, wherein the system further comprises a door that is movable to enable access to the drawer.

12. The apparatus of claim 1, further comprising a first reagent cartridge assembly comprising the first reagent cartridge and a first flow cell, wherein the system comprises a flow cell interface to receive the first flow cell, wherein the first reagent cartridge assembly comprises a lid and a body to which the lid is pivotably coupled, wherein the lid covers the flow cell.

13-16. (canceled)

17. The apparatus of claim 12, wherein the system comprises a pick-and-place assembly to move the first flow cell from the first reagent cartridge assembly to the flow cell interface.

18. The apparatus of claim 17, wherein the pick-and-place assembly comprises an actuator and a gripper, the actuator to move the gripper, and the gripper to move the first flow cell from the first reagent cartridge assembly to the flow cell interface.

19. An apparatus, comprising:
a system, comprising:
a sipper manifold assembly comprising a sipper;
a queue to carry reagent cartridges;
a cartridge moving assembly comprising a gantry, a carriage actuator, and a carriage, the carriage coupled to the gantry and the carriage actuator to move the carriage relative to the gantry; and
a cartridge receptacle assembly comprising a cartridge receptacle,
wherein the carriage is to move the reagent cartridges from the queue to the cartridge receptacle assembly.

20. The apparatus of claim 19, wherein the gantry comprises a two-dimensional gantry, wherein the gantry comprises a pair of horizontal guides and a vertical guide movably coupled to the horizontal guides, wherein the carriage actuator is to move the carriage along the vertical guide.

21-22. (canceled)

23. The apparatus of claim 19, wherein the cartridge receptacle assembly comprises a lock movable between an unlocked position and a locked position, a corresponding reagent cartridge positionable within the cartridge receptacle when the lock is in the unlocked position and the corresponding reagent cartridge is securable in the cartridge receptacle when the lock is in the locked position.

24. The apparatus of claim 23, wherein the lock comprises a lock actuator, an actuator rod, a link, and an arm, the actuator rod coupled to the lock actuator, the link pivotably coupling the actuator rod and the arm, the arm comprising a distal end coupled to the lock actuator at a pivot.

25. The apparatus of claim 24, wherein the lock actuator is to linearly move the actuator rod and cause the arm to move about the pivot between the locked position and the unlocked position.

26. The apparatus of claim 24, wherein the cartridge receptacle assembly defines a sipper access opening.

27. The apparatus of claim 26, wherein the sipper manifold assembly comprises a sipper actuator to move the sipper through the sipper access opening.

28. The apparatus of claim 27, wherein the sipper actuator comprises a linear actuator, wherein the sipper manifold assembly comprises a frame and a vertical guide coupled to the frame, the sipper actuator coupled to the frame and the sipper movably coupled to the vertical guide, wherein the sipper actuator to move the sipper along the vertical guide.

29-30. (canceled)

31. The apparatus of claim 27, wherein the sipper manifold assembly comprises a rack and pinion actuator to horizontally move the sipper.

32. The apparatus of claim 19, wherein the gantry comprises a horizontal guide and a vertical guide movably coupled to the horizontal guide, wherein the horizontal guide comprises a first rail and a first block and the vertical guide comprises a second rail and a second block, further comprising a vertical frame coupled to the first block, the second rail coupled to the vertical frame, the carriage actuator coupled to the second block and the vertical frame to move the second block and the carriage, further comprising a gantry actuator to horizontally move the carriage and a horizonal frame to which the horizontal guide is coupled, wherein the gantry actuator is to horizontally move the vertical guide.

33-36. (canceled)

37. The apparatus of claim 19, wherein the queue comprises a first position and a second position and comprises a first access aperture at the first position and a second access aperture at the second position, the reagent cartridges to be at the corresponding first position or the second position, wherein the queue comprises a shelf comprising a first receptacle at the first position and a second receptacle at the second position, wherein the carriage actuator is to move the carriage through the first access aperture to lift a corresponding reagent cartridge from the first position, wherein the carriage has a pair of protrusions.

38-42. (canceled)

43. The apparatus of claim 19, wherein the carriage has a pair of lifting arms, wherein the carriage actuator is to move the carriage to position the lifting arms to lift the corresponding reagent cartridge.

44-158. (canceled)
